(19) United States
(12) Patent Application Publication
(10) Pub. No.: US 2019/0002697 A1
(43) Pub. Date: Jan. 3, 2019

(54) MODIFIED PLANT OILS AND RUBBER CONTAINING COMPOSITIONS CONTAINING THE SAME

(71) Applicants: Bret Ja CHISHOLM, West Fargo, ND (US); Olena Teofilivna SHAFRANSKA, Reiles Acres, ND (US); Andrey CHERNYKH, Wexford, PA (US)

(72) Inventors: Bret Ja CHISHOLM, West Fargo, ND (US); Olena Teofilivna SHAFRANSKA, Reiles Acres, ND (US); Andrey CHERNYKH, Wexford, PA (US)

(73) Assignee: NDSU Research Foundation, Fargo, ND (US)

(21) Appl. No.: 16/069,611

(22) PCT Filed: Jan. 13, 2017
(86) PCT No.: PCT/US17/13346

§ 371 Date: Jul. 12, 2018

Related U.S. Application Data
(60) Provisional application No. 62/279,338, filed on Jan. 15, 2016.
(60) Provisional application No. 62/279,625, filed on Jan. 15, 2016.

(51) Int. Cl. C08L 91/00; C08L 23/16; C08L 29/10

(52) U.S. Cl. CPC C08L 91/00; C08L 23/16; C08L 2205/03; C08L 2205/06; C08L 2205/025; C08L 29/10

(57) ABSTRACT

Rubber compounds incorporating plant oil-based materials, such as sucrose fatty acid esters (e.g., sucrose soyates), poly(vinyl ether) fatty acid esters, styrenated plant oils, styrenated plant oil-based polyesters and styrenated plant oil-based poly(vinyl ethers), and combinations thereof that contain plant oil-derived fatty acids are provided, together with methods of making and using said compounds. Also disclosed are rubber materials containing one or more of the plant oil-based compounds. Further disclosed are methods of making the plant oil-based compounds and methods of making rubber materials.

### PRIORITY

This application claims the benefit of U.S. Provisional Application No. 62/279,338, filed Jan. 15, 2016 entitled SUCROSE FATTY ACID ESTERS AND PLANT OIL-BASED POLY(VINYL ETHERS) AS PROCESSING OILS IN RUBBER COMPOUNDS; and U.S. Provisional Application No. 62/279,625, filed Jan. 15, 2016 entitled STYRENATED PLANT OILS AND USE IN RUBBER COMPOUNDS, the disclosures of which are incorporated herein by reference thereto.

### BACKGROUND

Plant oil-based materials have many applications. For example, they are in use as lubricants, cosmetics, plastics, coatings, detergents, composites and drying agents. Commercial and industrial interest in plant oil-based materials is high due to the fact that plant oils are renewable resources and typically biodegradable. Soybean oil is the most widely used vegetable oil for non-food applications due to its low cost and availability.

### SUMMARY

Due to their biodegradability and lack of toxicity, plant oil triglycerides, such as soybean oil for example, have been targeted as potential replacements for conventional petroleum-based processing oils for rubber compounds. It has been found that grafting polystyrene chains to soybean oil results in a liquid that works very well as processing oil. Rubber compositions utilizing the styrene grafted plant oil or plant oil based compounds may have acceptable properties, including mechanical and thermal properties, such as moduli, tensile strength, and glass transition temperature.

### BRIEF DESCRIPTION OF THE DRAWINGS

FIG. 1 illustrates a possible mechanism for grafting styrene to soybean oil (SBO) as a specific example of a plant oil.

FIG. 2 shows rheology data obtained at 140° C.

FIG. 3a shows an image of a poly(2-VOES) composition cast onto a glass panel and cured at 140° C. for 45 minutes. FIG. 3b shows an image of a soybean oil composition cast onto a glass panel and cured at 140° C. for 45 minutes.

FIG. 4 shows tensile strength (i.e. stress at break) as a function of the type and concentration of the processing oil.

FIG. 5 shows stress at 100% strain as a function of the type and concentration of the processing oil.

FIG. 6 shows stress at 300% strain as a function of the type and concentration of the processing oil.

FIG. 7 shows elongation at break as a function of the type and concentration of the processing oil.

FIG. 8 shows toughness as a function of the type and concentration of the processing oil.

FIGS. 9a to 9e shows tensile strength (FIG. 9a), strain at 100% elongation (FIG. 9b), strain at 300% elongation (FIG. 9c), elongation at break (FIG. 9d), and toughness (FIG. 9e) as a function of processing oil composition using 15 weight % oil.

FIG. 10 shows extractable content of unfilled rubber compounds as a function of process oil composition using 15 weight % processing oil.

FIG. 11 shows photographs of the product from Example 8 (middle), Example 13 (left), and Example 14 (right).

FIG. 12 shows loss tangent data for Reference 4, Reference 5, and Example 25.

FIGS. 13a and 13b provide Fourier Transform infrared (FTIR) (FIG. 13a) and nuclear magnetic resonance (NMR) (FIG. 13b) spectroscopy traces of SBO and styrenated SBO (SBO-PS in FIGS. 13a and 13b).

FIGS. 14a, 14b, 14c and 14d show the storage moduli G′ (FIG. 14a), the loss moduli G″ (FIG. 14b), the tangent δ (FIG. 14c) and eh dynamic viscosity (FIG. 14d) were determined for SBR blends with 25 wt % PBO (aromatic oil), SBO and SBO-PS with grafted polystyrene levels of 10, 20, 30 and 40 wt %.

FIGS. 15a, 15b and 15c show results of thermal aging testing for rubber samples compounded with aromatic oils (AO) (FIG. 15a), soybean oil (SBO) (FIG. 15b) and SBO with 30 wt % of grafted polystyrene (SBO PS30) (FIG. 15c).

FIG. 16 shows results of thermal aging testing for rubber samples compounded with AO, SBO and SBO PS30.

FIG. 17 shows viscosity versus the concentration of polystyrene grafts for a SBO PS oil.

### DETAILED DESCRIPTION OF ILLUSTRATIVE EMBODIMENTS

Disclosed herein are sucrose fatty acid esters, poly(vinyl ether) fatty acid esters styrenated fatty acid esters, styrenated poly(vinyl ether) fatty acid esters; and compositions including such compounds.

The disclosed compounds can be utilized as processing aids for rubber compounds. Also disclosed are rubber materials containing one or more of the compounds. Further disclosed are methods of making the compounds and methods of making rubber materials.

### Plant Oils

Disclosed compounds and methods utilize plant oils. Virtually any type of plant oil can be utilized. In some embodiments, the plant oil can be a vegetable or nut oil, for example. Specific illustrative plant oils can include soybean oil, corn oil, palm oil, rapeseed oil, sunflower seed oil, peanut oil, cottonseed oil, palm kernel oil, and coconut oil. In some embodiments, soybean oil (referred to herein as “SBO”) can be utilized as the plant oil.

Disclosed compounds can also utilize plant oil-based compounds. A “plant oil-based compound” is a compound that has been formed from a plant oil by reacting it or modifying it with another material or compound.

Disclosed compounds, methods or both can use one or more than one plant oil, plant oil-based compound, or both. “Plant oil or plant oil-based compound” as used here can refer to a single plant oil, a single plant oil-based compound or combinations of plant oils, plant oil-based compounds, or both. These plant oil-based materials are referred to herein as “plant oil-based petroleum based processing oil (PPO) substitutes” or simply “PPO substitutes” (or replacements).

The fatty acids used to make the plant oil-based PPO substitutes can be obtained from any plant or vegetable oil of interest, for example, soybean oil, canola oil, corn oil, linseed oil, rapeseed oil, safflower oil, sunflower oil, tall oil, tung oil, oiticica oil, or perilla oil, including mixtures or derivatives thereof. Oil from trees or wood pulp such as tall oil and palm oil, or nut-based oils such as cashew oil, can also serve as a source of plant oil-derived fatty acids. Plant oil is heterogeneous, containing a variety of fatty acids such as, for example, oleic acid, stearic acid, linoleic acid, linolenic acid, palmitic acid, lauric acid, myristic acid, arachidic acid, and/or palmitioleic acid, among others. The plant oil used to make the processing oil substitutes as described herein thus typically contains a mixture of saturated and unsaturated fatty acids present in the plant oil. Disclosed plant oil-based PPO substitutes can, in some embodiments, contain at least 60%, 65%, 70%, 75%, 80%, 85%, or 90%, by weight, of plant-oil derived fatty acids.

### Plant Oil-Based Polyesters

In some embodiments, plant oils can be converted into compounds or materials that can be utilized in rubber containing compositions. Illustrative plant oil-based compounds can include polyesters derived from the reaction of sucrose with plant oil monoesters. For example, such plant oil-based materials can include sucrose fatty acid esters (e.g., sucrose soyates) and poly(vinyl ether) fatty acid esters that contain plant oil-derived fatty acids, such as poly[(2-vinyloxy)ethyl soyate] (poly(2-VOES)), which are higher in molecular weight than plant oil triglycerides.

Without intending to be bound by theory, it is noted that sucrose fatty acid esters and poly(vinyl ether) fatty acid esters contain higher numbers of fatty acids per molecule, and thus provide higher levels of unsaturation per molecule than soybean oil triglycerides. Rubber compounds made using the plant oil-based PPO substitutes exhibit substantially improved mechanical and thermal properties, such as modulus, tensile strength, and glass transition temperature, compared to rubber compounds formed using soybean oil as a processing aid. These higher molecular weight plant oil-based materials, exemplified by sucrose soyate, poly(2-VOES) and poly(4-VOBS), thus impart better mechanical and thermal properties to the rubber than soybean oil, when used as PPO substitutes. It should be noted that plant oil-based poly(vinyl ether) fatty acid esters can vary in molecular weight, and in some applications, vinyl ether polymers of relatively low molecular weight (relative to high molecular weight polymers) may be preferred. For example, low molecular weight plant oil-based poly(vinyl ether) fatty acid esters may blend more readily during use in conventional rubber processing methods, as exemplified below. As such, disclosed herein are improved rubber compositions, compounds, and formulations that employ, as a processing aid, a plant oil-based PPO substitute, as well as methods for making and using the rubber compositions, compounds, and formulations.

Illustrative disclosed compounds derived from renewable resources can include sucrose fatty acid esters, for example sucrose soyates such as sucrose octasoyate, sucrose heptasoyate, or mixtures thereof. Sucrose fatty acid esters, although they are not true polymers, are sometimes referred to herein as sucrose “polyesters” because of the multiple esterification sites on the sucrose molecule. Sucrose “multiester” and sucrose “polyester” are used interchangeably herein, and refer to a multiply esterified sucrose fatty acid ester.

Sucrose is a disaccharide with eight hydroxyl groups, thereby allowing the covalent attachment of up to eight fatty acids per molecule to yield a sucrose octa(fatty acid) ester. In the case of fatty acids derived from a plant oil, such as a plant triglyceride, for example soybean oil, up to eight plant-derived fatty acids can be attached, typically via esterification, to a central sucrose molecule. The plant oil fatty acids can be obtained, for example, from unprocessed, partially processed, or processed or purified plant oil, from plant oil triglycerides, or from a fatty acid alkyl ester. When sucrose is fully esterified with soy fatty acids the resulting compound is sucrose octasoyate. Sucrose octasoyate can be prepared using methods well-known to the art; for example, sucrose octasoyate can be prepared from soy monoesters such as biodiesel or by the interesterification of sucrose octaacetate and methyl soyate (see Akoh et al., J. Food Science, 55:1, 236-243 (1990); see also U.S. Pat. No. 6,797,753, and US Pat. Publ. 20140194575 (the disclosures of which are incorporated herein by reference thereto), describing, inter alia, epoxidized sucrose octasoyate; it should be understood that derivatized sucrose soyates such as epoxidized sucrose soyates can also be utilized as a PPO substitute in the present invention. A sucrose multiester that is useful as a processing aid for rubber compounds can be formed from the reaction of sucrose with plant oil monoesters. Sucrose soyate, including sucrose octasoyate, is also available commercially; for example, a highly esterified sucrose soyate multiester is available from Renuvix under the tradename ESSENEO SS8. Examples of sucrose multiesters suitable for use in the present invention also include, but are not limited to, Sefose 1618S, Sefose 1618U, Sefa Soyate IMF 40, Sefa Soyate LP426, Sefose 1618S B6, Sefose 1618U B6, Sefa Cottonate, which have been available from The Procter and Gamble Co. of Cincinnati, Ohio.

More generally, the plant oil-based PPO substitute is a compound that is the fatty acid ester of an alcohol or polyol where the degree of substitution of the polyol with fatty acids can vary to produce mono- or multiesters of plant oils. Preferably, the polyol is sucrose. It should be understood, however, that the polyol that is esterified with plant oil fatty acids to yield the plant oil-based PPO substitute is not limited to sucrose. For example, other sugars can be used, preferably sugars with at least 5 or 6 free hydroxyl groups. Particularly preferred are non-reducing sugars, such as non-reducing disaccharides, in which the sugar is an acetal (or ketal) that cannot readily oxidized because both anomeric carbon atoms are fixed in a glycosidic linkage in which the components bond through their anomeric centers.

### Plant Oil-Based Poly(Vinyl Ether) Fatty Acid Esters

Compounds derived from renewable resources that can be employed as processing aids in rubber synthesis, replacing conventional PPOs in whole or in part, also include plant oil-based poly(vinyl ether) fatty acid esters, also referred to as fatty acid ester-containing poly(vinyl ether)s or fatty acid ester-modified poly(vinyl ether)s, which terms are used interchangeably herein. Exemplary plant oil-based poly(vinyl ether) fatty acid esters include poly[(2-vinyloxy)ethyl soyate] (referred to herein as poly(2-VOES)); poly[(4-vinyloxy)butyl soyate] (referred to herein as poly(4-VOBS)); and poly(2-(1-propenyl)oxyethyl soyate). Additional vinyl ether monomers that can be polymerized to yield poly(vinyl ether) fatty acid esters suitable for use as plant oil-based PPO substitutes according to the invention (particularly when formulated as low molecular weight polymers) are described in WO2015/134080, the disclosure of which is incorporated herein by reference thereto.

In some embodiments, the plant oil-based poly(vinyl ether) fatty acid ester is relatively low in molecular weight. In one embodiment, the low molecular weight plant oil-based poly(vinyl ether) fatty acid ester has a molecular weight of below 10,000 g/mol. Plant oil-based poly(vinyl ether) fatty acid esters formulated as low molecular weight polymers can have a molecular weight of, for example, below 10,000 g/mol, or below 8,000 g/mol, or below 6,500 g/mol, or below 5000 g/mol. Preferably, a low molecular weight plant oil-based poly(vinyl ether) fatty acid ester has a molecular weight of below 6,500 g/mol. In some embodiments, the molecular weight of the low molecular weight plant oil-based poly(vinyl ether) fatty acid ester is in the range of 500 g/mol to 6,500 g/mol.

In some embodiments, plant oils can be converted into vinyl ethers or more specifically poly(vinyl ether)s. In one aspect, the invention provides a polymer formed from vinyl ether monomers derived from plant oil and having the structure

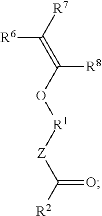

wherein R¹ is divalent organic group that functions as a spacer between the vinyl ether and the heteroatom; Z is a heteroatom selected from O, N or S; R² contains an aliphatic group derived from a renewable resource such as a plant oil; and R⁶, R⁷, and R⁸ are each independently H or alkyl.

The polymer of the invention thus preferably includes a repeating unit having the general structure

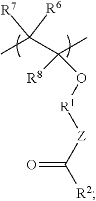

wherein R¹ is divalent organic group that functions as a spacer between the vinyl ether and the heteroatom; Z is a heteroatom selected from O, N or S; R² contains an aliphatic group derived from a renewable resource such as a plant oil; and R⁶, R⁷, and R⁸ are each independently H or alkyl.

The plant oil is preferably a vegetable or nut oil, more preferably soybean oil. In one embodiment, the polymer is the product of a carbocationic polymerization reaction in which the polymer molecular weight increases linearly or substantially linearly with monomer conversion. In some embodiments, a plot of molecular weight as a function of monomer conversion is approximately linear. One example of this type of carbocationic polymerization reaction is a “living” or controlled carbocationic polymerization. A “living” polymerization is polymerization that occurs substantially without termination or chain transfer reactions resulting in the ability to produce polymers with controlled molecular weight and polymers and potentially copolymers with well-defined molecular architectures such as block copolymers, star polymers, telechelic polymers, and graft copolymers. Optionally, the polymerization reaction, such as the living carbocationic polymerization, occurs in the absence of a Lewis base. In another embodiment, the polymer or copolymer is the product of a free radical polymerization. Optionally, the polymer has a polydispersity index of less than 1.5. The polymer can include a plurality of monomers, such that for each of the plurality of monomers, R² is independently an aliphatic group derived from a renewable resource such as a plant oil, preferably a C8-C21 aliphatic group derived from a plant oil.

The fatty acid pendant group of the vinyl ether monomer can be derived directly or indirectly from a plant oil. For example, the vinyl ether compound can be derived from a plant oil-derived compound such as a transesterified plant oil-based long chain alkyl ester, such as a biodiesel compound, for example an alkyl soyate such as methyl soyate.

Chemical derivatives of the polymer, including but not limited to an epoxy-functional polymer, an acrylate-functional polymer and a polyol polymer, are also encompassed by the invention. An epoxy-functional polymer includes, as an R² group, at least one aliphatic group derived from a plant oil that has been functionalized to include at least one epoxide group; an acrylate functional polymer includes, as an R² group, at least one aliphatic group derived from a plant oil that has been functionalized to include at least one acrylate-functional group; and a polyol polymer includes, as an R² group, at least one aliphatic group derived from a plant oil that has been functionalized to include at least one alcohol group.

The invention further includes copolymers of the vinyl ether plant oil-derived fatty acid ester monomers described herein, such as a copolymer with a poly(ethylene glycol)-functional vinylether monomer.

In another aspect, the invention provides a method for making a polymer of the invention that includes contacting vinyl ether plant oil-derived fatty acid ester monomers with an optional organic initiator molecule, and a Lewis acid, under reaction conditions to allow polymerization of the monomer. When the organic initiator is omitted, the polymerization may, without being bound by theory, be initiated by adventitious water present in the reaction mixture. Polymerization may, or may not, be a “living” polymerization. The polymerization reaction is optionally performed in the absence of a Lewis base. In another aspect, the invention provides a method for making a polymer from plant oil that includes polymerizing vinylether plant oil-derived fatty acid ester monomers to yield a polymer having a polydispersity index of less than 2.0, preferably less than 1.5, more preferably less than 1.2. Optionally, the methods include extracting the plant oil from a plant or plant part to obtain the oil. The method optionally further includes cleaving triglycerides found in the plant oil to yield the monomers comprising vinylethers of plant oil-derived fatty acid esters. Cleavage can be accomplished using base-catalyzed transesterification.

In a further aspect, the invention provides a method for producing a polymer that includes contacting vinylether plant oil-derived fatty acid ester monomers with an optional initiator to form a reaction mixture; contacting the reaction mixture with a co-initiator, e.g., a Lewis acid, to initiate a polymerization reaction under conditions and for a time to allow polymerization to proceed; and terminating the polymerization reaction to yield the polymer. In another aspect, the invention provides a method for producing a copolymer that includes contacting vinylether plant oil-derived fatty acid ester monomers with at least one additional monomer and an optional initiator to form a reaction mixture; contacting the reaction mixture with a co-initiator, e.g., a Lewis acid, to initiate a polymerization reaction under conditions and for a time to allow polymerization to proceed; and terminating the polymerization reaction to yield the copolymer. An exemplary additional monomer is a vinylether monomer such as poly(ethylene glycol)-functional vinylether monomer or tri(ethylene glycol) ethyl vinyl ether. Another exemplary additional vinylether monomer is cyclohexyl vinyl ether. Polymerization can take place at a temperature less than 10° C.; preferably less than 5° C., more preferably at about 0° C. The plant oil monomers are preferably vegetable oil or nut oil monomers, more preferably soybean oil monomers. In a preferred embodiment, the first initiator includes 1-isobutoxyethyl acetate and the co-initiator includes ethyl aluminum sesquichloride.

### Styrenated Plant Oil-Based Compounds

The polyesters derived from the reaction of sucrose with plant oil monoesters can then have styrene grafted thereon.

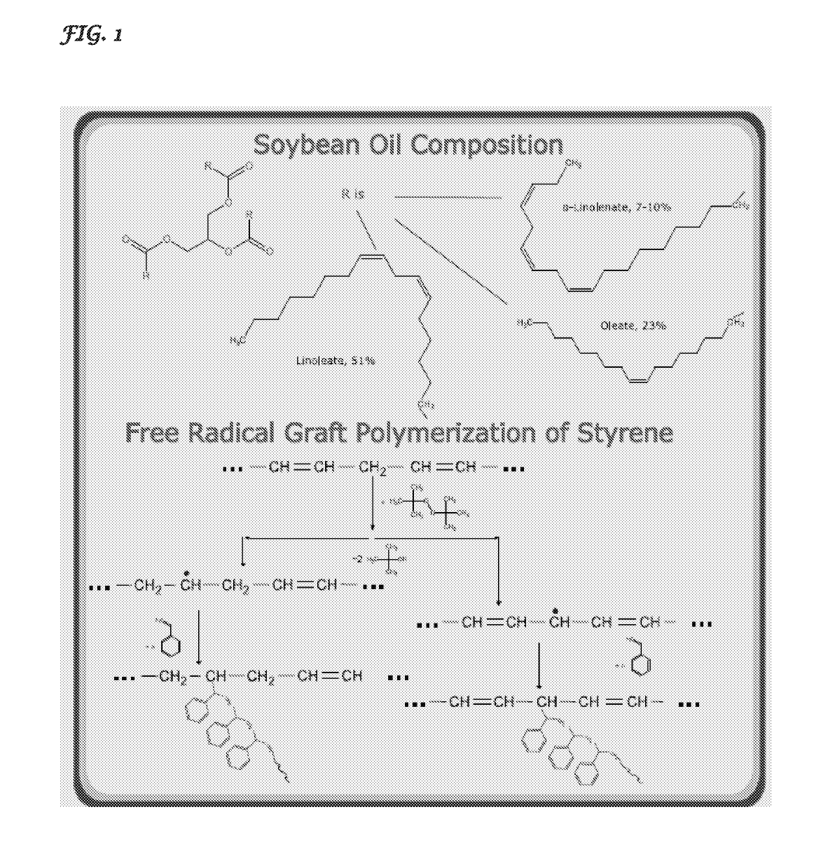

Compounds disclosed and utilized herein are styrenated plant oils or plant oil-based compounds, which are referred to herein as styrenated plant oil components. In general, styrenated plant oil components can be formed by reacting a plant oil or plant oil-based compound with styrene and an initiator. It is thought, but not relied upon that one possible mechanism for the reaction includes the radical from the initiator abstracting a bisallylic hydrogen from the plant oil (or plant oil-based compound), which then reacts with styrene. However, it should be noted that this is only possible explanation for one possible reaction that could take place to graft styrene to soybean oil. FIG. 1 illustrates a possible mechanistic scheme for grafting styrene to soybean oil (SBO) as an example.

Grafting styrene to a plant oil or plant oil-based compound can generally be accomplished by combining the plant oil or plant oil-based compound with styrene and an initiator. Illustrative initiators can include peroxides for example. Specific illustrative peroxides can include benzoyl peroxide, di-tert-butyl peroxide and methyl ethyl ketone peroxide for example.

The amount of styrene grafted to the plant oil (or plant oil-based compound) can vary. In some embodiments, the amount of styrene can be described based on the weight percent (wt %) of styrene relative to the total of the plant oil (or plant oil-based compound) and styrene. In some embodiments, the amount of styrene can be not less than 5 wt %, not less than 10 wt %, not less than 15 wt % or not less than 20 wt %, for example. In some embodiments, the amount of styrene can be not greater than 50 wt %, not greater than 40 wt %, not greater than 35 wt % or not greater than 30 wt %, for example.

The amount of styrene grafted to the plant oil (or plant oil-based compound) can also be described by the percentage of polystyrene grafted to the plant oil (or plant oil-based compound). For example, in some embodiments, not less than 10 wt % of the styrene added to the plant oil (or plant oil-based compound) is grafted to the plant oil (or plant oil-based compound), or not less than 15 wt % of the styrene added to the plant oil (or plant oil-based compound) is grafted to the plant oil (or plant oil-based compound), or not less than 20 wt % of the styrene added to the plant oil (or plant oil-based compound) is grafted to the plant oil (or plant oil-based compound).

By considering both the amount of styrene added to the plant oil or plant oil based compound and the percentage that was grafted, an actual amount of styrene grafted on to the plant oil or plant oil based compound can be described based on the weight percent (wt %) of styrene relative to the total of the plant oil (or plant oil-based compound) and styrene. In some embodiments, an actual amount of styrene grafted on to the plant oil or plant oil based compound can be not less than 5 wt % of styrene relative to the total of the plant oil (or plant oil-based compound) and styrene, not less than 15 wt % of styrene relative to the total of the plant oil (or plant oil-based compound) and styrene, or not less than 20 wt % of styrene relative to the total of the plant oil (or plant oil-based compound) and styrene. In some embodiments, an actual amount of styrene grafted on to the plant oil or plant oil based compound can be not greater than 40 wt % of styrene relative to the total of the plant oil (or plant oil-based compound) and styrene or not greater than 30 wt % of styrene relative to the total of the plant oil (or plant oil-based compound) and styrene.

The molecular weight of the styrenated plant oil or plant oil based compound can also be considered. In some embodiments, the molecular weight of the styrenated plant oil or plant oil based compound expressed relative to polystyrene standards can be not less than 2000 g/mole or not less than 3000 g/mole. In some embodiments, the molecular weight of the styrenated plant oil or plant oil based compound expressed relative to polystyrene standards can be not greater than 10,000 g/mole or not greater than 9000 g/mole.

Further information related to styrenated polyesters, such as styrenated sucrose soyate (referred to herein as “SSS”) can be found, for example in United States Patent Publication Number 2013/0261251, the disclosure of which is incorporated herein by reference thereto. A specific illustrative polyester can include sucrose soyate (referred to herein as “SS”). Sucrose soyate is commercially available from Proctor & Gamble (Cincinnati, Ohio) as SEFOSE® 1618U, for example.

### Methods of Forming Styrenated Plant Oil Components

In some embodiments, styrenation of plant oil or plant oil-based compounds to form a styrenated plant oil component can be accomplished by merely combining the plant oil or plant oil-based compound with one or more initiators and styrene. In some embodiments, the order of addition, mixing two or more reactants before adding to one or more reactants, the speed of addition, the reaction temperature, or any combination thereof can be modified.

In some embodiments, a method that produces a relatively homogenous solution of styrenated plant oil component can be utilized. Generally, the homogeneity or lack thereof of a solution can be determined by the appearance of the composition. For example, a composition that appears transparent or mostly transparent is typically more homogenous than a solution that is opaque or hazy.

In some embodiments, styrenation of a plant oil or plant oil-based compound can be accomplished using a relatively slow feed of one or more reactants to a reaction vessel containing one or more other reactants. In some embodiments, controlled, relatively slow feeding of one or more reactants may control or minimize the amount of polystyrene homopolymer that is produced in the reaction thereby increasing the amount of styrene grafted to the plant oil or plant oil-based compound. In some embodiments the addition of the styrene and initiator can occur over at least 3 hours or at least 3.5 hours. In some embodiments where at least about 20 wt % styrene is being grafted onto a plant oil or plant oil-based compound, the addition of the styrene and initiator can occur over at least 3 hours or at least 3.5 hours.

In some embodiments methods of styrenating plant oil or plant oil-based compounds can include relatively slow addition of styrene and initiator and optionally some of the plant oil or plant oil-based compound to the plant oil or plant oil-based compound that is heated above room temperature (e.g., not less than 100° C., not less than 125° C., or not less than 140° C.). In some embodiments, methods of styrenating plant oil or plant oil-based compounds can include relatively slow addition of styrene and initiator and optionally some of the plant oil or plant oil-based compound to the plant oil or plant oil-based compound that is heated to about 150° C. for example.

### Blends

The invention additionally includes the use of blends containing, as a first component, an unprocessed, partially processed, or processed or purified plant oil and, as a second component, a sucrose fatty acid ester, a plant oil-based poly(vinyl ether)s, such as a low molecular weight plant oil-based poly(vinyl ether) fatty acid esters, or a styrenated plant-oil based polyester, styrenated plant-oil based poly(vinyl ether), or a, or a styrenated plant-oil based polyester, styrenated plant-oil based poly(vinyl ether), or any combination thereof, as processing aids for rubber compounds. A blend can be used in place of, or in partial substitution for, a conventional PPO in a rubber compound.

More generally, the invention contemplates the use of any combination of a conventional petroleum-based processing oil (PPO) and/or at least one plant oil, and plant oil-based PPO substitute as described herein, in rubber compounds, compositions, formulations, as well as methods of making and use.

### Rubber Compounds

The plant oil-based materials described herein, more particularly the sucrose fatty acid esters and the plant oil-based poly(vinyl ether) fatty acid esters, can be incorporated into a rubber or rubberized compound as processing aids. In some embodiments, the plant oil-based poly(vinyl ether) fatty acid ester is a low molecular weight poly(vinyl ether) fatty acid ester. The large number of unsaturated groups per molecule of plant oil-based PPO substitute is expected to ensure grafting of the plant oil-based material into the crosslinked rubber matrix, thereby preventing extraction of the plant oil-based material from the vulcanized rubber and enhancing mechanical properties such as modulus, strength, and abrasion resistance.

While a high level of unsaturation is generally a positive attribute for use in rubber compounds and compositions, in some embodiments it may be nonetheless be desirable to limit cross-linking and derivatization. In such embodiments, the unsaturation level, and hence reactivity, of the plant oil-based PPO substitute can be reduced, for example through hydrogenation, prior to use as a processing oil in the production of rubber compounds. To that end, the use of oils with higher levels of saturation, including high oleic oils such as high oleic soybean oil, e.g., soybean oil obtained from high oleic content soybeans available from Monsanto under the tradename VISTIVE GOLD, may be useful to synthesize the sucrose soyate that is used as a PPO substitute in the compounds, compositions and methods of the invention.

Disclosed plant oil components can be utilized in rubber containing compositions or in combination with one or more rubber components. The term “rubber composition” as used herein includes rubber compositions or formulations prior to vulcanization, as well as rubber articles after vulcanization. After vulcanization, the rubber composition can assume the shape and character of a molded article; such molded articles are also included herein. The rubber compound can be “filled” (with a reinforcing filler) or “unfilled.” Disclosed rubber compositions are typically made by first blending the rubber component with the polymer of the invention and, optionally, any other processing oils or extenders, such as petroleum-based processing oils (PPOs) or plant oil or plant oil-based compound, followed by the addition and blending of optional additives such as stabilizers, accelerators, vulcanization agents, antioxidants and the like, followed by the optional addition and blending of one or more reinforcing fillers such as carbon black or silica particles, to form the unvulcanized composition. Vulcanization can then be performed at high temperature and pressure to yield the vulcanized rubber compound or article. A typical vulcanization process is carried out at a pressure of 1500 to 2500 Newtons and a temperature of 130 to 170° C. Hot air vulcanization or microwave heated vulcanization can also be employed. Vulcanization can be accomplished, for example, using one or more curing systems that employ sulfur, peroxides, urethane crosslinkers, metallic oxides and/or acetoxysilane.

In embodiments where the plant oil-based PPO substitute is a polymer formed from a vinyl ether fatty acid ester monomer, such as 2-VOES or 4-VOBS, the ability to copolymerize the plant oil-based poly(vinyl ether) fatty acid esters with other monomers provides a new method for tailoring basic polymer properties such as glass transition temperature, solubility parameter, tensile strength, and modulus. By proper selection of co-monomers for use in conjunction with the plant oil-based poly(vinyl ether) fatty acid esters described herein, such as poly(2-VOES) and poly(4-VOBS), the solubility/compatibility of the copolymer with a specific type of rubber can be enhanced. In addition, appropriate functional groups can be incorporated through co-polymerization. These functional groups can be selected to provide for favorable interactions between the copolymer and specific components of the rubber compound such as filler particles. Enhancing interactions between the polymer matrix and filler particles is expected to provide dramatic enhancements in mechanical properties including modulus, tensile strength, toughness, and abrasion resistance. A practical example of the use of these plant oil-based processing aids in rubber compounds is the incorporation of this polymer into rubber compounds used for making tires, hoses, belts and belting products, treads, and the like.

In embodiments where the plant oil-based PPO substitute is a styrenated plant oil-based PPO substituted, the styrenated plant oil component can function as a processing aid, replacing typically utilized petroleum-based processing oil (PPO) aids, or combinations thereof. The amount of styrenated plant oil component in a rubber composition can vary. In some embodiments, a styrenated plant oil component can be combined with a non-styrenated plant oil component in a rubber composition. In some embodiments, a styrenated plant oil component can be used in an amount that is substantially similar to an amount that a petroleum-based processing oil (PPO) would be used in a similar composition. In some embodiments, a styrenated plant oil component (optionally in combination with a non-styrenated plant oil component) can be present in a rubber composition at not less than 20 parts per 100 parts of the rubber component (e.g., the elastomer for example KER®-1502), not less than 25 parts per 100 parts of the rubber component, not less than 35 parts per 100 parts of the rubber component or not less than 45 parts per 100 parts of the rubber component. In some embodiments, a styrenated plant oil component (optionally in combination with a non-styrenated plant oil component) can be present in a rubber composition at not greater than 60 parts per 100 parts of the rubber component, not greater than 55 parts per 100 parts of the rubber component, not greater than 50 parts per 100 parts of the rubber component, not greater than 45 parts per 100 parts of the rubber component or not greater than 40 parts per 100 parts of the rubber component.

Illustrative rubber components include natural rubber (NR such as Standard Indonesian Rubber, or “SIR”), as well as synthetic rubbers, such as styrene butadiene rubber (SBR), isoprene rubber (IR), butadiene rubber (BR), ethylene-propylene rubber (EDM/EPDM wherein D stands for diene), butyl rubber (IIR), bromobutyl rubber (BIIR), chloroprene rubber (CR) and nitrile rubber (NBR), as well as combinations thereof. Nitrile rubber is a copolymer of acrylonitrile and butadiene, and is commonly used for products that are in contact with oil and fuel. Preferred rubber components are NR, SBR, BR and NBR. The rubber component of a rubber compound can be any suitable elastomer or elastomer gum. Preferably the rubber component possesses unsaturation; for example, it can be or include an unsaturated diene.

Optionally, disclosed rubber compositions can include reinforcing filler, such as carbon black, silica particles (amorphous silica), or a combination thereof. The rubber compound may be a filled or unfilled rubber compound. The rubber composition further optionally includes at least one additive selected from the group consisting of a stabilizer, an antioxidant, a lubricant, a vulcanization agent, a plasticizer, an additional processing aid, and an accelerator, or any combination thereof. In some embodiments, the rubber composition may contain a petroleum-based processing oil as a further processing aid. The rubber composition can be vulcanized or unvulcanized. In a some embodiments, the rubber composition is one in which all or some of a PPO is substituted with or replaced by at least one styrenated plant oil component.

Illustrative commercially useful rubber compounds contain rubber along with one or more processing aids such as processing oils and/or oil-based softeners or extenders. In some embodiments, rubber compounds additionally contain reinforcing fillers. Optionally, additives including but not limited to stabilizers, antioxidants, lubricants, vulcanization agents, plasticizers, additional processing aids, and/or accelerators are also included in rubber compounds. Suitable accelerators include dithiocarbamates, guanidines, quinones, sulfonamides, phenoldisulfides, insoluble sulfurs, diphenylamines, phthalimides, thiadiazoles, thiurams, thioureas, and thiazoles. Examples of additives include zinc oxide (ZnO), stearic acid (StA), phenolic resin, silane, sulfur, 2,2,4-trimethyl-1,2-dihydroquinoline (TMQ, an antioxidant), N-(1,3,-dimethylbutyl)-N′-phenyl-p-phenylenediamine (6PPD, an antoxidant), and N-cyclohexyl-2-benzothiazole sulfonamide (CBS, an accelerator). In some embodiments, the rubber composition contains at least one of ZnO, S, TBBS and stearic acid.

As noted above, the processing aids and extenders incorporated into rubber compounds have historically been petroleum based (petroleum-based processing oils, or PPOs). PPOs commonly used to make rubber compounds include mineral oils such as paraffinic, naphthenic and aromatic oils. In the present invention, all or some of the PPO in a rubber compound is substituted or replaced with one more plant oil-based PPO substitutes of the invention in order to employ green technology while retaining the high performance characteristics imparted by petroleum-based oils. Any rubber compound, composition, or formulation that incorporates a PPO can be reformulated by substituting or replacing all or part of the PPO component with one or more plant oil-based PPO substitutes of the invention, to provide a higher green content while maintaining or improving commercially important characteristics or features. Incorporation of the plant oil-based PPO substitutes of the invention into rubber compounds may result in compounds having higher modulus, tensile strength, toughness, and/or lower rolling resistance compared to rubber compounds utilizing PPOs. Additionally, as illustrated in the examples below, incorporation of the plant vinyl ether compounds of the invention yields superior properties compared to incorporation of unmodified soybean oil (SBO). For example, unlike SBO, poly(4-VOBS) was found to be not miscible with SBR and thus does not lower the SBR glass transition temperature, Tg. Moreover, the use of poly(4-VOBS) in SBR compounds was found to give smooth sheets that were not prone to shrinkage over time. Compared to PPO and SBO, utilization of poly(4-VOBS) at concentrations of >5% by weight in SBR rubber compounds (i.e., weight ratios of at least 5:95 poly(4-VOBS):SBR) provides higher tensile strength and toughness, with no loss of Shore A hardness. At poly(4-VOBS) concentrations >15%, toughness twice that of pure SBR was observed. Poly(4-VOBS) resulted in the lowest predicted rolling resistance. Also, much higher modulus at 100% and 200% strain was observed. Overall, poly(4-VOBS) was found to impart properties to the rubber compounds that were more similar to PPO than to SBO.

Without intending to be bound by theory, it is proposed that the polymers of the invention, having a multiplicity of double bonds, form a cross-linked network upon vulcanization, thereby beneficially preventing migration of the polymer (and other processing oils, if present) to the surface of the molded article.

Nonlimiting examples of polymers of the invention that are well-suited for incorporation into rubber compounds are poly(4-VOBS) (poly[(4-vinyloxy)butyl soyate]) and poly(2-VOES) (poly[(2-vinyloxy)ethyl soyate]).

Vinyl ether comonomers that are particularly suitable for use in copolymers incorporated into the rubber compounds of the invention are comonomers that are relatively nonpolar or hydrophobic, such as alkyl vinyl ethers. Examples of suitable alkyl vinyl ether comonomers include n-butyl vinyl ether, isobutyl vinyl ether, n-propyl vinyl ether, isopropyl vinyl ether, dodecyl vinyl ethers, and the like. Other suitable comonomers are those that possess an electron withdrawing group, for example comonomers that possess an anhydride or a nitrile. Examples of comonomers that possess relatively strong electron withdrawing groups are maleic anhydride, acrylonitrile, methacrylonitrile, fumaric acid, dimethyl fumarate and dimethyl maleate. Examples of copolymers of the invention that are well-suited for incorporation into rubber compounds are alternating copolymers of maleic anhydride and 2-VOES ((2-vinyloxy)ethyl soyate), referred to as polyMA-2-VOES, or maleic anhydride and 4-VOBS ((4-vinyloxy)butyl soyate), referred to as polyMA-4-VOBS).

Advantageously, the molecular weight of the polymer or copolymer of the invention can be readily tailored by adjusting the ratio of monomer to the initiator during the polymerization process to achieve the desired viscosity of the polymer or copolymer, thereby allowing customization of the mechanical properties of the rubber compound. For example, poly(2-VOES) and poly(4-VOBS) can be prepared with number average molecular weights, expressed relative to polystyrene standard, ranging from 1000 g/mol or lower on the lower end, to up to 50,000 g/mol, 100,000 g/mol, 120,000 g/mol or higher, depending on the intended use. As noted elsewhere herein, low molecular weight plant-oil based poly(vinyl ether) fatty acid esters, having molecular weights of less than 10,000 g/mol, are preferred for many applications.

Preferred rubber compounds of the invention contain at least one rubber component and at least one plant oil-based PPO substitute as a processing aid. Optionally, the rubber compound further contains a reinforcing filler, such as carbon black, mineral fillers such as clays, or silica particles. Also optionally, the rubber compound contains one or more additives. The one or more additives can include stabilizers, antioxidants, lubricants, vulcanization agents, plasticizers, additional processing aids, accelerators, as well as one or more petroleum-based oils (PPOs), or any combination thereof. In a preferred embodiment, the rubber compound contains at least one of zinc oxide (ZnO), sulfur (S), N-tert-butyl-2-benzothiazole-2-sulfenamide (TBBS) and stearic acid (StA).

In some embodiments, the amount of plant oil-based PPO substitute, such as the sucrose fatty acid ester or poly(vinyl ether) fatty acid ester, in the rubber compound of the invention is, by weight, equal to or less than the amount of rubber component. The ratio of the plant oil-based PPO substitute to the rubber component (PPO substitute:rubber, wt/wt) in the rubber compound may be at least 2:98, or at least 5:95, or at least 10:90, or at least 15:85, or at least 20:80, or at least 25:75, or at least 30:70, or at least 35:65, or at least 40:60, or at least 45:55, or at least 50:50. In other embodiments, the amount of plant oil-based PPO substitute in the rubber compound of the invention is greater than the amount of rubber component. The ratio of the plant oil-based PPO substitute to the rubber component (PPO substitute:rubber, wt/wt) in the rubber compound may be at least 55:45, 60:40, 65:35, 70:30, or even higher. The amount of plant oil-based PPO substitute in the rubber compound can be at least 5% by weight, at least 15% by weight, at least 25% by weight, at least 40% by weight, or at least 50% by weight. Particularly for “unfilled” rubber compounds (compounds containing little or no reinforcing filler), higher proportions of plant oil-based PPO substitute are associated with beneficial properties.

The term “rubber compound” as used herein includes rubber compositions or formulations prior to vulcanization, as well as rubber articles after vulcanization. After vulcanization, the rubber compound can assume the shape and character of a molded article; such molded articles are also included in the invention. The rubber compound can be “filled” (with a reinforcing filler) or “unfilled.” The rubber compounds of the invention are typically made by first blending the rubber component with the polymer of the invention and, optionally, any other processing oils or extenders, such as PPOs or SBO, followed by the addition and blending of optional additives such as stabilizers, accelerators, vulcanization agents, antioxidants and the like, followed by the optional addition and blending of one or more reinforcing fillers such as carbon black or silica particles, to form the unvulcanized composition. Vulcanization is then performed at high temperature and pressure to yield the vulcanized rubber compound or article. A typical vulcanization process is carried out at a pressure of 1500 to 2500 Newtons and a temperature of 130 to 170° C. Hot air vulcanization or microwave heated vulcanization can also be employed. Vulcanization can be accomplished, for example, using one or more curing systems that employ sulfur, peroxides, urethane crosslinkers, metallic oxides and/or acetoxysilane.

The invention further includes method of making a rubber composition, utilizing one or more rubber components as described herein, and one or more disclosed styrenated plant oil components. The method includes blending at least one rubber component with a first processing aid that includes a disclosed styrenated plant oil component; optionally blending at least one additive into the mixture; and subjecting the mixture to vulcanization to yield the rubber composition. Examples of additives include but are not limited to a stabilizer, an antioxidant, a lubricant, a vulcanization agent, a plasticizer, an additional processing aid, an accelerator, or any combination thereof. The method optionally includes blending a reinforcing filler into the mixture prior to vulcanization. Examples of a reinforcing filler include carbon black, silica particles, or a combination thereof. The method optionally further includes blending the rubber component and the first processing aid (e.g., including the styrenated plant oil component) with a second processing aid that includes petroleum-based processing oil (PPO).

Also disclosed are articles that include or are formed from a rubber composition as described herein, such as a molded article. An example of a commercially useful article that incorporates the rubber composition is a tire. The rubber compounds of the invention have many commercial uses, including but not limited to uses in fabricating tires or in other aspects of the automotive industry, in textiles, construction, consumer products, and biomedical applications. In yet another embodiment, the polymer of the invention can be incorporated into a composite material, such as a fiber-reinforced composite.

The present disclosure is illustrated by the following examples. It is to be understood that the particular examples, materials, amounts, and procedures are to be interpreted broadly in accordance with the scope and spirit of the disclosure as set forth herein.

### EXAMPLES

### Example 1. Utility of Novel Soybean Oil-Based Polymers in Rubber Compounds

Rubber compounds for applications such automobile tires are multicomponent materials based largely on petroleum-derived starting materials. For example, it has been shown that soybean oil and/or its derivatives can be used to improve the elongation of EPDM rubbers and displace some of the petroleum-based processing oils in tire tread compounds (Brentin and Sarnacke, “Rubber Compounds: A Market Opportunity Study”).

The International Rubber Study Group reported that the total volume of rubber consumed globally in 2011 was 25.7 million metric tons with tire manufacturing consuming about 60% of the total. Based on the size of this market, it can be understood that even modest use of soybean oil-based materials in this market translates to significant volumes of soybeans. For example, if just 1% of the total volume of rubber consumed in 2011 was displaced by poly(2-VOES), which is 75 weight percent soybean oil, the total number of bushels of soybeans would be over 2 million bushels. Previous research has shown that soybean oil has the potential to replace some petroleum-based components in rubber compounds. Considering the enormous size of the rubber industry and the price and supply volatility of petrochemicals, this market may represent a major opportunity for the use soybean oil-based materials.

We have developed a process to produce high molecular weight polymers from a novel monomer derived from soybean oil. The novel monomer, which is being referred to as vinyl ether of soybean oil fatty acid esters (VESFA) or (2-vinyloxy)ethyl soyate (2-VOES) is 75 weight percent soybean oil and can be readily produced using a process analogous to that used to produce soy biodiesel. We have scaled the monomer synthesis up to a volume of 10 liters without issue. The polymerization process developed for 2-VOES allows for high molecular weight polymer to be produced without consuming the unsaturation in the fatty acid pendent groups. The polymerization process also enables control of polymer molecular weight and the production of copolymers.

The primary difference between the homopolymer of 2-VOES (i.e. poly(2-VOES) and soybean oil is the number of unsaturated groups per molecule. In contrast to soybean oil triglycerides which have three fatty acid chains per molecule, depending on the molecular weight, poly(2-VOES) possesses 10s or 100s of fatty acid chains per molecule. Thus, the number of functional groups per molecule for poly(2-VOES) can be 1 to 2 orders of magnitude higher than soybean oil. This difference in chemical structure was shown to dramatically decrease cure times of coating compositions and significantly increase coating modulus/hardness. In addition, due to the higher molecular weight of poly(2-VOES) as compared to soybean oil, much less shrinkage occurs upon cure, which enables higher adhesion to substrates.

With respect to rubber compounds, the polymer technology developed is expected to possess some major advantages over traditional soybean oil and soybean oil derivatives. First, the higher, and in some embodiments dramatically higher, number of unsaturated groups per molecule associated with poly(2-VOES) will ensure grafting of the polymer into the crosslinked rubber matrix preventing extraction of the polymer from the vulcanized rubber and enhancing mechanical properties such as modulus, strength, and abrasion resistance. In addition, and perhaps more importantly, the ability to copolymerize 2-VOES with other monomers provides a new method for tailoring basic polymer properties such as glass transition temperature, solubility parameter, and chemical functionality. By proper selection of comonomers for use in conjunction with 2-VOES copolymers, the solubility/compatibility of the copolymer with a specific type of rubber can be enhanced. In addition, through copolymerization, appropriate functional groups can be incorporated that provide for favorable interactions between the copolymer and specific components of the rubber compound such as filler particles. Enhancing interactions between the polymer matrix and filler particles can provide dramatic enhancements in mechanical properties including modulus, tensile strength, toughness, and abrasion resistance.

Poly(2-VOES) polymers can be incorporated into rubber compounds for tires, hoses, belts and belting products, treads, and the like. Vulcanized poly(2-VOES) and 2-VOES copolymers may also have potential application as factice. These vulcanized polymers can be compared to soybean oil factice produced using analogous vulcanization conditions.

The soybean oil-based polymer technology of the present invention is expected to be useful for application in rubber compounds, particularly in tire tread applications.

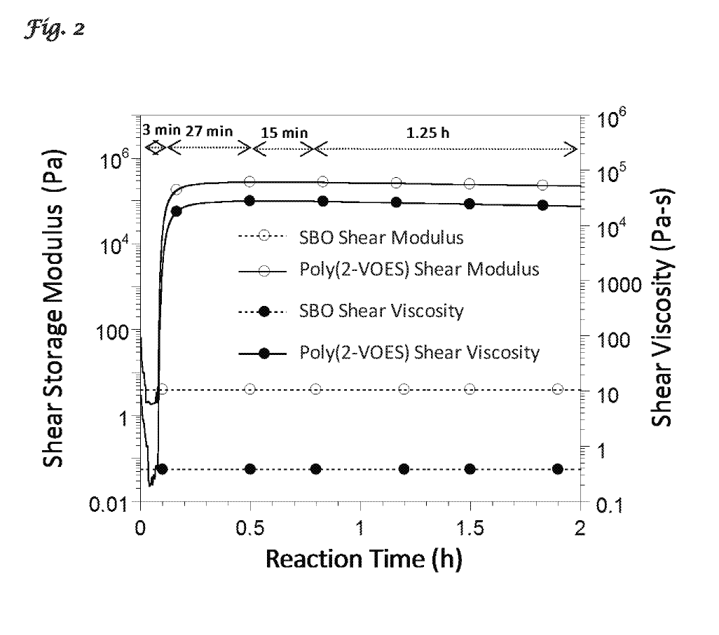

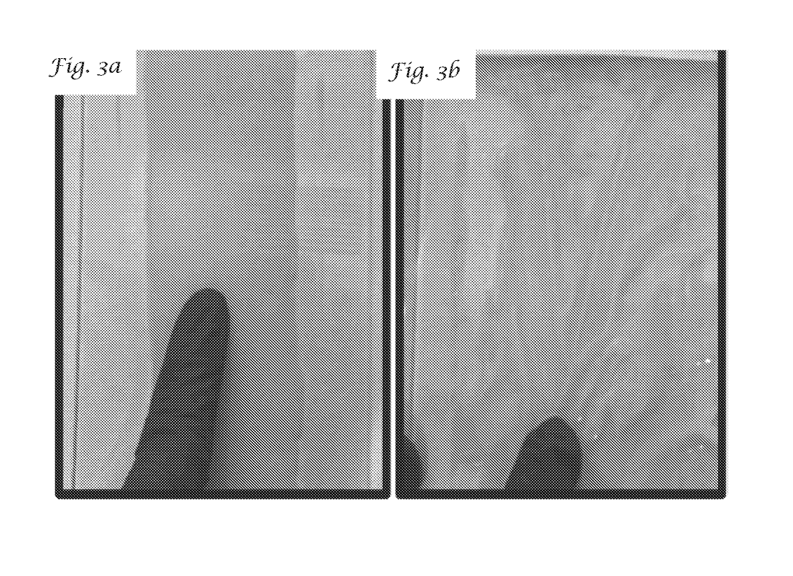

A proof-of-concept experiment has been conducted in which a poly(2-VOES) sample was blended with typical reagents used to vulcanize rubber and the composition cured at 140° C. For comparison, an analogous composition was prepared using conventional soybean oil in place of poly(2-VOES). The vulcanization process was monitored with time at 140° C. using a parallel plate rheometer. As shown in FIG. 2, the viscosity and shear modulus of the poly(2-VOES) material increased by a few orders of magnitude in under 5 minutes, while that of the soybean oil-based material remained unchanged over the entire two hour period. This result indicates that poly(2-VOES) produces a crosslinked network dramatically faster than that of soybean oil. In addition, films were cast onto glass panels and the panels placed in an oven set at 140° C. for 45 minutes. As shown in FIG. 3, the material based on soybean oil was still liquid while the material based on poly(2-VOES) was a tack-free rubber. These results clearly demonstrate unique capabilities for poly(2-VOES) as compared to conventional soybean oil in rubber compositions.

This technology may have major utility in rubber compounds which will drive the utilization of soybean-based materials in the rubber industry.

### Example 2. Unfilled Rubbers

Elastomers for vulcanized rubber compounds are very high molecular weight and, as a result, are very difficult to process without the addition of a “processing oil” to lower the viscosity and plasticize the polymer chains. Most processing oils are petroleum-based, relatively expensive, and some have been found to be toxic. As a result, the rubber industry has been investigating plant oils as a non-toxic, lower cost substitutes for conventional petroleum-based processing oils. Since many of the plant oil-based polyvinyl ethers described are liquids with very a low glass transition temperature (approximately −90° C.), it was of interest to evaluate their utility as a bio-based, polymeric processing oil for rubber compounds. Since these polyvinyl ethers possess a large number of double bonds per molecule, it was expected that the polymers would become part of the crosslinked network during vulcanization, which would eliminate migration of the polymeric oil to the surface of vulcanized articles. Eliminating migration of the processing oil to the vulcanized article surface is desirable, especially considering that, for some applications, the amount of processing oil (sometimes also referred to as an extender) may be equivalent or in excess of the amount of elastomer in the composition.

The following commercially available materials were used in Example 2 through Example 6

| Designation | Vendor | Tradename | Description |
|---|---|---|---|
| SBR | LION | COPO ® 1500 | Styrene-butadiene |
| | COPOLYMER | | copolymer with 23.5% |
| | | | bound styrene |
| PPO | Harwick | Stan-Plas 1200 | Hydrotreated heavy |
| | Standard | | naphthenic oil |
| | | | (CAS no. 64742-52-5) |
| SBO | Sam's Club | Soybean oil | Food grade |
| | | | soybean oil |
| CB | Sid Richardson | N100 | Carbon black |
| ZnO | Sigma-Aldrich | Zinc oxide | Zinc oxide 99-100% |
| | | | purity |
| S | Alfa-Aesar | Sulfur | Sulfur 99.5% purity |
| TBBS | Alfa-Aesar | N-tert-butyl-2- | N-tert-butyl-2- |
| | | benzothiazole-2- | benzothiazole-2- |
| | | sulfenamide | sulfenamide (CAS no. |
| | | | 95-31-8) 97% purity |
| StA | Sigma-Aldrich | Stearic acid | Stearic acid 95% |
| | | | purity |

A series of rubber compounds were produced by first blending SBR with a processing oil (i.e. PPO, SBO, P4VOBS) using a Prep-Mill® two roll mill from C. W. Brabender. The poly(4-VOBS) (poly[(4-vinyloxy)butyl soyate]), also referred to herein as “P4VOBS,” that was used possessed a number average molecular weight of 34,000 g/mole, expressed relative to polystyrene standards. Once the SBR and oil were thoroughly mixed StA, TBBS, S, and ZnO were added to the mixture using the two roll mill. Once these compounds were thoroughly mixed, the unvulcanized rubber compound was transferred to a hot press and vulcanized under a pressure of 2,000 Newtons using a cure temperature of 145° C. and cure time of 60 minutes. Table 1 describes the composition of the different rubber compounds produced.

TABLE 1
Composition of unfilled rubbers produced.

| | Type of | | Oil | | | | |
|---|---|---|---|---|---|---|---|
| Sample | Processing | SBR | Concentration | ZnO | S | TBBS | StA |
| Identification | Oil | (parts) | (parts) | (parts) | (parts) | (parts) | (parts) |
| No Oil | None | 100 | 0 | 2.4 | 1.4 | 1.0 | 0.8 |
| 2.5% PPO | PPO | 97.5 | 2.5 | 2.4 | 1.4 | 1.0 | 0.8 |
| 2.5% SBO | SBO | 97.5 | 2.5 | 2.4 | 1.4 | 1.0 | 0.8 |
| 2.5% P4VOBS | P4VOBS | 97.5 | 2.5 | 2.4 | 1.4 | 1.0 | 0.8 |
| 5% PPO | PPO | 95 | 5.0 | 2.4 | 1.4 | 1.0 | 0.8 |
| 5% SBO | SBO | 95 | 5.0 | 2.4 | 1.4 | 1.0 | 0.8 |
| 5% P4VOBS | P4VOBS | 95 | 5.0 | 2.4 | 1.4 | 1.0 | 0.8 |
| 10% PPO | PPO | 90 | 10 | 2.4 | 1.4 | 1.0 | 0.8 |
| 10% SBO | SBO | 90 | 10 | 2.4 | 1.4 | 1.0 | 0.8 |
| 10% P4VOBS | P4VOBS | 90 | 10 | 2.4 | 1.4 | 1.0 | 0.8 |
| 15% PPO | PPO | 85 | 15 | 2.4 | 1.4 | 1.0 | 0.8 |
| 15% SBO | SBO | 85 | 15 | 2.4 | 1.4 | 1.0 | 0.8 |
| 15% P4VOBS | P4VOBS | 85 | 15 | 2.4 | 1.4 | 1.0 | 0.8 |

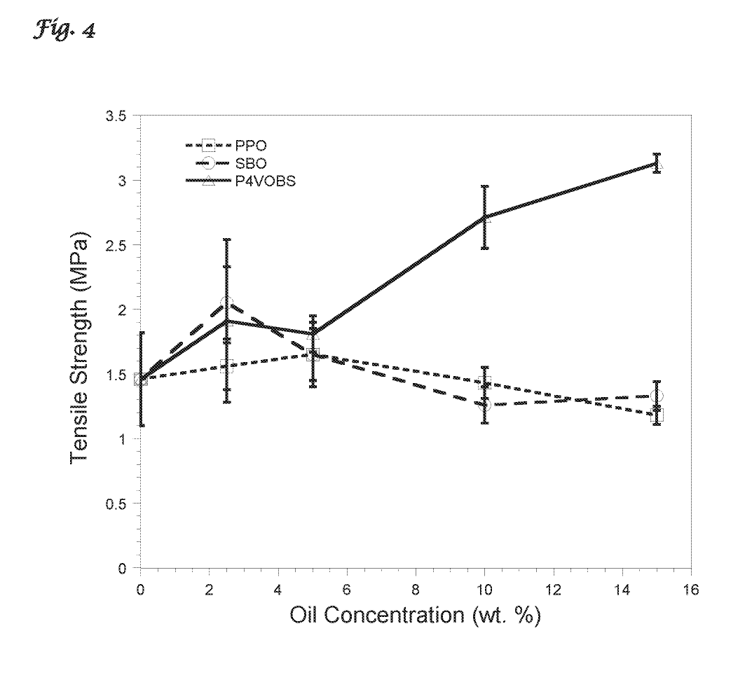

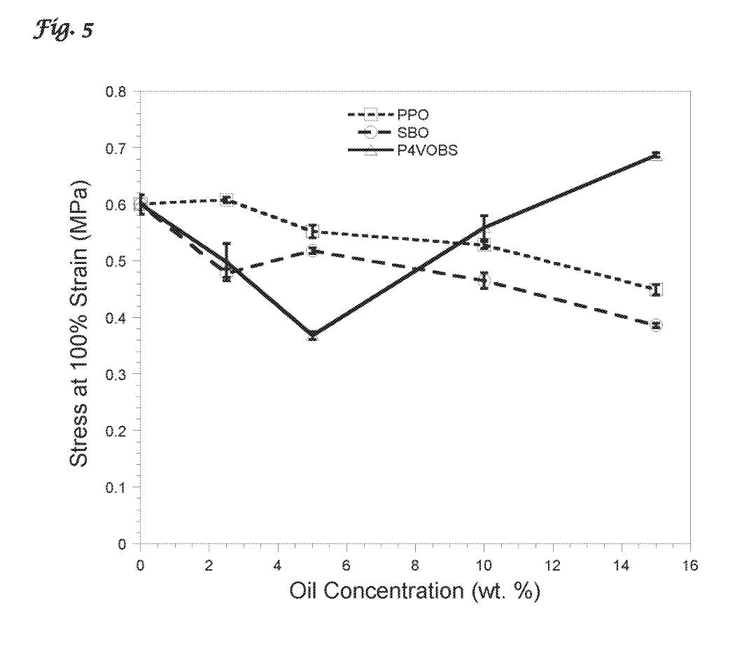

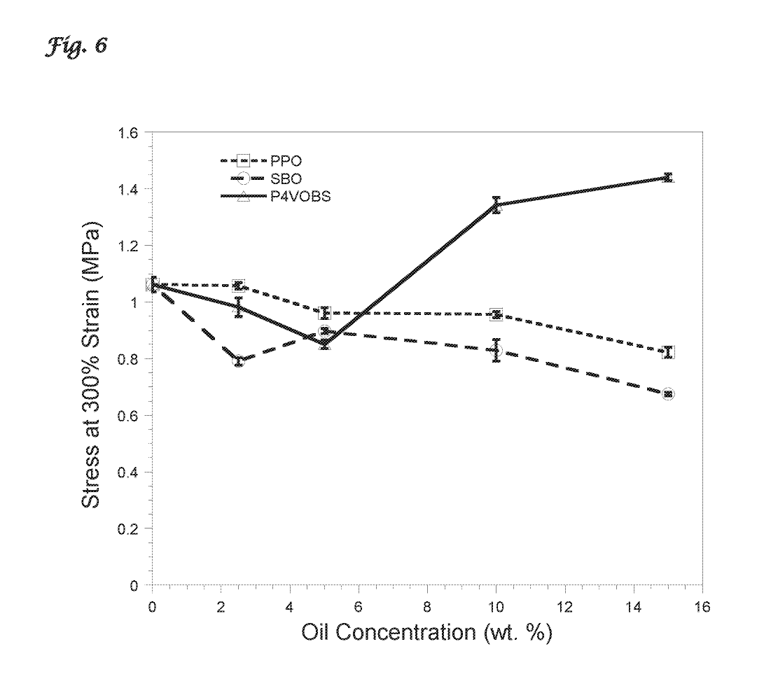

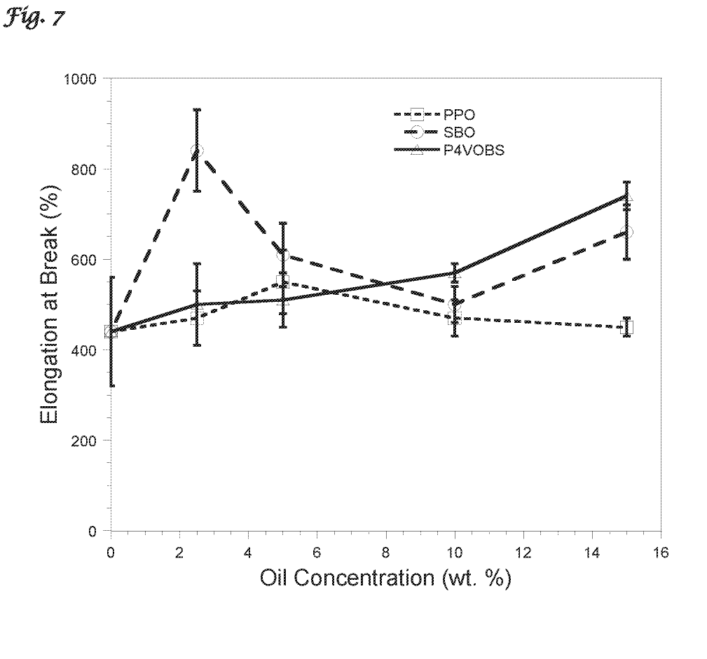

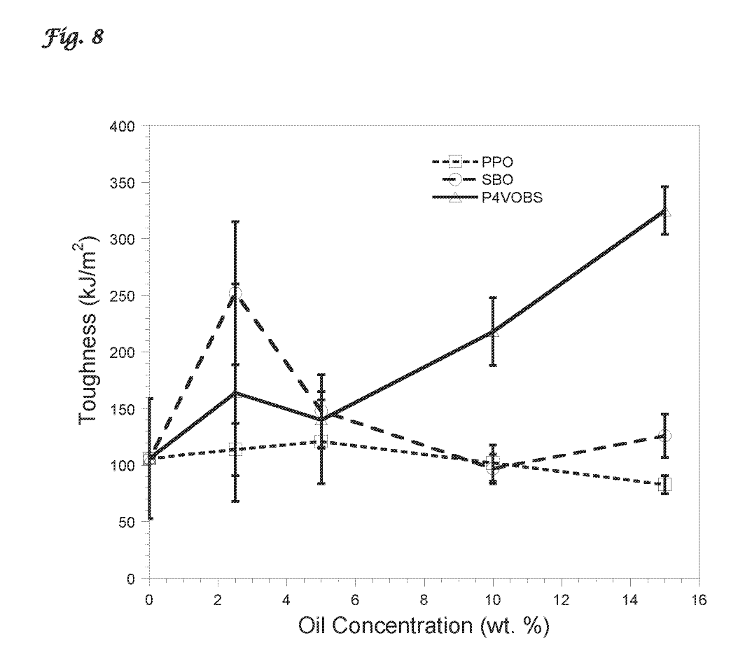

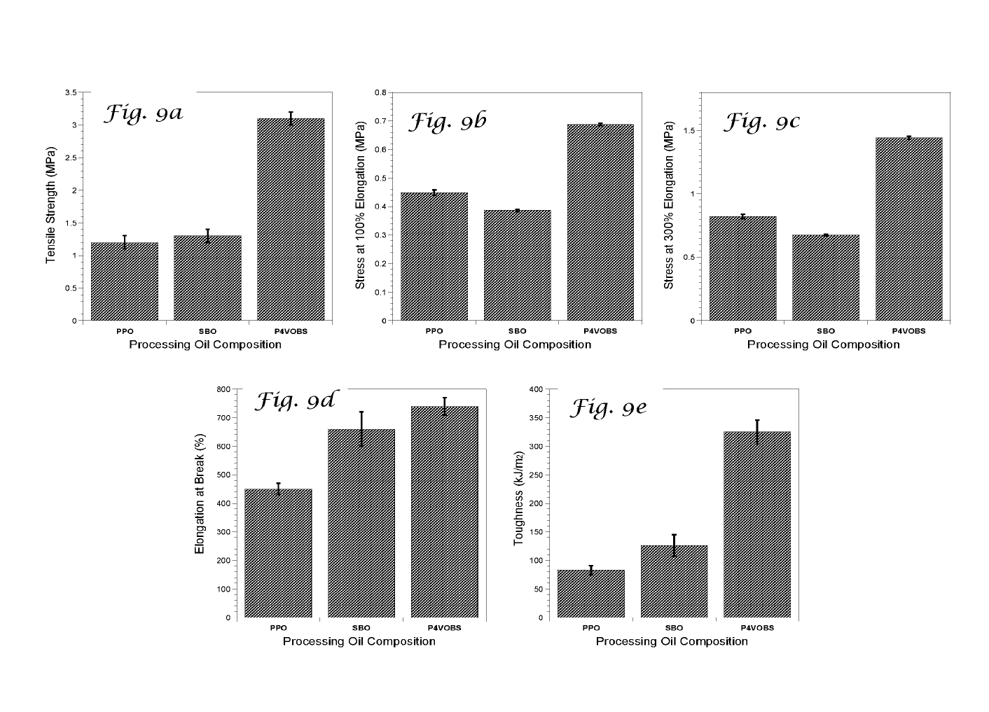

From the sheets of vulcanized rubber, ASTM D638 Type V test specimens were stamped out using a die cutter obtained from Qualitest. Stress—strain data were obtained from these test specimens using an Insight® Material Testing System from MTS. Measurements were made at ambient temperature using a crosshead speed of 20 mm/minute. Five specimens were tested for each rubber composition and the average and standard deviation for each property of interest determined. The data obtained are listed in Table 2 and shown graphically in FIGS. 4-8. At oil concentrations of 10 or 15 wt. %, the use of PPO or SBO showed no significant enhancements in tensile strength, modulus at 100% strain, modulus at 300% strain, and toughness compared to the vulcanized SBR (i.e. No Oil). In contrast, the use of P4VOBS as a processing oil significantly increased all of these properties. FIGS. 9a to 9e illustrate these results (tensile strength, FIG. 9a; stress at 100%, FIG. 9b; stress at 30%, FIG. 9c; elongation at break, FIG. 9d; and toughness, FIG. 9e) by comparing the properties of rubbers containing 15 weight percent processing oil.

TABLE 2
Mechanical properties determined for unfilled blends of SBR and
the different processing oils. Each data point represents the
average of five specimens along with the standard deviation.

| | Tensile | Stress at | Stress at | | |
|---|---|---|---|---|---|
| | strength | 100% strain | 300% strain | Elongation | Toughness |
| Sample ID | (MPa) | (MPa) | (MPa) | at break (%) | (kJ/m²) |
| No Oil | 1.46 ± 0.36 | 0.600 ± 0.017 | 1.062 ± 0.026 | 440 ± 120 | 106 ± 53 |
| 2.5% PPO | 1.56 ± 0.18 | 0.608 ± 0.005 | 1.057 ± 0.011 | 470 ± 60 | 114 ± 23 |
| 2.5% SBO | 2.05 ± 0.28 | 0.478 ± 0.007 | 0.791 ± 0.013 | 840 ± 90 | 252 ± 63 |
| 2.5% P4VOBS | 1.91 ± 0.63 | 0.498 ± 0.033 | 0.982 ± 0.033 | 500 ± 90 | 164 ± 96 |
| 5% PPO | 1.65 ± 0.25 | 0.552 ± 0.011 | 0.961 ± 0.019 | 550 ± 70 | 121 ± 37 |
| 5% SBO | 1.65 ± 0.20 | 0.518 ± 0.005 | 0.897 ± 0.009 | 610 ± 70 | 148 ± 32 |
| 5% P4VOBS | 1.81 ± 0.14 | 0.368 ± 0.007 | 0.851 ± 0.015 | 510 ± 60 | 140 ± 25 |
| 10% PPO | 1.43 ± 0.12 | 0.528 ± 0.006 | 0.956 ± 0.011 | 470 ± 40 | 102 ± 16 |
| 10% SBO | 1.26 ± 0.14 | 0.465 ± 0.014 | 0.829 ± 0.038 | 500 ± 40 | 97 ± 13 |
| 10% P4VOBS | 2.71 ± 0.24 | 0.559 ± 0.021 | 1.342 ± 0.027 | 570 ± 20 | 218 ± 30 |
| 15% PPO | 1.18 ± 0.07 | 0.449 ± 0.009 | 0.822 ± 0.017 | 450 ± 20 | 83 ± 8 |
| 15% SBO | 1.33 ± 0.11 | 0.386 ± 0.004 | 0.675 ± 0.006 | 660 ± 60 | 126 ± 19 |
| 15% P4VOBS | 3.13 ± 0.07 | 0.687 ± 0.004 | 1.441 ± 0.012 | 740 ± 30 | 325 ± 21 |

Since the P4VOBS possesses over 100 double bonds per molecule, it was expected that the polymer molecules would be incorporated into the crosslinked network upon vulcanization. Incorporation of the processing oil into the crosslinked network can be expected to be beneficial since it prevents migration of the processing oil to the surface of the molded article and subsequent changes in rubber physical and mechanical properties. FIG. 10 shows the weight of soluble material extracted from rubber compounds possessing 15 weight percent of the three different processing oils (i.e. PPO, SBO, and P4VOBS). The extraction was done using a Soxhlet extractor and toluene as the solvent. The extraction procedure consisted of cutting specimens into small (˜3 mm×5 mm×5 mm) pieces, weighing the sample, extracting in the Soxhlet extractor for 16 hours, drying the extracted samples in a vacuum oven at 60° C. for 16 hours, and weighing the extracted samples. As shown in FIG. 10, the rubber compound containing P4VOBS as the processing aid had the lowest fraction of extractable materials, while the compound containing the conventional, petroleum-based processing oil (i.e. PPO) possessed the highest content of extractables. The extractable content of the rubber compound based on SBO was lower than the PPO-based compound, but higher than the P4VOBS-containing rubber compound.

### Example 3. Carbon Black-Filled Rubbers

A series of CB-filled rubber compounds were produced by first blending SBR with a processing oil (i.e. PPO, SBO, P4VOBS) using a Prep-Mill® two roll mill from C. W. Brabender. The P4VOBS that was used possessed a number average molecular weight of 34,000 g/mole, expressed relative to polystyrene standards. Once the SBR and oil were thoroughly mixed, StA, TBBS, S, and ZnO were added to the mixture using the two roll mill. Once these compounds were thoroughly mixed, the CB was mixed in using the two roll mill. The unvulcanized rubber compound was transferred to a hot press and vulcanized under a pressure of 2,000 Newtons using a cure temperature of 145° C. and cure time of 60 minutes. Table 3 lists the composition of the different CB-filled rubber compounds produced.

TABLE 3
Composition of the CB-filled rubbers produced.

| | 10% | 10% | 10% |
|---|---|---|---|
| Raw Material | PPO + CB | SBO + CB | P4VOBS + CB |
| SBR (parts) | 90 | 90 | 90 |
| PPO (parts) | 10 | — | — |
| SBO (parts) | — | 10 | — |
| P4VOBS (parts) | — | — | 10 |
| CB (parts) | 50 | 50 | 50 |
| ZnO (parts) | 2.4 | 2.4 | 2.4 |
| S (parts) | 1.4 | 1.4 | 1.4 |
| TBBS (parts) | 1.0 | 1.0 | 1.0 |
| StA (parts) | 0.8 | 0.8 | 0.8 |

From the sheets of vulcanized rubber, ASTM D638 Type V test specimens were stamped out using a die cutter obtained from Qualitest. Stress—strain data were obtained from these test specimens using an Insight® Material Testing System from MTS. Measurements were made at ambient temperature using a crosshead speed of 20 mm/minute. Five specimens were tested for each rubber composition and the average and standard deviation for each property of interest determined. The data obtained are listed in Table 4. From the data listed in Table 4, it can be seen that the use of P4VOBS provided higher tensile strength and stress at 100 and 300% elongation than the rubber compound based on SBO as the processing oil. In general, the use of P4VOBS as the processing oil provided mechanical properties that were more similar to the rubber compound based on the conventional processing oil, PPO. In contrast, the use of SBO as a renewable-based processing oil significantly reduced tensile strength and stiffness compared to PPO.

TABLE 4
Mechanical properties determined for CB-filled blends of SBR and
the different processing oils. Each data point represents the
average of five specimens along with the standard deviation.

| | Tensile | Stress at | Stress at | | |
|---|---|---|---|---|---|
| | strength | 100% strain | 300% strain | Elongation | Toughness |
| Sample ID | (MPa) | (MPa) | (MPa) | at break (%) | (kJ/m²) |
| 10% PPO + CB | 25.4 ± 1.0 | 2.42 ± 0.21 | 8.87 ± 0.86 | 665 ± 52 | 1,888 ± 203 |
| 10% SBO + CB | 19.7 ± 0.5 | 1.58 ± 0.01 | 4.80 ± 0.05 | 810 ± 17 | 1,741 ± 97 |
| 10% P4VOBS + CB | 24.7 ± 0.3 | 2.94 ± 0.03 | 10.16 ± 0.06 | 618 ± 7 | 1,772 ± 44 |

### Example 4. Processing Oil Blends in Unfilled Rubber Compounds

An experiment was conducted in which blends of PPO and P4VOBS or SBO and P4VOBS were used as the processing oil for unfilled rubber compounds. The molecular weight of the P4VOBS utilized was 34,000 g/mole as expressed relative to polystyrene standards. First, SBR with a processing oil (i.e. PPO, SBO, P4VOBS) or processing oil blend was mixed using a Prep-Mill® two roll mill from C. W. Brabender. Once the SBR and oil were thoroughly mixed, StA, TBBS, S, and ZnO were added to the mixture using the two roll mill. Once these compounds were thoroughly mixed, the unvulcanized rubber compound was transferred to a hot press and vulcanized under a pressure of 2,000 Newtons using a cure temperature of 145° C. and cure time of 60 minutes. Table 5 describes the compositions of the different rubber compounds produced.

TABLE 5
A description of the compositions of rubber compounds
based on binary blends of processing oils.

| | SBR | PPO | SBO | P4VOBS | ZnO | S | TBBS | StA |
|---|---|---|---|---|---|---|---|---|
| Sample ID | (parts) | (parts) | (parts) | (parts) | (parts) | (parts) | (parts) | (parts) |
| 15PPO | 85 | 15.00 | — | — | 2.4 | 1.4 | 1.0 | 0.8 |
| 11.25/3.75 | 85 | 11.25 | — | 3.75 | 2.4 | 1.4 | 1.0 | 0.8 |
| PPO/P4VOBS | | | | | | | | |
| 7.5/7.5 | 85 | 7.50 | — | 7.50 | 2.4 | 1.4 | 1.0 | 0.8 |
| PPO/P4VOBS | | | | | | | | |
| 3.75/11.25 | 85 | 3.75 | — | 11.25 | 2.4 | 1.4 | 1.0 | 0.8 |
| PPO/P4VOBS | | | | | | | | |
| 15SBO | 85 | — | 15.00 | — | 2.4 | 1.4 | 1.0 | 0.8 |
| 11.25/3.75 | 85 | — | 11.25 | 3.75 | 2.4 | 1.4 | 1.0 | 0.8 |
| SBO/P4VOBS | | | | | | | | |
| 7.5/7.5 | 85 | — | 7.50 | 7.50 | 2.4 | 1.4 | 1.0 | 0.8 |
| SBO/P4VOBS | | | | | | | | |
| 3.75/11.25 | 85 | — | 3.75 | 11.25 | 2.4 | 1.4 | 1.0 | 0.8 |
| SBO/P4VOBS | | | | | | | | |
| 15P4VOBS | 85 | — | — | 15.00 | 2.4 | 1.4 | 1.0 | 0.8 |

From the sheets of vulcanized rubber, ASTM D638 Type V test specimens were stamped out using a die cutter obtained from Qualitest. Stress—strain data were obtained from these test specimens using an Insight® Material Testing System from MTS. Measurements were made at ambient temperature using a crosshead speed of 500 mm/minute. Five specimens were tested for each rubber composition and the average and standard deviation for each property of interest determined. The data obtained are listed in Table 6. In general, displacing some of the PPO or SBO with P4VOBS increased tensile strength, stress at 100% and 300% elongation, and toughness.

TABLE 6
The mechanical properties of rubber compounds based on blends of processing oils.

| | Tensile | Stress at | Modulus at | | |
|---|---|---|---|---|---|
| | strength | 100% strain | 300% strain | Elongation | Toughness |
| Sample ID | (MPa) | (MPa) | (MPa) | at break (%) | (kJ/m²) |
| 15PPO | 2.1 ± 0.3 | 0.620 ± 0.005 | 1.079 ± 0.014 | 631 ± 68 | 186 ± 38 |
| 11.25/3.75 | 2.6 ± 0.9 | 0.644 ± 0.002 | 1.132 ± 0.004 | 699 ± 162 | 249 ± 126 |
| PPO/P4VOBS | | | | | |
| 7.5/7.5 | 3.0 ± 0.4 | 0.711 ± 0.006 | 1.307 ± 0.020 | 702 ± 90 | 280 ± 71 |
| PPO/P4VOBS | | | | | |
| 3.75/11.25 | 4.3 ± 1.1 | 0.754 ± 0.009 | 1.411 ± 0.027 | 900 ± 175 | 496 ± 184 |
| PPO/P4VOBS | | | | | |
| 15SBO | 2.1 ± 0.3 | 0.552 ± 0.003 | 0.894 ± 0.005 | 795 ± 83 | 229 ± 44 |
| 11.25/3.75 | 2.3 ± 0.4 | 0.594 ± 0.002 | 0.994 ± 0.003 | 768 ± 131 | 245 ± 75 |
| SBO/P4VOBS | | | | | |
| 7.5/7.5 | 3.0 ± 0.4 | 0.659 ± 0.007 | 1.158 ± 0.015 | 830 ± 98 | 333 ± 69 |
| SBO/P4VOBS | | | | | |
| 3.75/11.25 | 3.5 ± 0.2 | 0.751 ± 0.005 | 1.403 ± 0.012 | 804 ± 28 | 376 ± 26 |
| SBO/P4VOBS | | | | | |
| 15P4VOBS | 3.4 ± 0.5 | 0.840 ± 0.005 | 1.655 ± 0.021 | 729 ± 87 | 347 ± 71 |

### Example 5. Processing Oil Blends in CB-Filled Rubber Compounds

An experiment was conducted in which blends of PPO and P4VOBS or SBO and P4VOBS were used as the processing oil for CB-filled rubber compounds. The molecular weight of the P4VOBS utilized was 34,000 g/mole, as expressed relative to polystyrene standards. First, SBR with a processing oil (i.e. PPO, SBO, P4VOBS) or processing oil blend was mixed using a Prep-Mill® two roll mill from C. W. Brabender. Once the SBR and oil were thoroughly mixed, StA, TBBS, S, and ZnO were added to the mixture using the two roll mill. Once these compounds were thoroughly mixed, CB was added and thoroughly mixed using the two roll mill. The unvulcanized rubber compound was the transferred to a hot press and vulcanized under a pressure of 2,000 Newtons using a cure temperature of 145° C. and cure time of 60 minutes. Table 7 describes the compositions of the different rubber compounds produced.

TABLE 7
A description of the compositions of rubber compounds based on
binary blends of processing oils. In addition to the components
listed in the table, each composition also contained 2.4 parts
of ZnO, 1.4 parts S, 1.0 parts TBBS, and 0.8 parts StA.

| | SBR | PPO | SBO | P4VOBS | CB |
|---|---|---|---|---|---|
| Sample ID | (parts) | (parts) | (parts) | (parts) | (parts) |
| 10PPO + CB | 85 | 15.00 | — | — | 50 |
| 7.5/2.5 PPO/ | 85 | 11.25 | — | 3.75 | 50 |
| P4VOBS + CB | | | | | |
| 5/5 PPO/ | 85 | 7.50 | — | 7.50 | 50 |
| P4VOBS + CB | | | | | |
| 2.5/7.5 PPO/ | 85 | 3.75 | — | 11.25 | 50 |
| P4VOBS + CB | | | | | |
| 10SBO + CB | 85 | — | 15.00 | — | 50 |
| 7.5/2.5 SBO/ | 85 | — | 11.25 | 3.75 | 50 |
| P4VOBS + CB | | | | | |
| 5/5 SBO/ | 85 | — | 7.50 | 7.50 | 50 |
| P4VOBS + CB | | | | | |
| 2.5/7.5 SBO/ | 85 | — | 3.75 | 11.25 | 50 |
| P4VOBS + CB | | | | | |
| 10P4VOBS + CB | 85 | — | — | 15.00 | 50 |

From the sheets of vulcanized rubber, ASTM D638 Type V test specimens were stamped out using a die cutter obtained from Qualitest. Stress—strain data were obtained from these test specimens using an Insight® Material Testing System from MTS. Measurements were made at ambient temperature using a crosshead speed of 500 mm/minute. Five specimens were tested for each rubber composition and the average and standard deviation for each property of interest determined. The mechanical properties of the rubber compounds based on blends of PPO and P4VOBS or SBO and P4VOBS are shown in Table 8. In general, displacing some of the PPO or SBO with P4VOBS increased stress at 100% and 300% elongation, but decreased elongation at break and toughness.

TABLE 8
The mechanical properties of CB-filled rubber compounds based on blends of processing oils.

| | Tensile | Stress at | Stress at | | |
|---|---|---|---|---|---|
| | strength | 100% strain | 300% strain | Elongation | Toughness |
| Sample | (MPa) | (MPa) | (MPa) | at break (%) | (kJ/m²) |
| 10PPO + CB | 24.5 ± 0.5 | 2.789 ± 0.052 | 9.016 ± 0.238 | 682 ± 18 | 1962 ± 89 |
| 7.5/2.5PPO/P4VOBS + CB | 23.8 ± 0.3 | 3.152 ± 0.041 | 10.102 ± 0.186 | 629 ± 11 | 1799 ± 50 |
| 5/5PPO/P4VOBS + CB | 23.4 ± 0.6 | 3.479 ± 0.072 | 11.607 ± 0.290 | 566 ± 12 | 1610 ± 78 |
| 2.5/7.5PPO/P4VOBS + CB | 21.5 ± 1.3 | 3.200 ± 0.033 | 10.303 ± 0.187 | 567 ± 30 | 1462 ± 167 |
| 10SBO + CB | 21.7 ± 0.3 | 2.105 ± 0.035 | 6.221 ± 0.065 | 829 ± 16 | 2110 ± 66 |
| 7.5/2.5SBO/P4VOBS + CB | 21.7 ± 0.5 | 2.174 ± 0.016 | 6.553 ± 0.050 | 776 ± 17 | 1975 ± 103 |
| 5/5 SBO/P4VOBS + CB | 21.5 ± 0.3 | 3.126 ± 0.043 | 9.721 ± 0.062 | 619 ± 12 | 1642 ± 63 |
| 2.5/7.5SBO/P4VOBS + CB | 23.9 ± 2.3 | 3.020 ± 0.029 | 9.963 ± 0.144 | 640 ± 61 | 1839 ± 338 |
| 10P4VOBS + CB | 21.9 ± 1.3 | 3.598 ± 0.024 | 12.088 ± 0.082 | 519 ± 32 | 1393 ± 174 |

### Example 6. Influence of P4VOBS Molecular Weight in Unfilled Rubber Compounds

For Examples 2 through 5, the P4VOBS utilized possessed a number-average molecular weight, as expressed relative to polystyrene standards, of 34,000 g/mole. Since the molecular weight of P4VOBS can be easily tailored, which affects the viscosity of the polymer, an experiment was conducted in which the effect of P4VOBS molecular weight on the mechanical properties of unfilled rubber compounds was determined. P4VOBS molecular weight was easily varied by adjusting the ratio of 4-VOBS to the initiator (i.e. cationogen). The three different P4VOBS samples produced possessed number average molecular weights of 5,000 g/mole, 12,000 g/mole, and 34,000 g/mole, as expressed relative to polystyrene standards. The viscosity of these three polymers was measured using an ARES Rheometer from TA Instruments operating in steady shear mode at a temperature of 23° C. The viscosities of the P4VOBS samples at a shear rate of 10 s⁻¹ are listed in Table 9 along with values for SBO and PPO.

TABLE 9
Viscosity of P4VOBS polymers produced.

| Material | Viscosity at 10 s⁻¹ (cP) |
|---|---|
| PPO | 420 |
| SBO | 20 |
| P4VOBS 5,000 g/mole | 170 |
| P4VOBS 12,000 g/mole | 590 |
| P4VOBS 34,000 g/mole | 2,260 |

Unfilled rubber compounds were produced by mixing SBR with a processing oil (i.e. PPO, SBO, P4VOBS) using a Prep-Mill® two roll mill from C. W. Brabender. Once the SBR and oil were thoroughly mixed, StA, TBBS, S, and ZnO were added to the mixture using the two roll mill. Once these compounds were thoroughly mixed, the unvulcanized rubber compound was transferred to a hot press and vulcanized under a pressure of 2,000 Newtons using a cure temperature of 145° C. and cure time of 60 minutes. Table 10 describes the compositions of the different rubber compounds produced.

TABLE 10
A description of the compositions for rubber compounds based P4VOBS
polymers of varying molecular weight. In addition to the components
listed in the table, each composition also contained 2.4 parts of
ZnO, 1.4 parts S, 1.0 parts TBBS, and 0.8 parts StA.

| | P4VOBS | | | | |
|---|---|---|---|---|---|
| | molecular | | | | |
| | weight | SBR | PPO | SBO | P4VOBS |
| Sample | (g/mole) | (parts) | (parts) | (parts) | (parts) |
| 15PPO | — | 90 | 15 | — | — |
| 15SBO | — | 90 | — | 15 | — |
| 15 5K P4VOBS | 5,000 | 90 | — | — | 15 |
| 15 12K P4VOBS | 12,000 | 90 | — | — | 15 |
| 15 34K P4VOBS | 34,000 | 90 | — | — | 15 |

From the sheets of vulcanized rubber, ASTM D638 Type V test specimens were stamped out using a die cutter obtained from Qualitest. Stress—strain data were obtained from these test specimens using an Insight® Material Testing System from MTS. Measurements were made at ambient temperature using a crosshead speed of 500 mm/minute. Five specimens were tested for each rubber composition and the average and standard deviation for each property of interest determined. Table 11 provides the data obtained. As shown in Table 11, increasing P4VOBS molecular weight increases all of the mechanical properties tested.

TABLE 11
The mechanical properties of unfilled rubber compounds based
P4VOBS of varying molecular weight as the processing oil.

| | Tensile | Stress at | Stress at | | |
|---|---|---|---|---|---|
| | strength | 100% strain | 300% strain | Elongation | Toughness |
| Sample ID | (MPa) | (MPa) | (MPa) | at break (%) | (kJ/m²) |
| 15PPO | 1.18 ± 0.07 | 0.449 ± 0.009 | 0.822 ± 0.017 | 450 ± 20 | 83 ± 8 |
| 15SBO | 1.33 ± 0.11 | 0.386 ± 0.004 | 0.675 ± 0.006 | 660 ± 60 | 126 ± 19 |
| 15 5K P4VOBS | 1.18 ± 0.02 | 0.450 ± 0.014 | 0.826 ± 0.010 | 460 ± 10 | 81 ± 3 |
| 15 12K P4VOBS | 1.50 ± 0.10 | 0.573 ± 0.008 | 1.088 ± 0.016 | 470 ± 50 | 111 ± 22 |
| 15 34K P4VOBS | 3.13 ± 0.07 | 0.687 ± 0.004 | 1.441 ± 0.012 | 740 ± 30 | 325 ± 21 |

### Example 7. Influence of P4VOBS Molecular Weight in CB-Filled Rubber Compounds

For Examples 2 through 5, the P4VOBS utilized possessed a number-average molecular weight, as expressed relative to polystyrene standards, of 34,000 g/mole. Since the molecular weight of P4VOBS can be easily tailored, which affects the viscosity of the polymer, an experiment was conducted in which the effect of P4VOBS molecular weight on the mechanical properties of CB-filled rubber compounds was determined. P4VOBS molecular weight was easily varied by adjusting the ratio of 4-VOBS to the initiator (i.e. cationogen). The three different P4VOBS samples produced possessed number average molecular weights of 5,000 g/mole, 12,000 g/mole, and 34,000 g/mole, as expressed relative to polystyrene standards. For the production of the rubber compounds, SBR was mixed with a processing oil (i.e. PPO, SBO, P4VOBS) using a Prep-Mill® two roll mill from C. W. Brabender. Once the SBR and oil were thoroughly mixed, StA, TBBS, S, and ZnO were added to the mixture using the two roll mill. Once these compounds were thoroughly mixed, CB was added and thoroughly mixed using the two roll mill. The unvulcanized rubber compound was the transferred to a hot press and vulcanized under a pressure of 2,000 Newtons using a cure temperature of 145° C. and cure time of 60 minutes. Table 12 describes the compositions of the different rubber compounds produced.

TABLE 12
A description of the compositions for rubber compounds based P4VOBS
polymers of varying molecular weight. In addition to the components
listed in the table, each composition also contained 2.4 parts of
ZnO, 1.4 parts S, 1.0 parts TBBS, and 0.8 parts StA.

| | P4VOBS | | | | | |
|---|---|---|---|---|---|---|
| | molecular | | | | | |
| | weight | SBR | PPO | SBO | P4VOBS | CB |
| Sample | (g/mole) | (parts) | (parts) | (parts) | (parts) | (parts) |
| 10PPO + CB | — | 90 | 15 | — | — | 50 |
| 10SBO + CB | — | 90 | — | 15 | — | 50 |
| 10 5K | 5,000 | 90 | — | — | 15 | 50 |
| P4VOBS + CB | | | | | | |
| 10 12K | 12,000 | 90 | — | — | 15 | 50 |
| P4VOBS + CB | | | | | | |
| 10 34K | 34,000 | 90 | — | — | 15 | 50 |
| P4VOBS + CB | | | | | | |

From the sheets of vulcanized rubber, ASTM D638 Type V test specimens were stamped out using a die cutter obtained from Qualitest. Stress—strain data were obtained from these test specimens using an Insight® Material Testing System from MTS. Measurements were made at ambient temperature using a crosshead speed of 500 mm/minute. Five specimens were tested for each rubber composition and the average and standard deviation for each property of interest determined. Table 13 provides the data obtained.

TABLE 13
The mechanical properties of CB-filled rubber compounds based
P4VOBS of varying molecular weight as the processing oil.

| | Tensile | Stress at | Stress at | | |
|---|---|---|---|---|---|
| | strength | 100% strain | 300% strain | Elongation | Toughness |
| Sample ID | (MPa) | (MPa) | (MPa) | at break (%) | (kJ/m²) |
| 10PPO + CB | 25.4 ± 1.0 | 2.416 ± 0.209 | 8.867 ± 0.859 | 665 ± 52 | 1888 ± 203 |
| 10SBO + CB | 19.7 ± 0.5 | 1.575 ± 0.009 | 4.796 ± 0.050 | 810 ± 17 | 1741 ± 97 |
| 10 5K P4VOBS + CB | 24.9 ± 0.7 | 2.163 ± 0.012 | 6.969 ± 0.071 | 779 ± 19 | 2174 ± 124 |
| 10 12K P4VOBS + CB | 21.3 ± 0.6 | 2.603 ± 0.025 | 8.926 ± 0.080 | 587 ± 15 | 1419 ± 77 |
| 10 34K P4VOBS + CB | 24.7 ± 0.3 | 2.944 ± 0.034 | 10.16 ± 0.064 | 618 ± 7 | 1772 ± 44 |

### Example 8. Synthesis of a Low Molecular Weight Poly(Vinyl Ether) Polymer Based on Soybean Oil

Table 14 lists the materials used in Examples 8 through 11.

TABLE 14
Materials

| Acronym | Description | Source | Tradename |
|---|---|---|---|
| KER 1502 | Styrene-butadiene | Synthos | KER 1502 |
| | elastomer | | |
| COPO 1500 | Styrene-butadiene | Lion Copolymers | COPO 1500 |
| | elastomer | | |
| CB | Carbon black | Cabot | Vulcan 3 N330* |
| ZnO | Zinc oxide | Sigma-Aldrich | — |
| SA | Stearic acid | Sigma-Aldrich | — |
| SBO | Soybean oil | Sam's Club | — |
| SS | Sucrose soyate | Proctor and Gamble | Sefose 1618U |
| AR Oil | High boiling | Valero | ValAro 130A |
| | aromatic oil | | |
| TBBS | N-tert-butyl-2- | Sigma-Aldrich | — |
| | benzothiazole- | | |
| | 2-sulfenamide | | |
| S8 | Sulfur | Sigma-Aldrich | — |
| Styrene | Styrene | Sigma-Aldrich | — |
| dTBP | Di-tert-Butyl | Sigma-Aldrich | Luperox DI |
| | peroxide | | |
| Xylene | Xylene | Sigma-Aldrich | — |

Synthesis of 2-VOES Monomer.

2-VOES ((2-vinyloxy)ethyl soyate) used produce poly(2-VOES) (poly[(2-vinyloxy)ethyl soyate]) with a molecular weight of 2,100 g/mole, utilized in Examples VIII through X, was synthesized as follows: A 10 L jacketed reaction vessel equipped with reflux condenser, nitrogen bubbler, and stirrer was loaded with 1.5 kg of methyl soyate (MeSoy) purified by passing through a silica column and 1.3 kg of distilled monoethylene glycol vinyl ether (MEGVE). Dry K₂CO₃ (30 g) was added to the reaction mixture and the reaction was allowed to proceed for 2 hours at 100° C. (in the jacket) and 200 mbar to provide (2-vinyloxy)ethyl soyate in excess MEGVE. The temperature in the reflux condenser was maintained in the range 3 to 6° C. After the reaction was completed, the excess of MEGVE was distilled off under vacuum, starting at 100 mbar pressure and 60° C. (in the jacket) and gradually changing pressure to 10 mbar until distillation was complete. Then the reaction mixture was cooled down to 25° C. and washed three times with deionized water (1.5 l for each wash). After washing, the mixture was allowed to separate for 1 to 6 hours and the clear aqueous phase was discarded. The washed product was dried over MgSO₄, filtered, and distilled using a thin-film evaporator operating at a pressure of 1 Torr and temperature 130° C.

Synthesis of Poly(2-VOES).

Poly(2-VOES) (poly[(2-vinyloxy)ethyl soyate]) having a molecular weight of 2,100 g/mole was synthesized as follows: A three-neck 1 L flask was equipped with a mechanical stirrer, thermometer, nitrogen gas purge. The flask was charged with 230 ml of dichloromethane, 300 ml of 2-VOES, and 15 ml of anhydrous 1,4-dioxane and cooled down to 7° C. using an ice bath. Next, 7.5 g of acetic acid was dissolved in 10 ml of methylene chloride in a vial and charged to the reaction mixture. After 5 minutes, 24 ml of 0.1M tin tetrachloride solution in dichloromethane was charged to the reaction mixture under vigorous stirring to initiate the polymerization. The polymerization was allowed to proceed for 45 minutes at a temperature of 13-15° C. After 45 minutes, 100 ml of methanol was poured into the reaction mixture over a two minute period to quench the polymerization. The poly(2-VOES) solution in dichloromethane was washed three times with 500 to 700 mL of methanol and the polymer isolated by stripping off the dichloromethane using a rotary evaporator operating at reduced pressure. Yield 267.5 g (99%). The molecular weight of the polymer was determined using gel permeation chromatography and expressed relative to polystyrene standards. The molecular weight was 2,100 g/mole.

### Example 9. Sucrose Soyate and Poly(2-VOES) as the Processing Oil in a Rubber Compound Containing 50 Phr Processing Oil and 110 Phr CB

Table 15 lists the ingredients and their concentration used to produce rubber compounds containing 50 phr of a processing oil and 110 phr CB. The table also provides the mechanical properties obtained for the vulcanized rubbers. For each rubber compound, a master batch was first produced using a by charging the KER 1502, CB, and processing oil and mixing for one minute at 20 rpm using a HAAKE™ Rheomix OS Lab Mixer from Thermoscientific equipped with Banbury-type mixing blades. The set temperature of the mixer was 60° C. Next, ZnO and SA were added and the material mixed for at 60 rpm using a set temperature of 60° C. Mixing was continued until the torque measured during the mixing was relatively constant. Generally the mixing time required to achieve a constant torque was 7 to 8 minutes. During the mixing process, the internal temperature of the mixer typically reached 100° C. Next, the appropriate amount of S8 and TBBS were mixed with the master batch using a two roll mill and a gap between the rolls of 0.04 inches. The two roll was a Prep-Mill™ from Brabender. Once it appeared that the S8 and TBBS has been thoroughly incorporated into the rubber compound, the rubber was cut, folded, and run through the two roll mill eight more times to ensure a homogeneous mixture.

For vulcanization, circular sheets of the rubber compound about 10 cm in diameter were placed within a large rubber O-ring (inside diameter of 12 cm) which was placed between two aluminum platens of a hot press and a vacuum placed on the material for 5 minutes. Next, the rubber compound was vulcanized at 145° C. for 35 minutes using an applied force of 2360 to 2400 N. Samples for mechanical property testing were obtained by stamping specimens from the vulcanized rubber using a die that was in the shape of ASTM D638 Type V tensile specimens. Modulus, tensile strength, and elongation were determined according to ASTM D412. The value of the modulus was taken at 100% and 300% elongation.

Table 15 provides the composition and properties of rubbers based on a formulation that utilizes 50.0 phr of processing oil. By comparing the properties of Reference Composition 2 to Reference Composition 1, it can be seen that direct substitution of the conventional petroleum-based processing oil (AR Oil) with SBO results in dramatic reductions in moduli and tensile strength. Since SBO contains unsaturation, a third reference composition was produced (Reference Composition 3) in which additional curative was added to account for the “extra” unsaturation in the formulation. By comparing Reference Composition 3 to Reference Composition 2, it can be seen that this increase in curatives increased moduli and tensile strength, but not nearly to the level of that of Reference Composition 1. Thus, these results show that the use of SBO as a processing oil substantially reduces key mechanical properties, such as moduli and tensile strength, compared to the use of the conventional petroleum-based processing oil (AR Oil).

Comparing the properties of Samples 1 and 2 to Reference Composition 3, it can be seen that both SS and the poly(2-VOES) provide substantially higher moduli and tensile strength when used as a processing oil than SBO. In addition, the mechanical properties of the rubbers based on SS (Sample 1) and poly(2-VOES) (Sample 2) were quite similar to the properties obtained using the conventional petroleum-based processing oil (AR Oil) (Reference Composition 1).

TABLE 15
Compositions and properties of the rubber compounds produced. All values
are in units of parts per 100 parts of elastomer (i.e. KER 1502).

| | Reference 1 | Reference 2 | Reference 3 | Sample 1 | Sample 2 |
|---|---|---|---|---|---|
| Starting Material | | | | | |
| KER 1502 | 100.00 | 100.00 | 100.00 | 100.00 | 100.00 |
| AR Oil | 50.00 | — | — | — | — |
| SBO | — | 50.00 | 50.00 | — | — |
| SS | — | — | — | 50.00 | — |
| Poly(2-VOES) | — | — | — | — | 50.00 |
| CB | 110.00 | 110.00 | 110.00 | 110.00 | 110.00 |
| ZnO | 3.00 | 3.00 | 4.50 | 4.50 | 4.50 |
| SA | 1.00 | 1.00 | 1.50 | 1.50 | 1.50 |
| TBBS | 1.50 | 1.50 | 1.50 | 1.50 | 1.50 |
| S8 | 1.75 | 1.75 | 2.625 | 2.625 | 2.625 |
| Properties | | | | | |
| Modulus at 300% | 11.92 ± 0.16 | 6.45 ± 0.17 | 9.24 ± 0.15 | 11.73 ± 0.15 | 12.44 ± 0.15 |
| elongation (MPa) | | | | | |
| Modulus at 100% | 3.41 ± 0.07 | 2.18 ± 0.05 | 2.63 ± 0.05 | 3.17 ± 0.04 | 3.33 ± 0.04 |
| elongation (MPa) | | | | | |
| Tensile Strength | 16.8 ± 0.8 | 11.3 ± 0.3 | 14.4 ± 0.5 | 16.5 ± 0.8 | 16.7 ± 0.6 |
| (MPa) | | | | | |
| Elongation (%) | 424 ± 26 | 513 ± 19 | 452 ± 16 | 412 ± 18 | 396 ± 13 |

### Example 10. Sucrose Soyate (SS) and Poly(2-VOES) as the Processing Oil in a Rubber Compound Containing 37.50 Phr Processing Oil and 101 Phr CB

Table 16 lists the ingredients and their concentration used to produce rubber compounds containing 37.5 phr of a processing oil and 101 phr CB. The table also provides the mechanical properties obtained for the vulcanized rubbers. For each rubber compound, a master batch was first produced using a by charging the KER 1502, CB, and processing oil and mixing for one minute at 20 rpm using a HAAKE™ Rheomix OS Lab Mixer from Thermoscientific equipped with Banbury-type mixing blades. The set temperature of the mixer was 60° C. Next, ZnO and SA were added and the material mixed for at 60 rpm using a set temperature of 60° C. Mixing was continued until the torque measured during the mixing was relatively constant. Generally the mixing time required to achieve a constant torque was 7 to 8 minutes. During the mixing process, the internal temperature of the mixer typically reached 100° C. Next, the appropriate amount of S8 and TBBS were mixed with the master batch using a two roll mill and a gap between the rolls of 0.04 inches. The two roll was a Prep-Mill™ from Brabender. Once it appeared that the S8 and TBBS has been thoroughly incorporated into the rubber compound, the rubber was cut, folded, and run through the two roll mill eight more times to ensure a homogeneous mixture.

For vulcanization, circular sheets of the rubber compound about 10 cm in diameter were placed within a large rubber O-ring (inside diameter of 12 cm) which was placed between two aluminum platens of a hot press and a vacuum placed on the material for 5 minutes. Next, the rubber compound was vulcanized at 145° C. for 35 minutes using an applied force of 2360 to 2400 N. Samples for mechanical property testing were obtained by stamping specimens from the vulcanized rubber using a die that was in the shape of ASTM D638 Type V tensile specimens. Modulus, tensile strength, and elongation were determined according to ASTM D412. The value of the modulus was taken at 100% and 300% elongation. Mooney viscosity was measured at 100° C. according to ASTM D1646.

Table 16 provides the composition and properties of rubbers based on a formulation that utilizes 37.5 phr of processing oil. By comparing the properties of Reference Composition 5 to Reference Composition 4, it can be seen that direct substitution of the conventional petroleum-based processing oil (AR Oil) with SBO results in dramatic reductions in moduli and tensile strength. Since SBO contains unsaturation, a third reference composition was produced (Reference Composition 6) in which additional curative was added to account for the “extra” unsaturation in the formulation. By comparing Reference Composition 6 to Reference Composition 5, it can be seen that this increase in curatives increased moduli and tensile strength, but not nearly to the level of that of Reference Composition 4. Thus, these results show that the use of SBO as a processing oil substantially reduces key mechanical properties, such as moduli and tensile strength, compared to the use of the conventional petroleum-based processing oil (AR Oil).

Comparing the properties of Samples 3 and 4 to Reference Composition 6, it can be seen that both SS and the poly(2-VOES) provide substantially higher moduli and tensile strength when used as a processing oil than SBO. In addition, the mechanical properties of the rubbers based on SS (Sample 3) and poly(2-VOES) (Sample 4) were quite similar to the properties obtained using the conventional petroleum-based processing oil (AR Oil) (Reference Composition 4). Further, the Mooney viscosity obtained for Samples 3 and 4 were dramatically lower than that for Reference Composition 6 and lower than that for Reference Composition 4. This result indicates that Samples 3 and 4 would require less energy to process the rubbers.

TABLE 16
Compositions and properties of the rubber compounds produced. All values
are in units of parts per 100 parts of elastomer (i.e. KER 1502).

| | Reference 4 | Reference 5 | Reference 6 | Sample 3 | Sample 4 |
|---|---|---|---|---|---|
| Starting Material | | | | | |
| KER 1502 | 100.00 | 100.00 | 100.00 | 100.00 | 100.00 |
| AR Oil | 37.50 | — | — | — | — |
| SBO | — | 37.50 | 37.50 | — | — |
| SS | — | — | — | 37.50 | — |
| Poly(2-VOES) | — | — | — | — | 37.50 |
| CB | 101.00 | 101.00 | 101.00 | 101.00 | 101.00 |
| ZnO | 3.00 | 3.00 | 4.13 | 4.13 | 4.13 |
| SA | 1.00 | 1.00 | 1.38 | 1.38 | 1.38 |
| TBBS | 1.38 | 1.38 | 1.38 | 1.38 | 1.38 |
| S8 | 1.75 | 1.75 | 2.41 | 2.41 | 2.41 |
| Properties | | | | | |
| Mooney viscosity | 64.4 | NA | NA | 58.0 | 61.2 |
| Modulus at 300% | 14.82 ± 0.20 | 9.04 ± 0.13 | 11.68 ± 0.10 | 14.06 ± 0.13 | 13.18 ± 0.06 |
| elongation (MPa) | | | | | |
| Modulus at 100% | 4.17 ± 0.05 | 2.93 ± 0.04 | 3.27 ± 0.06 | 3.78 ± 0.08 | 3.50 ± 0.06 |
| elongation (MPa) | | | | | |
| Tensile Strength | 19.3 ± 0.4 | 14.2 ± 0.4 | 16.9 ± 1.1 | 18.3 ± 0.4 | 18.1 ± 0.4 |
| (MPa) | | | | | |
| Elongation (%) | 398 ± 9 | 478 ± 11 | 430 ± 30 | 385 ± 11 | 400 ± 9 |

Table 17 shows data for analogous rubbers to those described in Table 16, with the exception that COPO 1500 was used as the elastomer instead of KER 1502.

TABLE 17
Compositions and properties of the rubber compounds produced. All values
are in units of parts per 100 parts of elastomer (i.e. KER 1502).

| | Reference 7 | Reference 8 | Reference 9 | Sample 5 | Sample 6 |
|---|---|---|---|---|---|
| Starting Material | | | | | |
| KER 1502 | 100.00 | 100.00 | 100.00 | 100.00 | 100.00 |
| AR Oil | 25.00 | — | — | — | — |
| SBO | — | 25.00 | 25.00 | — | — |
| SS | — | — | — | 25.00 | — |
| Poly(2-VOES) | — | — | — | — | 25.00 |
| CB | 92.00 | 92.00 | 92.00 | 92.00 | 92.00 |
| ZnO | 3.00 | 3.00 | 3.75 | 3.75 | 3.75 |
| SA | 1.00 | 1.00 | 1.25 | 1.25 | 1.25 |
| TBBS | 1.25 | 1.25 | 1.25 | 1.25 | 1.25 |
| S8 | 1.75 | 1.75 | 2.19 | 2.19 | 2.19 |
| Properties | | | | | |
| Modulus at 300% | 17.12 ± 0.48 | 9.04 ± 0.13 | 13.26 ± 0.15 | 16.24 ± 0.24 | 16.71 ± 0.30 |
| elongation (MPa) | | | | | |
| Modulus at 100% | 4.80 ± 0.14 | 3.53 ±0.11 | 3.70 ± 0.06 | 4.60 ± 0.08 | 4.44 ± 0.05 |
| elongation (MPa) | | | | | |
| Tensile Strength | 19.7 ± 0.7 | 16.4 ± 0.7 | 19.1 ± 0.6 | 20.7 ± 0.7 | 20.3 ± 1.1 |
| (MPa) | | | | | |
| Elongation (%) | 345 ± 6 | 445 ± 19 | 428 ± 17 | 384 ± 13 | 361 ± 20 |

### Example 11. Sucrose Soyate (SS) and Poly(2-VOES) as the Processing Oil in a Rubber Compound Containing 25.00 Phr Processing Oil and 92.00 Phr CB

Table 18 lists the ingredients and their concentration used to produce rubber compounds containing 25 phr of a processing oil and 92 phr CB. The table also provides the mechanical properties obtained for the vulcanized rubbers. For each rubber compound, a master batch was first produced using a by charging the KER 1502, CB, and processing oil and mixing for one minute at 20 rpm using a HAAKE™ Rheomix OS Lab Mixer from Thermoscientific equipped with Banbury-type mixing blades. The set temperature of the mixer was 60° C. Next, ZnO and SA were added and the material mixed for at 60 rpm using a set temperature of 60° C. Mixing was continued until the torque measured during the mixing was relatively constant. Generally the mixing time required to achieve a constant torque was 7 to 8 minutes. During the mixing process, the internal temperature of the mixer typically reached 100° C. Next, the appropriate amount of S8 and TBBS were mixed with the master batch using a two roll mill and a gap between the rolls of 0.04 inches. The two roll was a Prep-Mill™ from Brabender. Once it appeared that the S8 and TBBS has been thoroughly incorporated into the rubber compound, the rubber was cut, folded, and run through the two roll mill eight more times to ensure a homogeneous mixture.

For vulcanization, circular sheets of the rubber compound about 10 cm in diameter were placed within a large rubber O-ring (inside diameter of 12 cm) which was placed between two aluminum platens of a hot press and a vacuum placed on the material for 5 minutes. Next, the rubber compound was vulcanized at 145° C. for 35 minutes using an applied force of 2360 to 2400 N. Samples for mechanical property testing were obtained by stamping specimens from the vulcanized rubber using a die that was in the shape of ASTM D638 Type V tensile specimens. Modulus, tensile strength, and elongation were determined according to ASTM D412. The value of the modulus was taken at 100% and 300% elongation.

Table 18 provides the composition and properties of rubbers based on a formulation that utilizes 25 phr of processing oil. By comparing the properties of Reference Composition 8 to Reference Composition 7, it can be seen that direct substitution of the conventional petroleum-based processing oil (AR Oil) with SBO results in dramatic reductions in moduli and tensile strength. Since SBO contains unsaturation, a third reference composition was produced (Reference Composition 9) in which additional curative was added to account for the “extra” unsaturation in the formulation. By comparing Reference Composition 9 to Reference Composition 8, it can be seen that this increase in curatives increased moduli and tensile strength, but not nearly to the level of that of Reference Composition 7. Thus, these results show that the use of SBO as a processing oil substantially reduces key mechanical properties, such as moduli and tensile strength, compared to the use of the conventional petroleum-based processing oil (AR Oil).

Comparing the properties of Samples 5 and 6 to Reference Composition 9, it can be seen that both SS and the poly(2-VOES) provide substantially higher moduli and tensile strength when used as a processing oil than SBO. In addition, the mechanical properties of the rubbers based on SS (Sample 5) and poly(2-VOES) (Sample 6) were quite similar to the properties obtained using the conventional petroleum-based processing oil (AR Oil) (Reference Composition 7).

TABLE 18
Compositions and properties of the rubber compounds
produced. All values are in units of parts per
100 parts of elastomer (i.e. COPO 1500).

| | Reference 11 | Sample 7 | Sample 8 |
|---|---|---|---|
| Starting Material | | | |
| COPO 1500 | 100.00 | 100.00 | 100.00 |
| SBO | 37.50 | — | — |
| SS | — | 37.50 | — |
| Poly(2-VOES) | — | — | 37.50 |
| CB | 101.00 | 101.00 | 101.00 |
| ZnO | 4.13 | 4.13 | 4.13 |
| SA | 1.38 | 1.38 | 1.38 |
| TBBS | 1.38 | 1.38 | 1.38 |
| S8 | 2.41 | 2.41 | 2.41 |
| Properties | | | |
| Modulus at 300% | 9.86 ± 0.12 | 11.61 ± 0.15 | 13.74 ± 0.15 |
| elongation (MPa) | | | |
| Modulus at 100% | 3.03 ± 0.11 | 3.40 ± 0.05 | 3.67 ± 0.07 |
| elongation (MPa) | | | |
| Tensile Strength | 16.3 ± 0.2 | 17.7 ± 0.4 | 18.3 ± 0.5 |
| (MPa) | | | |
| Elongation (%) | 490 ± 12 | 450 ± 14 | 429 ± 50 |

Table 19 lists the materials utilized in Examples 12 to 26.

TABLE 19
Materials

| Acronym | Description | Source | Tradename |
|---|---|---|---|
| KER 1502 | Styrene-butadiene | Synthos Group | KER ® 1502 |
| | elastomer | S.A. (Poland) | |
| COPO 1500 | Styrene-butadiene | East West | COPO ® 1500 |
| | elastomer | Copolymer | |
| | | (formerly Lion | |
| | | Copolymer, | |
| | | Baton Rouge, | |
| | | LA) | |
| CB | Carbon black | Cabot | VULCAN ® 3 |
| | | Corporation | ASTM N330 |
| | | (Boston, MA) | |
| ZnO | Zinc oxide | Sigma-Aldrich | — |
| | | (St. Louis, MO) | |
| SA | Stearic acid | Sigma-Aldrich | — |
| | | (St. Louis, MO) | |
| SBO | Soybean oil | Sam's Club | — |
| SS | Sucrose soyate | Proctor & Gamble | SEFOSE 1618U |
| | | (Cincinnati, OH) | |
| AR Oil | High boiling | Valero Energy | ValAro 130A |
| | aromatic oil | (San Antonio, TX) | |
| TBBS | N-tert-butyl-2- | Sigma-Aldrich | — |
| | benzothiazole-2- | (St. Louis, MO) | |
| | sulfenamide | | |
| S8 | Sulfur | Sigma-Aldrich | — |
| | | (St. Louis, MO) | |
| Styrene | Styrene | Sigma-Aldrich | — |
| | | (St. Louis, MO) | |
| dTBP | Di-tert-Butyl | Sigma-Aldrich | LUPEROX ® DI |
| | peroxide | (St. Louis, MO) | |
| Xylene | Xylene | Sigma-Aldrich | — |
| | | (St. Louis, MO) | |
| Toluene | Toluene | VWR | — |
| | | International | |
| | | (Radnor, PA) | |

### Example 12. Synthesis of Styrenated SBO Using 10 Weight Percent of Styrene

135 g of SBO was added to a three-neck, 250 ml round-bottom flask equipped with magnetic stirring, condenser, oil bath, nitrogen blanket and addition funnel. The SBO was heated up to 150° C. under a nitrogen blanket and a solution of 9 g of dTBP dissolved in 15 g of styrene added dropwise to the hot SBO under continuous, rapid stirring. The rate of addition of dTBP/styrene solution was such that it took approximately three hours to complete the addition. After completing the dTBP/styrene solution addition, the reaction mixture was heated at 150° C. for 3 more hours. The reaction mixture was then allowed to cool to approx. 60-70° C. before removing unreacted styrene with a rotary evaporator operating at 65° C. and reduced pressure. Styrene conversion was determined gravimetrically and found to be 95 wt. %. The product, SBO-g-10% PS, was a transparent liquid at room temperature. Using gel permeation chromatography, the number-average molecular weight expressed relative to polystyrene standards was determined to be 4,800 g/mole. Next, 2 g of the product was poured into 3 g of rapidly stirring hexane, which resulted in a homogeneous solution. This result suggests that the material was not contaminated with ungrafted polystyrene homopolymer or a material fraction that was exceptionally high in polystyrene content.

### Example 13. Synthesis of Styrenated SBO Using 20 Weight Percent of Styrene

120 g of SBO was added to a three-neck, 250 ml round-bottom flask equipped with magnetic stirring, condenser, oil bath, nitrogen blanket, and addition funnel. The SBO was heated up to 150° C. under a nitrogen blanket and a solution of 9 g of dTBP dissolved in 30 g of styrene added dropwise to the hot SBO under continuous, rapid stirring. The rate of addition of the dTBP/styrene solution was such that it took approximately three hours to complete the addition. After completing the dTBP/styrene solution addition, the reaction mixture was heated at 150° C. for 3 more hours. The reaction mixture was then allowed to cool to approx. 60-70° C. before removing unreacted styrene using a rotary evaporator operating at 65° C. and reduced pressure. Styrene conversion was determined gravimetrically and found to be 76 wt. %. The product, SBO-g-15% PS, was a transparent liquid at room temperature. Using gel permeation chromatography, the number-average molecular weight expressed relative to polystyrene standards was determined to be 4,200 g/mole. Next, 2 g of the product was poured into 3 g of rapidly stirring hexane, which resulted in a homogeneous solution. This result suggests that the material was not contaminated with ungrafted polystyrene homopolymer or a material fraction that was exceptionally high in polystyrene content.

### Example 14. Synthesis of Styrenated SBO Using 30 Weight Percent of Styrene

105 g of SBO was added to a three-neck, 250 ml round-bottom flask equipped with magnetic stirring, condenser, oil bath, nitrogen blanket and addition funnel. The SBO was heated up to 150° C. under a nitrogen blanket and a solution of 9 g of dTBP dissolved in 45 g of styrene added dropwise to the hot SBO under continuous, rapid stirring. The rate of addition of dTBP/styrene solution was such that it took approximately three hours to complete the addition. After completing the dTBP/styrene solution addition, the reaction mixture was heated at 150° C. for 3 more hours. The reaction mixture was then allowed to cool to approx. 60-70° C. before removing unreacted styrene using a rotary evaporator operating at 65° C. and reduced pressure. Styrene conversion was determined gravimetrically and found to be 83 wt. %. The product, SBO-g-25% PS, was a slightly hazy liquid at room temperature that became transparent when heated to 60° C. Using gel permeation chromatography, the number-average molecular weight expressed relative to polystyrene standards was determined to be 5,900 g/mole. The observation of turbidity suggested the presence of polystyrene homopolymer. As a result, 10 g of the product was poured into 15 g of rapidly stirring hexane. The mixture was then centrifuged for 5 minutes at 5,000 rpm, which produced a precipitate. The precipitate was isolated by decanting the liquid and subsequently drying in a vacuum oven. The amount of precipitate produced was 0.6 wt. %. The precipitate was characterized using FTIR and H¹ NMR and found to be largely polystyrene.

### Example 15. Synthesis of Styrenated SBO Using 20 Weight Percent of Styrene

40 g of SBO was added to a three-neck, 100 ml round-bottom flask equipped with magnetic stirring, condenser, oil bath, nitrogen purge, and addition funnel. The SBO was heated up to 150° C. under a nitrogen blanket and a solution of 3 g of dTBP dissolved in 10 g of styrene added dropwise to the hot SBO under continuous, rapid stirring. The rate of addition of dTBP/styrene solution was such that it took approximately two hours to complete the addition. After completing the dTBP/styrene solution addition, the reaction mixture was heated at 150° C. for 3 more hours. The reaction mixture was then allowed to cool to approx. 60-70° C. before removing unreacted styrene with a rotary evaporator operating at 65° C. and reduced pressure. Styrene conversion was determined gravimetrically and found to be 60 wt. %. The product, SBO-g-12% PS, was an opaque liquid at room temperature that produced a precipitate after standing at room temperature for two days. Using gel permeation chromatography, the number-average molecular weight expressed relative to polystyrene standards was determined to be 2,400 g/mole. The observation of turbidity suggested the presence of polystyrene homopolymer. As a result, 10 g of the product was poured into 15 g of rapidly stirring hexane. The mixture was then centrifuged for 5 minutes at 5,000 rpm, which produced a precipitate. The precipitate was isolated by decanting the liquid and subsequently drying in a vacuum oven. The amount of precipitate produced was 1.8 wt. %. The precipitate was characterized using FTIR and H¹ NMR and found to be largely polystyrene.

### Example 16. Synthesis of Styrenated SBO Using 20 Weight Percent of Styrene

For this example, an automated mini-pump was used to control the addition of the dTBP/styrene solution. 40 g of SBO was added to a three-neck, 100 ml round-bottom flask equipped with magnetic stirring, condenser, oil bath, nitrogen purge, and mini-feed pump. The SBO was heated up to 150° C. under a nitrogen blanket and a solution of 3 g of dTBP dissolved in 10 g of styrene added dropwise to the hot SBO under continuous, rapid stirring using the mini-pump set at an addition rate of 0.08 ml/min. At this addition rate, it took about 3 hours for the dTBP/styrene solution to be added to the hot SBO. After complete addition of the dTBP/styrene solution, the reaction mixture was heated at 150° C. for 3 more hours. The reaction mixture was then allowed to cool to approx. 60-70° C. before removing unreacted styrene with a rotary evaporator operating at 65° C. and reduced pressure. Styrene conversion was determined gravimetrically and found to be 74 wt. %. The product, SBO-g-15% PS, was largely a transparent liquid. Using gel permeation chromatography, the number-average molecular weight expressed relative to polystyrene standards was determined to be 3,000 g/mole. Next, 10 g of the product was poured into 15 g of rapidly stirring hexane. The mixture was then centrifuged for 5 minutes at 5,000 rpm, which produced a small amount of precipitate. The precipitate was isolated by decanting the liquid and subsequently drying in a vacuum oven. The amount of precipitate produced was 0.08%. The precipitate was characterized using FTIR and H¹ NMR and found to be largely polystyrene.

### Example 17. Synthesis of Styrenated SBO with 20 Weight Percent of Styrene

For this example, an automated mini-pump was used to control the addition of the dTBP/styrene solution. 40 g of SBO was added to a three-neck, 100 ml round-bottom flask equipped with magnetic stirring, condenser, oil bath, nitrogen purge, and mini-feed pump. The SBO was heated up to 150° C. under a nitrogen blanket and a solution of 3 g of dTBP dissolved in 10 g of styrene added dropwise to the hot SBO under continuous, rapid stirring using the mini-pump set at an addition rate of 0.07 ml/min. At this addition rate, it took about 3.5 hours for the dTBP/styrene solution to be added to the hot SBO. After complete addition of the dTBP/styrene solution, the reaction mixture was heated at 150° C. for 3 more hours. The reaction mixture was then allowed to cool to approx. 60-70° C. before removing unreacted styrene with a rotary evaporator operating at 65° C. and reduced pressure. Styrene conversion was determined gravimetrically and found to be 79 wt. %. The product, SBO-g-16% PS, was largely a transparent liquid. Using gel permeation chromatography, the number-average molecular weight expressed relative to polystyrene standards was determined to be 3,400 g/mole. Next, 2 g of the product was poured into 3 g of rapidly stirring hexane, which produced a homogeneous solution. This result suggests that the material was not contaminated with ungrafted polystyrene homopolymer or a material fraction that was exceptionally high in polystyrene content.

### Example 18. Synthesis of Styrenated SBO with 20 Weight Percent of Styrene

For this example, an automated mini-pump was used to control the addition of the dTBP/styrene solution. 40 g of SBO was added to a three-neck, 100 ml round-bottom flask equipped with magnetic stirring, condenser, oil bath, nitrogen purge, and mini-feed pump. The SBO was heated up to 150° C. under a nitrogen blanket and a solution of 3 g of dTBP dissolved in 10 g of styrene added dropwise to the hot SBO under continuous, rapid stirring using the mini-pump set at an addition rate of 0.06 ml/min. At this addition rate, it took about 4 hours for the dTBP/styrene solution to be added to the hot SBO. After complete addition of the dTBP/styrene solution, the reaction mixture was heated at 150° C. for 3 more hours. The reaction mixture was then allowed to cool to approx. 60-70° C. before removing unreacted styrene with a rotary evaporator operating at 65° C. and reduced pressure. Styrene conversion was determined gravimetrically and found to be 76 wt. %. The product, SBO-g-15% PS, was largely a transparent liquid. Using gel permeation chromatography, the number-average molecular weight expressed relative to polystyrene standards was determined to be 2,500 g/mole. Next, 2 g of the product was poured into 3 g of rapidly stirring hexane, which produced a homogeneous solution. This result suggests that the material was not contaminated with ungrafted polystyrene homopolymer or a material fraction that was exceptionally high in polystyrene content.

### Example 19. Synthesis of Styrenated SBO Using 30 Weight Percent of Styrene

35 g of SBO was added to a three-neck, 100 ml round-bottom flask equipped with magnetic stirring, condenser, oil bath, nitrogen purge, and addition funnel. The SBO was heated up to 150° C. under a nitrogen blanket and a solution of 3 g of dTBP and 15 g of styrene was added dropwise to the hot SBO under continuous, rapid stirring. The rate of addition of dTBP/styrene solution was such that it took approximately 3.5 hours to complete the addition. After completing the dTBP/styrene solution addition, the reaction mixture was heated at 150° C. for 3 more hours. The reaction mixture was then allowed to cool to approx. 60-70° C. before removing unreacted styrene using a rotary evaporator operating at 65° C. and reduced pressure. Styrene conversion was determined gravimetrically and found to be 83 wt. %. The product, SBO-g-25% PS, was transparent at room temperature, but a very small amount of precipitated was observed after standing at room temperature for about one day. Using gel permeation chromatography, the number-average molecular weight expressed relative to polystyrene standards was determined to be 9,000 g/mole. 10 g of the product was poured into 15 g of rapidly stirring hexane. The mixture was then centrifuged for 5 minutes at 5,000 rpm, which produced a precipitate. The precipitate was isolated by decanting the liquid and subsequently drying in a vacuum oven. The amount of precipitate produced was 0.3 wt. %. The precipitate was characterized using FTIR and H¹ NMR and found to be largely polystyrene.

### Example 20. Synthesis of Styrenated SBO Using 30 Weight Percent of Styrene

For this example, a solution of styrene, dTBP, and SBO were added to hot SBO over time. 60 g of SBO was added to a three-neck, 250 ml round-bottom flask equipped with magnetic stirring, condenser, oil bath, nitrogen purge, and addition funnel. The SBO was heated up to 150° C. under a nitrogen blanket and a solution of 7.2 g of dTBP, 36 g of styrene, and 24 g of SBO was added dropwise to the hot SBO under continuous, rapid stirring. The rate of addition of dTBP/styrene/SBO solution was such that it took approximately 3.0 hours to complete the addition. After completing the dTBP/styrene/SBO solution addition, the reaction mixture was heated at 150° C. for 3 more hours. The reaction mixture was then allowed to cool to approx. 60-70° C. before removing unreacted styrene using a rotary evaporator operating at 65° C. and reduced pressure. Styrene conversion was determined gravimetrically and found to be 87 wt. %. The product, SBO-g-26% PS, was transparent at room temperature and no precipitate was formed upon standing at room temperature. Using gel permeation chromatography, the number-average molecular weight expressed relative to polystyrene standards was determined to be 6,000 g/mole. Next, 2 g of the product was poured into 3 g of rapidly stirring hexane, which produced a homogeneous solution. This result suggests that the material was not contaminated with ungrafted polystyrene homopolymer or a material fraction that was exceptionally high in polystyrene content.

### Example 21. Synthesis of Styrenated SBO Using 30 Weight Percent of Styrene

For this example, an automated mini-pump was used to control the addition of the dTBP/styrene solution. 35 g of SBO was added to a three-neck, 100 ml round-bottom flask equipped with magnetic stirring, condenser, oil bath, nitrogen purge, and mini-feed pump. The SBO was heated up to 150° C. under a nitrogen blanket and a solution of 3 g of dTBP dissolved in 15 g of styrene added dropwise to the hot SBO under continuous, rapid stirring using the mini-pump set at an addition rate of 0.11 ml/min. At this addition rate, it took about 3 hours for the dTBP/styrene solution to be added to the hot SBO. After complete addition of the dTBP/styrene solution, the reaction mixture was heated at 150° C. for 3 more hours. The reaction mixture was then allowed to cool to approx. 60-70° C. before removing unreacted styrene with a rotary evaporator operating at 65° C. and reduced pressure. Styrene conversion was determined gravimetrically and found to be 85 wt. %. The product, SBO-g-26% PS, was a slightly hazy liquid that was stable after standing at room temperature. Using gel permeation chromatography, the number-average molecular weight expressed relative to polystyrene standards was determined to be 6,800 g/mole. Next, 10 g of the product was poured into 15 g of rapidly stirring hexane. The mixture was then centrifuged for 5 minutes at 5,000 rpm, which produced a small amount of precipitate. The precipitate was isolated by decanting the liquid and subsequently drying in a vacuum oven. The amount of precipitate produced was 0.6 wt. %. The precipitate was characterized using FTIR and H¹ NMR and found to be largely polystyrene.

### Example 22. Synthesis of Styrenated SBO Using 30 Weight Percent of Styrene

For this example, an automated mini-pump was used to control the addition of the dTBP/styrene solution. 35 g of SBO was added to a three-neck, 100 ml round-bottom flask equipped with magnetic stirring, condenser, oil bath, nitrogen purge, and mini-feed pump. The SBO was heated up to 150° C. under a nitrogen blanket and a solution of 3 g of dTBP dissolved in 15 g of styrene added dropwise to the hot SBO under continuous, rapid stirring using the mini-pump set at an addition rate of 0.08 ml/min. At this addition rate, it took about 4 hours for the dTBP/styrene solution to be added to the hot SBO. After complete addition of the dTBP/styrene solution, the reaction mixture was heated at 150° C. for 3 more hours. The reaction mixture was then allowed to cool to approx. 60-70° C. before removing unreacted styrene with a rotary evaporator operating at 65° C. and reduced pressure. Styrene conversion was determined gravimetrically and found to be 87 wt. %. The product, SBO-g-26% PS, was a slightly hazy liquid that was stable after standing at room temperature. Using gel permeation chromatography, the number-average molecular weight expressed relative to polystyrene standards was determined to be 7,000 g/mole. Next, 10 g of the product was poured into 15 g of rapidly stirring hexane. The mixture was then centrifuged for 5 minutes at 5,000 rpm, which produced a small amount of precipitate. The precipitate was isolated by decanting the liquid and subsequently drying in a vacuum oven. The amount of precipitate produced was 0.2 wt. %. The precipitate was characterized using FTIR and H¹ NMR and found to be largely polystyrene.

### Example 23. Synthesis of Styrenated SBO with 30 Weight Percent of Styrene

For this example, an automated mini-pump was used to control the addition of the dTBP/styrene solution. 175 g of SBO was added to a three-neck, 500 ml round-bottom flask equipped with magnetic stirring, condenser, oil bath, nitrogen purge, and mini-feed pump. The SBO was heated up to 150° C. under a nitrogen blanket and a solution of 15 g of dTBP dissolved in 75 g of styrene added dropwise to the hot SBO under continuous, rapid stirring using the mini-pump set at an addition rate of 0.38 ml/min. At this addition rate, it took about 4 hours for the dTBP/styrene solution to be added to the hot SBO. After complete addition of the dTBP/styrene solution, the reaction mixture was heated at 150° C. for 3 more hours. The reaction mixture was then allowed to cool to approx. 60-70° C. before removing unreacted styrene with a rotary evaporator operating at 65° C. and reduced pressure. Styrene conversion was determined gravimetrically and found to be 90 wt. %. The product, SBO-g-PS27, was a slightly hazy liquid that was stable after standing at room temperature. Using gel permeation chromatography, the number-average molecular weight expressed relative to polystyrene standards was determined to be 4,100 g/mole. Next, 10 g of the product was poured into 15 g of rapidly stirring hexane. The mixture was then centrifuged for 5 minutes at 5,000 rpm, which produced a small amount of precipitate. The precipitate was isolated by decanting the liquid and subsequently drying in a vacuum oven. The amount of precipitate produced was less than 0.1 wt. %. The precipitate was characterized using FTIR and H¹ NMR and found to be largely polystyrene.

### Example 24. Synthesis of Styrenated SBO Using 30 Weight Percent of Styrene

The following is an example that illustrates the effect of charging the styrene and SBO at the beginning of the reaction and adding the dBTP over time. 35 g of SBO and 15 g of styrene were added to a three-neck, 100 ml round-bottom flask equipped with magnetic stirring, condenser, oil bath, nitrogen purge, and mini-feed pump. The solution was heated up to 150° C. under a nitrogen blanket and 3 g of dTBP was added dropwise to the hot SBO/styrene solution under continuous, rapid stirring. The rate of addition of dTBP was 0.02 ml/min, which took approximately three hours to complete the addition. After completing the dTBP addition, the reaction mixture was heated at 150° C. for 3 more hours. The reaction mixture was then allowed to cool to approx. 60-70° C. before removing unreacted styrene using a rotary evaporator operating at 65° C. and reduced pressure. Styrene conversion was determined gravimetrically and found to be 95 wt. %. The product, SBO-g-29% PS, was an opaque, heterogeneous mixture at room temperature that contained a considerable amount of precipitate. The product was poured into a 150% excess of rapidly stirring hexane. The mixture was then centrifuged for 5 minutes at 5,000 rpm to isolate the precipitate. The precipitate was isolated by decanting the liquid and subsequently drying in a vacuum oven. The amount of precipitate produced was 12.0 wt. %. The precipitate was characterized using FTIR and H¹ NMR and found to be largely polystyrene. Using gel permeation chromatography, the number-average molecular weight expressed relative to polystyrene standards for the precipitate was determined to be 26,900 g/mole. The hexane soluble fraction was isolated by removing hexane using a rotary evaporator operating at 30° C. and reduced pressure and the number-average molecular weight expressed relative to polystyrene standards determined to be 10,800 g/mole.

### Example 25. Synthesis of Styrenated SBO with 30 Weight Percent of Styrene

The following is an example that illustrates the effect of charging the styrene, SBO, and dBTP at the beginning of the reaction. 35 g of SBO, 15 g of styrene, and 3 g of dTBP were added to a three-neck, 100 ml round-bottom flask equipped with magnetic stirring, condenser, oil bath, and nitrogen purge. The solution was heated for 10 hours at 125° C. under a nitrogen blanket and then for an additional 4 hours at 150° C. The reaction mixture was then allowed to cool to approx. 60-70° C. before removing unreacted styrene using a rotary evaporator operating at 65° C. and reduced pressure. Styrene conversion was determined gravimetrically and found to be 100 wt. %. The product, SBO-g-30% PS, was an opaque, heterogeneous mixture at room temperature that contained a considerable amount of precipitate. The product was poured into a 150% excess of rapidly stirring hexane. The mixture was then centrifuged for 5 minutes at 5,000 rpm to isolate the precipitate. The precipitate was isolated by decanting the liquid and subsequently drying in a vacuum oven. The amount of precipitate produced was 14.3 wt. %. The precipitate was characterized using FTIR and H¹ NMR and found to be largely polystyrene. Using gel permeation chromatography, the number-average molecular weight expressed relative to polystyrene standards for the precipitate was determined to be 61,000 g/mole. The hexane soluble fraction was isolated by removing hexane using a rotary evaporator operating at 30° C. and reduced pressure and the number-average molecular weight expressed relative to polystyrene standards determined to be 2,000 g/mole.

### Example 26. Synthesis of Styrenated SBO with 40 Weight Percent of Styrene

For this example, a solution of styrene, dTBP, and SBO were added to hot SBO over time. 30 g of SBO was added to a three-neck, 100 ml round-bottom flask equipped with magnetic stirring, condenser, oil bath, nitrogen purge, and addition funnel. The SBO was heated up to 150° C. under a nitrogen blanket and a solution of 4.2 g of dTBP, 28 g of styrene, and 12 g of SBO was added dropwise to the hot SBO under continuous, rapid stirring. The rate of addition of dTBP/styrene/SBO solution was such that it took approximately 4.0 hours to complete the addition. After completing the dTBP/styrene/SBO solution addition, the reaction mixture was heated at 150° C. for 3 more hours. The reaction mixture was then allowed to cool to approx. 60-70° C. before removing unreacted styrene using a rotary evaporator operating at 65° C. and reduced pressure. Styrene conversion was determined gravimetrically and found to be 92 wt. %. The product, SBO-g-37% PS, was transparent at room temperature and no precipitate was formed upon standing at room temperature. Using gel permeation chromatography, the number-average molecular weight expressed relative to polystyrene standards was determined to be 6,300 g/mole. 2 g of the product was poured into 3 g of rapidly stirring hexane, which produced a homogeneous solution. This result suggests that the material was not contaminated with ungrafted polystyrene homopolymer or a material fraction that was exceptionally high in polystyrene content.

TABLE 20
Details of the styrenated SBO materials produced.

| | | Time | | | | | |
|---|---|---|---|---|---|---|---|
| | | associated | | | | | |
| | | with | | | | | Molecular |
| | Styrene | styrene/dTBP | | Styrene | Grafted | Ungrafted | weight of the |
| Example | added, | solution | | conversion, | Polystyrene, | Polystyrene, | SBO-g-PS, |
| # | wt. %* | addition, hours | Appearance | wt. % | wt. % | wt. % | Mn |
| 12 | 10 | 3 | transparent | 95 | 9.5 | Less than | 4800 |
| | | | | | | 0.1% | |
| 13 | 20 | 3 | transparent | 76 | 15.2 | Less than | 4200 |
| | | | | | | 0.1% | |
| 14 | 30 | 3 | slightly | 83 | 24.4 | 0.6 | 5900 |
| | | | hazy | | | | |
| 15 | 20 | 2 | opaque | 60 | 10.2 | 1.8 | 2400 |
| 16 | 20 | 3 (feed rate | transparent | 74 | 14.8 | 0.08 | 3000 |
| | | of 0.08 | | | | | |
| | | ml/min) | | | | | |
| 17 | 20 | 3.5 (feed | transparent | 79 | 15.8 | 0 | 3400 |
| | | rate of 0.07 | | | | | |
| | | ml/min) | | | | | |
| 18 | 20 | 4 (feed rate | transparent | 76 | 15.2 | 0 | 2500 |
| | | of 0.06 | | | | | |
| | | ml/min) | | | | | |
| 19 | 30 | 3.5 | transparent | 83 | 24.7 | 0.3 | 9000 |
| | | | with some | | | | |
| | | | precipitate | | | | |
| | | | formed | | | | |
| 20 | 30 | 3 (also | transparent | 87 | 26.0 | Less than | 6000 |
| | | contained | | | | 0.1% | |
| | | SBO) | | | | | |
| 21 | 30 | 3 (feed rate | slightly | 85 | 24.8 | 0.6 | 6800 |
| | | of 0.11 | hazy | | | | |
| | | ml/min) | | | | | |
| 22 | 30 | 4 (feed rate | slightly | 87 | 26.0 | 0.2 | 7000 |
| | | of 0.08 | hazy | | | | |
| | | ml/min) | | | | | |
| 23 | 30 | 4 (feed rate | slightly | 90 | 27.1 | 0.1% | 4100 |
| | | of 0.38 | hazy | | | | |
| | | ml/min) | | | | | |
| 24 | 30 | 3 (dTBP | opaque, | 95 | 16.4 | 12 | . . . |
| | | only, feed | heterogeneous | | | | |
| | | rate of 0.02 | with | | | | |
| | | ml/min) | precipitate | | | | |
| 25 | 30 | NA | opaque, | 100 | 15.7 | 14.3 | . . . |
| | | | heterogeneous | | | | |
| | | | with | | | | |
| | | | precipitate | | | | |
| 26 | 40 | 4.0 | transparent | 92 | 37.0 | 0 | 6300 |

*Percentage of styrene relative to SBO and styrene) for Examples 12 to 26.

### Results for Examples 12 to 26.

Table 20, above, lists some of the details of the styrenated SBO (sty-SBO) materials produced. For use as a processing oil for rubber compounds, it may be advantageous if the sty-SBO is a homogeneous liquid. The process used to react styrene with SBO may determine the homogeneity of the product. For example, as illustrated with Example 20, charging all three components needed for grafting of styrene to SBO at the beginning of the reaction produces a material that is heterogeneous with a considerable amount of precipitate. Pouring the Example 20 material into hexane resulted in precipitation of 14.3 wt. % of the material. This material was determined to be largely polystyrene homopolymer that was not effectively grafted to SBO. Similarly, adding the free radical initiator, dTBP, over time to a solution of SBO and styrene (Example 19) resulted in a heterogeneous material with a considerable amount of precipitate. When poured into hexane, the Example 19 material produced 12 wt. % of precipitate, which was determined to be essentially ungrafted polystyrene. FIG. 11 provides photos of the materials generated from Examples 14, 19 and 20. Unlike Examples 19 and 20, which resulted in heterogeneous materials, Example 14 provided a homogeneous liquid. For Example 14, a solution of styrene and dTBP was added slowly to hot SBO over a period of 3.5 hours.

### Example 27. Synthesis of Styrenated Sucrose Soyate with 15 Weight Percent of Styrene

This example involves the use of sucrose soyate (SS) in place of SBO. 42.5 g of SS and 40 g of toluene were added to a three-neck, 100 ml round-bottom flask equipped with magnetic stirring, condenser, oil bath, nitrogen purge, and addition funnel. The oil bath was heated to 150° C. and a solution of 3 g of dTBP, 7.5 g of styrene, and 10 g of toluene was added dropwise to the hot SS/toluene solution under continuous, rapid stirring and a nitrogen blanket. The rate of addition of dTBP/styrene solution was such that it took approximately three hours to complete the addition. After completing the dTBP/styrene/toluene solution addition, the reaction mixture was heated with the 150° C. oil bath for 3 more hours. The reaction mixture was then allowed to cool to approx. 60-70° C. before removing unreacted styrene and toluene with a rotary evaporator operating at 65° C. and reduced pressure. Styrene conversion was determined gravimetrically and found to be 79.3 wt. %. The product, SS-g-12% PS, was a slightly hazy liquid at room temperature. Using gel permeation chromatography, the number-average molecular weight expressed relative to polystyrene standards was determined to be 3,700 g/mole. 10 g of the product was poured into 15 g of rapidly stirring hexane. The mixture was then centrifuged for 5 minutes at 5,000 rpm, which produced a minor amount of precipitate. The precipitate was isolated by decanting the liquid and subsequently drying in a vacuum oven. The amount of precipitate produced was less than 0.1 wt. %.

### Example 28. Synthesis of Styrenated Sucrose Soyate with 20 Weight Percent of Styrene

For this example, an automated mini-pump was used to control the addition of the dTBP/styrene solution. 40 g of SS and 50 g of toluene were added to a three-neck, 100 ml round-bottom flask equipped with magnetic stirring, condenser, oil bath, nitrogen purge, and a mini-feed pump. The oil bath was heated to 150° C. and a solution of 3 g of dTBP and 10 g of styrene was added slowly to the hot SS/toluene solution under continuous, rapid stirring and a nitrogen blanket using the mini-feed pump with the feed rate set at 0.06 ml/min. At this rate of addition, it took approximately four hours to complete the dTBP/styrene addition. After completing the dTBP/styrene solution addition, the reaction mixture was heated with the 150° C. oil bath for 3 more hours. The reaction mixture was then allowed to cool to approx. 60-70° C. before removing unreacted styrene and toluene with a rotary evaporator operating at 65° C. and reduced pressure. Styrene conversion was determined gravimetrically and found to be 91.0 wt. %. The product, SBO-g-18% SS, was a slightly hazy liquid at room temperature. Using gel permeation chromatography, the number-average molecular weight expressed relative to polystyrene standards was determined to be 7,200 g/mole. 10 g of the product was poured into 15 g of rapidly stirring hexane. The mixture was then centrifuged for 5 minutes at 5,000 rpm, which produced a minor amount of precipitate. The precipitate was isolated by decanting the liquid and subsequently drying in a vacuum oven. The amount of precipitate produced was 0.2 wt. %.

### Example 29. Synthesis of Styrenated SBO-Based Poly(Vinyl Ether) with 15 Weight Percent of Styrene

This example involves the use of a poly(2-(vinyloxy)ethyl soyate) [poly(2-VOES)] polymer in place of SBO. 21.25 g of a 2,100 g/mole poly(2-VOES) and 20 g of toluene were added to a three-neck, 100 ml round-bottom flask equipped with magnetic stirring, condenser, oil bath, nitrogen purge, and addition funnel. The oil bath was heated to 150° C. and a solution of 1.5 g of dTBP, 3.75 g of styrene, and 5 g of toluene was added dropwise to the hot poly(2-VOES)/toluene solution under continuous, rapid stirring and a nitrogen blanket. The rate of addition of dTBP/styrene/toluene solution was such that it took approximately three hours to complete the addition. After completing the dTBP/styrene/toluene solution addition, the reaction mixture was heated with the 150° C. oil bath for 3 more hours. The reaction mixture was then allowed to cool to approx. 60-70° C. before removing unreacted styrene and toluene with a rotary evaporator operating at 65° C. and reduced pressure. Styrene conversion was determined gravimetrically and found to be 73.3 wt. %. The product, poly(2-VOES)-g-11% PS, was a slightly hazy liquid at room temperature. Using gel permeation chromatography, the number-average molecular weight expressed relative to polystyrene standards was determined to be 2,700 g/mole. 10 g of the product was poured into 15 g of rapidly stirring hexane. The mixture was then centrifuged for 5 minutes at 5,000 rpm, which produced a minor amount of precipitate. The amount of precipitate produced was less than 0.1 wt. %.

### Example 30. Synthesis of Styrenated SBO-Based Poly(Vinyl Ether) with 20 Weight Percent of Styrene

For this example, an automated mini-pump was used to control the addition of the dTBP/styrene solution. 24 g of 2,100 g/mole poly(2-VOES) and 50 g of toluene were added to a three-neck, 100 ml round-bottom flask equipped with magnetic stirring, condenser, oil bath, nitrogen purge, and a mini-feed pump. The oil bath was heated to 150° C. and a solution of 1.8 g of dTBP and 6 g of styrene was added slowly to the hot poly(2-VOES)/toluene solution under continuous, rapid stirring and a nitrogen blanket using the mini-feed pump with the feed rate set at 0.04 ml/min. At this rate of addition, it took approximately four hours to complete the dTBP/styrene addition. After completing the dTBP/styrene solution addition, the reaction mixture was heated with the 150° C. oil bath for 3 more hours. The reaction mixture was then allowed to cool to approx. 60-70° C. before removing unreacted styrene and toluene with a rotary evaporator operating at 65° C. and reduced pressure. Styrene conversion was determined gravimetrically and found to be 83.0 wt. %. The product, poly(2-VOES)-g-17% PS, was a slightly hazy liquid at room temperature. Using gel permeation chromatography, the number-average molecular weight expressed relative to polystyrene standards was determined to be 14,000 g/mole. 10 g of the product was poured into 15 g of rapidly stirring hexane. The mixture was then centrifuged for 5 minutes at 5,000 rpm, which produced a minor amount of precipitate. The precipitate was isolated by decanting the liquid and subsequently drying in a vacuum oven. The amount of precipitate produced was 0.2 wt. %. Table 21 shows the rate of styrene addition for Examples 12 to 30.

TABLE 21
Rate of Styrene Addition

| | | | | | Rate of Addition |
|---|---|---|---|---|---|
| | | Grams | | Time of | (wt % styrene |
| Styrene | Example | Plant | Grams | Addition | relative to wt % |
| in formula | Number | Oil | Styrene | (minutes | plant oil/minutes |
| 10 | 12 | 135 | 15 | 180 | 0.062 |
| 20 | 13 | 120 | 30 | 180 | 0.208 |
| 30 | 14 | 105 | 45 | 180 | 0.238 |
| 20 | 15 | 40 | 10 | 120 | 0.208 |
| 20 | 16 | 40 | 10 | 180 | 0.139 |
| 20 | 17 | 40 | 10 | 210 | 0.119 |
| 20 | 18 | 40 | 10 | 240 | 0.104 |
| 30 | 19 | 35 | 15 | 210 | 0.204 |
| 30 | 20 | NA | | | |
| 30 | 21 | 35 | 15 | 180 | 0.238 |
| 30 | 22 | 35 | 15 | 240 | 0.179 |
| 30 | 23 | 175 | 75 | 240 | 0.179 |
| 30 | 24 | NA | | | |
| 30 | 25 | NA | | | |
| 40 | 26 | NA | | | |
| 15 | 27 | 42.5 | 7.5 | 180 | 0.098 |
| 20 | 28 | 40 | 10 | 240 | 0.104 |
| 15 | 29 | 21.25 | 3.75 | 180 | 0.098 |
| 20 | 30 | 24 | 6 | 240 | 0.104 |

### Example 31. Rubber Compounds Produced Using the Various Styrenated Materials as Processing Oils

Various styrenated materials were used as procession oils to produce rubber compounds. Two different rubber formulations were utilized that varied with respect to the elastomer utilized. Both elastomers were commercially available styrene-butadiene copolymers. One of the elastomers was KER-1502 from Synthos, while the other was COPO-1500 from Lion Copolymer. For each rubber compound, a master batch was first produced by charging the elastomer (KER-1502 or COPO-1500), CB, and processing oil and mixing for one minute at 20 rpm using a HAAKE™ Rheomix OS Lab Mixer from Thermoscientific equipped with Banbury-type mixing blades. The set temperature of the mixer was 60° C. Next, ZnO and SA were added and the material mixed for at 60 rpm using a set temperature of 60° C. Mixing was continued until the torque measured during the mixing was relatively constant. Generally the mixing time required to achieve a constant torque was 7 to 8 minutes. During the mixing process, the internal temperature of the mixer typically reached 100° C. Next, the appropriate amount of S8 and TBBS were mixed with the master batch using a two roll mill and a gap between the rolls of 0.04 inches. The two roll was a Prep-Mill™ from Brabender. Once it appeared that the S8 and TBBS has been thoroughly incorporated into the rubber compound, the rubber was cut, folded, and run through the two roll mill eight more times to ensure a homogeneous mixture.

For vulcanization, a circular sheet of the rubber compound with a diameter of about 10 cm was placed within a large rubber O-ring placed between two aluminum platens and a vacuum placed on the material for 5 minutes. The inner diameter of the rubber O-ring was 12 cm. Next, the rubber compound was vulcanized in the hot press at 145° C. for 35 minutes using an applied force of 2360 to 2400 N. Samples for mechanical property testing were obtained by stamping specimens from the vulcanized rubber using a die that was in the shape of ASTM D638 Type V tensile specimens. Modulus, tensile strength, and elongation were determined according to ASTM D412. The value of the modulus was taken at 100% and 300% elongation.

Using KER-1502 as the elastomer, three reference materials were used for comparison purposes. One reference material was based on a conventional petroleum-based processing oil (i.e. AR Oil in Table 19). The other two reference materials were based on SBO as the processing oil. Table 22 provides the formulations used for the three reference materials along with mechanical properties of the vulcanized rubbers produced. By comparing the properties of Reference 2 to Reference 1, it can be seen that direct substitution of the conventional petroleum-based processing oil (AR Oil) with SBO results in dramatic reductions in moduli and tensile strength. Since SBO contains unsaturation, a third reference was produced (Reference 3) in which additional curative (S8 and TBBS) was added to account for the “extra” unsaturation in the formulation. By comparing Reference 3 to Reference 2, it can be seen that this increase in curatives increased moduli and tensile strength, but not nearly to the level of that of Reference 1. Thus, these results show that the use of SBO as a processing oil substantially reduces key mechanical properties, such as moduli and tensile strength, compared to the use of conventional petroleum-based processing oils. In addition, the Mooney viscosity of Reference 3, which is based on SBO as the processing oil, was substantially higher than that of Reference 1, which is based on AR Oil.

TABLE 22
Composition and properties of the reference rubbers
produced. All values are in units of parts per
100 parts of elastomer (i.e. KER-1502).

| | Reference 4 | Reference 5 | Reference 6 |
|---|---|---|---|
| Starting Material | | | |
| KER-1502 | 100.00 | 100.00 | 100.00 |
| AR Oil | 37.50 | — | — |
| SBO | — | 37.50 | 37.50 |
| CB | 101.00 | 101.00 | 101.00 |
| ZnO | 3.00 | 3.00 | 4.13 |
| SA | 1.00 | 1.00 | 1.38 |
| TBBS | 1.38 | 1.38 | 1.38 |
| S8 | 1.75 | 1.75 | 2.41 |
| Properties | | | |
| Mooney viscosity | 64.4 | NA | NA |
| Modulus at 300% | 14.82 ± 0.20 | 9.04 ± 0.13 | 11.68 ± 0.10 |
| elongation (MPa) | | | |
| Modulus at 100% | 4.17 ± 0.05 | 2.93 ± 0.04 | 3.27 ± 0.06 |
| elongation (MPa) | | | |
| Tensile Strength | 19.3 ± 0.4 | 14.2 ± 0.4 | 16.9 ± 1.1 |
| (MPa) | | | |
| Elongation (%) | 398 ± 9 | 478 ± 11 | 430 ± 30 |

Reference rubbers were also produced using a different elastomer, namely, COPO-1500 from Lion Copolymer. Table 23 shows the compositions and properties of the rubbers produced. Similar to the results obtained with the rubbers based on KER-1502 as the elastomer, direct replacement of AR Oil with SBO resulted in a substantial decrease in moduli and strength.

TABLE 23
Composition and properties of the reference rubbers
produced. All values are in units of parts per
100 parts of elastomer (i.e. COPO-1500).

| | Reference 10 | Reference 11 |
|---|---|---|
| Starting Material | | |
| COPO-1500 | 100.00 | 100.00 |
| AR Oil | 37.50 | — |
| SBO | — | 37.50 |
| CB | 101.00 | 101.00 |
| ZnO | 4.125 | 4.125 |
| SA | 1.375 | 1.375 |
| TBBS | 1.375 | 1.375 |
| S8 | 2.406 | 2.406 |
| Properties | | |
| Mooney viscosity | 69.6 | 56.6 |
| Modulus at 300% | 14.65 ± 0.27 | 9.86 ± 0.12 |
| elongation (MPa) | | |
| Modulus at 100% | 4.56 ± 0.13 | 3.03 ± 0.11 |
| elongation (MPa) | | |
| Tensile Strength | 17.3 ± 1.0 | 16.3 ± 0.2 |
| (MPa) | | |
| Elongation (%) | 358 ± 20 | 490 ± 12 |

Table 24 illustrates the effect of styrene graft content on rubber properties for rubbers produced using SBO-g-PSs as processing oils and KER-1502 as the elastomer. As shown in Table 5, replacement of SBO as the processing oil with the sytrenated SBOs (Examples 1, 2, and 3) resulted in substantial increases in moduli and tensile strength, while reducing the Mooney viscosity.

TABLE 24
Composition and properties of rubbers produced using SBO-g-PSs as processing oils.
All values are in units of parts per 100 parts of elastomer (i.e. KER-1502).

| | Reference 6 | Sample 41 | Sample 42 | Sample 43 |
|---|---|---|---|---|
| Starting Material | | | | |
| KER-1502 | 100.00 | 100.00 | 100.00 | 100.00 |
| SBO | 37.50 | — | — | — |
| SBO-g-PS10(Example 12) | — | 37.50 | — | — |
| SBO-g-PS15(Example 13) | — | — | 37.50 | — |
| SBO-g-PS25 (Example 14) | — | — | — | 37.50 |
| CB | 101.00 | 101.00 | 101.00 | 101.00 |
| ZnO | 4.125 | 4.125 | 4.125 | 4.125 |
| SA | 1.375 | 1.375 | 1.375 | 1.375 |
| TBBS | 1.375 | 1.375 | 1.375 | 1.375 |
| S8 | 2.406 | 2.406 | 2.406 | 2.406 |
| Properties | | | | |
| Mooney Viscosity | NA | 56.0 | 56.4 | 58.2 |
| Modulus at 300% | 11.68 ± 0.10 | 15.11 ± 0.31 | 16.94 ± 0.13 | 15.62 ± 0.26 |
| elongation (MPa) | | | | |
| Modulus at 100% | 3.27 ± 0.06 | 4.09 ± 0.08 | 4.50 ± 0.06 | 4.18 ± 0.08 |
| elongation (MPa) | | | | |
| Tensile Strength (MPa) | 16.9 ± 1.1 | 18.7 ± 1.0 | 17.6 ± 1.1 | 20.0 ± 0.4 |
| Elongation (%) | 430 ± 30 | 370 ± 18 | 311 ± 17 | 384 ± 9 |

Table 25 provides the same comparison, but with COPO-1500 used as the elastomer. Similar to the results obtained with the rubbers based on KER-1502 as the elastomers, effective styrenation of SBO significantly increased moduli and tensile strength. However, with COPO-1500 as the elastomer, a strong effect of the degree of SBO styrenation on rubber mechanical properties was observed that was not observed with the rubber analogs based on KER-1502 as the elastomer. As shown in Table 25, increasing polystyrene graft concentration from 10 to 37 wt. % caused an increase in moduli. For Sample 47 it was observed that the rubber compound tended to stick to the rolls of the two-roll mill, which was not observed for the other examples. Thus, with regard to processability, a polystyrene graft content of 37% may not be the optimum for this particular rubber formulation.

TABLE 25
Composition and properties of rubbers produced using SBO-g-PSs as processing oils.
All values are in units of parts per 100 parts of elastomer (i.e. COPO-1500).

| | Reference 11 | Sample 44 | Sample 45 | Sample 46 | Sample 47 |
|---|---|---|---|---|---|
| Starting Material | | | | | |
| COPO-1500 | 100.00 | 100.00 | 100.00 | 100.00 | 100.00 |
| SBO | 37.50 | — | — | — | — |
| SBO-g-PS10(Example 12) | — | 37.50 | — | — | — |
| SBO-g-PS15(Example 13) | — | — | 37.50 | — | — |
| SBO-g-PS25 (Example 14) | — | — | — | 37.50 | — |
| SBO-g-37% PS (Example 26) | — | — | — | — | 37.50 |
| CB | 101.00 | 101.00 | 101.00 | 101.00 | 101.00 |
| ZnO | 4.125 | 4.125 | 4.125 | 4.125 | 4.125 |
| SA | 1.375 | 1.375 | 1.375 | 1.375 | 1.375 |
| TBBS | 1.375 | 1.375 | 1.375 | 1.375 | 1.375 |
| S8 | 2.406 | 2.406 | 2.406 | 2.406 | 2.406 |
| Properties | | | | | |
| Mooney viscosity | 56.6 | 60.9 | 65.1 | 66.1 | N/A |
| Mod. 300% elong. (MPa) | 9.86 ± 0.12 | 12.18 ± 0.29 | 13.95 ± 0.20 | 15.79 ± 0.44 | 16.52 ± 0.25 |
| Mod. 100% elong. (MPa) | 3.03 ± 0.11 | 3.42 ± 0.10 | 3.90 ± 0.08 | 4.66 ± 0.12 | 4.67 ± 0.13 |
| Tensile Strength (MPa) | 16.3 ± 0.2 | 16.8 ± 0.5 | 17.2 ± 0.20 | 19.3 ± 0.1 | 18.2 ± 0.5 |
| Elongation (%) | 490 ± 12 | 409 ± 15 | 367 ± 3 | 368 ± 3 | 332 ± 14 |

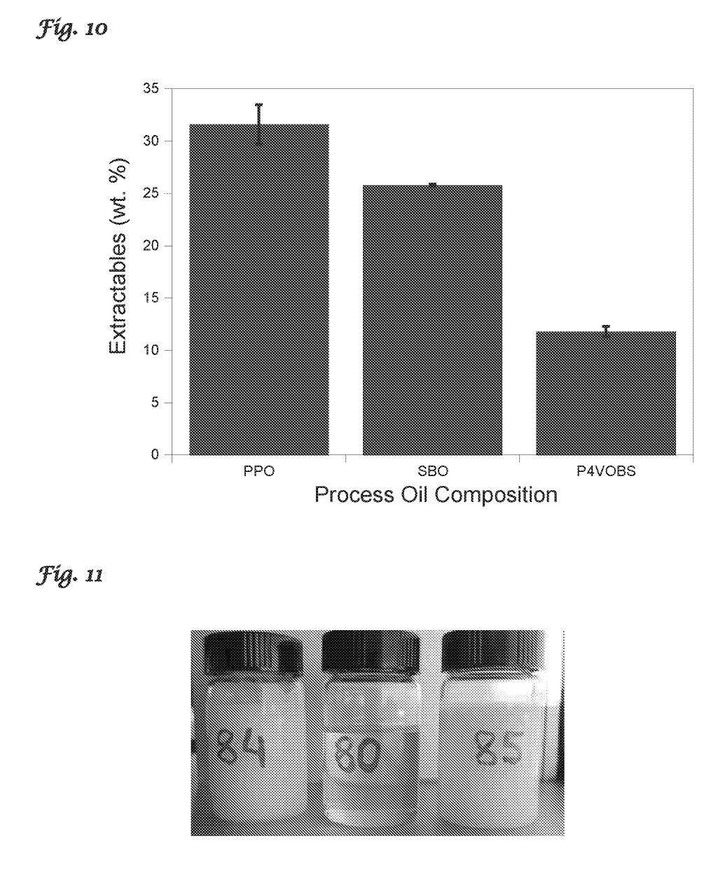

For rubber compounds designed for specific applications, such as automobile tires, the viscoelastic properties of the rubber are very important. It has been shown that loss tangent data (i.e. ratio of loss modulus to storage modulus) obtained from dynamic mechanical analysis (DMA) can be used to predict wet traction behavior and rolling resistance of tires. The value of the loss tangent at 0° C. correlates to wet traction behavior, while the value of the loss tangent at 60° C. correlates to rolling resistance. The higher the value of the loss tangent at 0° C., the better the wet traction of the tire tread. The lower the loss tangent at 60° C., the lower the rolling resistance and, thus, the better the fuel economy. DMA was conducted on rectangular specimens that were 15 mm long, 5 mm wide, and 1.50 mm thick. The instrument was a Q800 V206 from TA Instruments. The operating parameters consisted of a temperature ramp from −80° C. to 70° C. at a rate of 5° C./minute, frequency of 1 Hz, and strain of 0.1%. FIG. 12 compares loss tangent between Reference 4, Reference 5, and Sample 46, while Table 26 provides data for the glass transition temperature (Tg), loss tangent at 0° C., and loss tangent at 60° C. The Tg was taken as the peak maximum.

As shown in FIG. 12 and Table 26, substitution of the conventional petroleum-based processing oil (AR Oil—Reference 4) with SBO (Reference 5) resulted in a dramatic reduction in Tg of the cured rubber. The magnitude of the Tg reduction was 17° C. By incorporating styrene grafts into the SBO the Tg reduction was significantly reduced from 17° C. to 11° C. In addition, use of SBO-g-25% PS resulted in the lowest loss tangent value at 60° C. indicating that this rubber would provide the lowest rolling resistance and, thus, best fuel economy if used as a tire tread rubber.

TABLE 26
Data for the Tg, loss tangent at 0° C., and loss tangent at
60° C. for Reference 10, Reference 11, and Sample 46

| | | | tan δ at | tan δ at |
|---|---|---|---|---|
| | Processing Oil | Tg (° C.) | 0° C. | 60° C. |
| Reference 10 | AR Oil | −29 | 0.32 | 0.275 |
| Reference 11 | SBO | −46 | 0.33 | 0.271 |
| Sample 46 | SBO-g-25% PS | −40 | 0.31 | 0.265 |
| | (Example 14) | | | |

Table 27 illustrates the influence of the process for producing SBO-g-PSs on their utility as a processing oil. The data presented in Table 27 compares the properties of rubbers generated using processing oils produced by styrenating SBO using 30 weight percent styrene and three different styrenation methods. The styrenated SBOs were SBO-g-27% PS (Example 23), SBO-g-28.5% PS (Example 24), and SBO-g-30% PS (Example 25). As shown in Table 8, it is clear that the method of styrenation has a major impact on the properties of the rubber. The use of SBO-g-27% PS (Example 23) as a processing oil provided much higher moduli and tensile strength that the analogous rubbers based on SBO-g-28.5% PS (Example 24) or SBO-g-30% PS (Example 25) as the processing oil. The process for producing SBO-g-27% PS (Example 23) involved the slow addition of a solution of dTBP and styrene to hot SBO, while the process for SBO-g-28.5% PS (Example 24) involved the slow addition of dTBP to a hot solution of SBO and styrene and the process for SBO-g-30% PS (Example 25) involved adding SBO, dTBP, and styrene at the beginning of the reaction.

TABLE 27
Composition and properties of rubbers generated using SBO-g-20% PS (Sample 18),
SBO-g-28.5% PS (Sample 19), and SBO-g-30% PS (Sample 20) as processing oils. All
values are in units of parts per 100 parts of elastomer (i.e. COPO-1500).

| | Reference 11 | Sample 48 | Sample 49 | Sample 50 |
|---|---|---|---|---|
| Starting Material | | | | |
| COPO-1500 | 100.00 | 100.00 | 100.00 | 100.0 |
| SBO | 37.50 | — | — | — |
| SBO-g-27% PS (Example 23) | — | 37.50 | — | — |
| SBO-g-28.5% PS (Example 24) | — | — | 37.50 | — |
| SBO-g-30% PS (Example 25) | — | — | — | 37.50 |
| CB | 101.00 | 101.00 | 101.00 | 101.00 |
| ZnO | 4.125 | 4.125 | 4.125 | 4.125 |
| SA | 1.375 | 1.375 | 1.375 | 1.375 |
| TBBS | 1.375 | 1.375 | 1.375 | 1.375 |
| S8 | 2.406 | 2.406 | 2.406 | 2.406 |
| Properties | | | | |
| Modulus at 300% elongation (MPa) | 9.86 ± 0.12 | 13.68 ± 0.19 | 10.43 ± 0.26 | 9.39 ± 0.18 |
| Modulus at 100% elongation (MPa) | 3.03 ± 0.11 | 3.91 ± 0.06 | 3.37 ± 0.07 | 3.14 ± 0.02 |
| Tensile Strength (MPa) | 16.3 ± 0.2 | 17.6 ± 0.4 | 14.4 ± 0.6 | 13.3 ± 0.3 |
| Elongation (%) | 490 ± 12 | 389 ± 8 | 425 ± 10 | 449 ± 8 |

Table 28 compares two different soy-based materials compared to SBO as a processing oil. The two different soy-based materials were SS and poly(2-VOES) with a molecular weight of 2,100 g/mole. Since none of these materials are styrenated, they are considered reference materials.

As shown in Table 28, use of both SS and the 2,100 g/mole poly(2-VOES) as a processing oil provided higher moduli and tensile strength and lower Mooney viscosity than the corresponding rubber based on SBO as the processing oil.

TABLE 28
Composition and properties of rubbers produced using SBO, SS, and
a 2,100 g/mole poly(2-VOES) as processing oils. All values are
in units of parts per 100 parts of elastomer (i.e. KER 1502).

| | Reference 6 | Reference 12 | Reference 13 |
|---|---|---|---|
| Starting Material | | | |
| KER 1502 | 100.00 | 100.00 | 100.00 |
| SBO | 37.50 | — | — |
| SS | — | 37.50 | — |
| Poly(2-VOES) | — | — | 37.50 |
| CB | 101.00 | 101.00 | 101.00 |
| ZnO | 4.125 | 4.125 | 4.125 |
| SA | 1.375 | 1.375 | 1.375 |
| TBBS | 1.375 | 1.375 | 1.375 |
| S8 | 2.406 | 2.406 | 2.406 |
| Properties | | | |
| Mooney viscosity | NA | 58.0 | 61.2 |
| Modulus at 300% | 11.68 ± 0.10 | 14.06 ± 0.13 | 13.18 ± 0.06 |
| elongation (MPa) | | | |
| Modulus at 100% | 3.27 ± 0.06 | 3.78 ± 0.08 | 3.50 ± 0.06 |
| elongation (MPa) | | | |
| Tensile Strength (MPa) | 16.9 ± 1.1 | 18.3 ± 0.4 | 18.1 ± 0.4 |
| Elongation (%) | 430 ± 30 | 385 ± 11 | 400 ± 9 |

Table 29 shows the effect of styrenation of SS and the 2,100 g/mole poly(2-VOES) on rubber properties. The level of styrene used for graft was 15 wt. %. As shown in Table 29, grafting polystyrene to both SS and the 2,100 g/mole poly(2-VOES) resulted in higher moduli and tensile strength without negatively effecting elongation at break.

TABLE 29
Composition and properties of rubbers that illustrate the effect of styrenation
of SS and a 2,100 g/mole poly(2-VOES) on utility as a processing oil. All values are in
units of parts per 100 parts of elastomer (i.e. KER 1502).

| | Reference 12 | Sample 51 | Reference 13 | Sample 52 |
|---|---|---|---|---|
| Starting Material | | | | |
| KER 1502 | 100.00 | 100.00 | 100.00 | 100.00 |
| SS | 37.50 | — | — | — |
| SS-g-12% PS (Example 27) | — | 37.50 | — | — |
| Poly(2-VOES) | — | — | 37.50 | — |
| Poly(2-VOES)-g-11% PS | — | — | — | 37.50 |
| (Example 29) | | | | |
| CB | 101.00 | 101.00 | 101.00 | 101.00 |
| ZnO | 4.125 | 4.125 | 4.125 | 4.125 |
| SA | 1.375 | 1.375 | 1.375 | 1.375 |
| TBBS | 1.375 | 1.375 | 1.375 | 1.375 |
| S8 | 2.406 | 2.406 | 2.406 | 2.406 |
| Properties | | | | |
| Modulus at 300% | 14.06 ± 0.13 | 14.21 ± 0.26 | 13.18 ± 0.06 | 14.42 ± 0.14 |
| elongation (MPa) | | | | |
| Modulus at 100% | 3.78 ± 0.08 | 4.29 ± 0.07 | 3.50 ± 0.06 | 4.10 ± 0.03 |
| elongation (MPa) | | | | |
| Tensile Strength (MPa) | 18.3 ± 0.4 | 18.8 ± 0.5 | 18.1 ± 0.4 | 19.2 ± 0.5 |
| Elongation (%) | 385 ± 11 | 402 ± 19 | 400 ± 9 | 402 ± 12 |

Table 30 provides a comparison of rubbers based on COPO-1500 as the elastomer and SBO, SS, an SS-g-18% PS (Example 28) as processing oils. The data shown in Table 30 clearly shows use of SS-g-18% PS (Example 28) as the processing oil substantially increases moduli and tensile strength.

TABLE 30
Composition and properties of rubbers produced using SBO, SS,
an SS-g-18% PS (Example 28) as processing oils. All values are
in units of parts per 100 parts of elastomer (i.e. COPO-1500).

| | Reference 11 | Reference 14 | Sample 53 |
|---|---|---|---|
| Starting Material | | | |
| COPO-1500 | 100.00 | 100.00 | 100.00 |
| SBO | 37.50 | — | — |
| SS | — | 37.50 | — |
| SS-g-18% PS (Example 28) | — | — | 37.50 |
| CB | 101.00 | 101.00 | 101.00 |
| ZnO | 4.125 | 4.125 | 4.125 |
| SA | 1.375 | 1.375 | 1.375 |
| TBBS | 1.375 | 1.375 | 1.375 |
| S8 | 2.406 | 2.406 | 2.406 |
| Properties | | | |
| Mooney Viscosity | 56.6 | 58.7 | NA |
| Modulus at 300% elongation | 9.86 ± 0.12 | 11.61 ± 0.15 | 15.29 ± 0.08 |
| (MPa) | | | |
| Modulus at 100% elongation | 3.03 ± 0.11 | 3.40 ± 0.05 | 5.22 ± 0.11 |
| (MPa) | | | |
| Tensile Strength (MPa) | 16.3 ± 0.2 | 17.7 ± 0.4 | 18.8 ± 0.8 |
| Elongation (%) | 490 ± 12 | 450 ± 14 | 354 ± 11 |

Samples 42 to 53 were all produced using a rubber formulation containing 37.5 parts per hundred parts (phr) of elastomer as the concentration of the processing oils. The data shown in Tables 31 and 32 are based on a rubber formulation with 25.0 phr of processing oil. Table 32 provides data for reference rubbers.

TABLE 32
Composition and properties of the reference rubbers based on 25 phr of
processing oil. All values are in units of parts per 100 parts of elastomer
(i.e. KER-1502).

| | Reference 7 | Reference 8 | Reference 9 |
|---|---|---|---|
| Starting Material | | | |
| KER-1502 | 100.00 | 100.00 | 100.00 |
| AR Oil | 25 | — | — |
| SBO | — | 25 | 25 |
| CB | 92 | 92 | 92 |
| ZnO | 3.00 | 3.00 | 3.75 |
| SA | 1.00 | 1.00 | 1.25 |
| TBBS | 1.25 | 1.25 | 1.25 |
| S8 | 1.75 | 1.75 | 2.19 |
| Properties | | | |
| Modulus at 300% elongation | 17.12 ± 0.48 | 9.04 ± 0.13 | 13.26 ± 0.15 |
| (MPa) | | | |
| Modulus at 100% elongation | 4.80 ± 0.14 | 3.53 ± 0.11 | 3.70 ± 0.06 |
| (MPa) | | | |
| Tensile Strength (MPa) | 19.7 ± 0.7 | 16.4 ± 0.7 | 19.1 ± 0.6 |
| Elongation (%) | 345 ± 6 | 445 ± 19 | 328 ± 17 |

By comparing the properties of Reference 8 to Reference 7, it can be seen that direct substitution of the conventional petroleum-based processing oil (AR Oil) with SBO results in dramatic reductions in moduli and tensile strength. Since SBO contains unsaturation, a third reference was produced (Reference 9) in which additional curative (S8 and TBBS) was added to account for the “extra” unsaturation in the formulation. By comparing Reference 9 to Reference 8, it can be seen that this increase in curatives increased moduli and tensile strength, but not nearly to the level of that of Reference 7. Thus, these results show that the use of SBO as a processing oil substantially reduces key mechanical properties, such as moduli and tensile strength, compared to the use of the conventional petroleum-based processing oil.

Table 33 compares the properties of rubbers based on SBO-g15% PS (Example 13) and SBO-g-25% PS (Example 14) as processing oils to the reference based on SBO. As shown in Table 23, styrenation of the SBO substantially increased moduli and tensile strength without sacrificing elongation.

TABLE 33
Composition and properties of rubbers based on SBO-g15% PS
(Example 13) and SBO-g-25% PS (Example 14) as processing
oils to the reference based on SBO. All values are
in units of parts per 100 parts of elastomer (i.e. KER-1502).

| | Reference 9 | Sample 54 | Sample 55 |
|---|---|---|---|
| Starting Material | | | |
| KER-1502 | 100.00 | 100.00 | 100.00 |
| SBO | 25 | — | — |
| SBO-g15% PS (Example 13) | — | 25 | — |
| SBO-g-25% PS (Example 14) | — | — | 25 |
| CB | 92 | 92 | 92 |
| ZnO | 3.75 | 3.75 | 3.75 |
| SA | 1.25 | 1.25 | 1.25 |
| TBBS | 1.25 | 1.25 | 1.25 |
| S8 | 2.19 | 2.19 | 2.19 |
| Properties | | | |
| Modulus at 300% elongation | 13.26 ± 0.15 | 17.88 ± 0.12 | 17.20 ± 0.44 |
| (MPa) | | | |
| Modulus at 100% elongation | 3.70 ± 0.06 | 4.79 ± 0.03 | 4.78 ± 0.11 |
| (MPa) | | | |
| Tensile Strength (MPa) | 19.1 ± 0.6 | 20.3 ± 0.5 | 19.5 ± 1.3 |
| Elongation (%) | 328 ± 17 | 340 ± 9 | 339 ± 21 |

Tables 34 and 35 provide the composition and properties of rubbers based on a formulation that utilizes 50.0 phr of processing oil. Table 34 provides data for reference rubbers. By comparing the properties of Reference 2 to Reference 1, it can be seen that direct substitution of the conventional petroleum-based processing oil (AR Oil) with SBO results in dramatic reductions in moduli and tensile strength. Since SBO contains unsaturation, a third reference was produced (Reference 3) in which additional curative (S8 and TBBS) was added to account for the “extra” unsaturation in the formulation. By comparing Reference 3 to Reference 2, it can be seen that this increase in curatives increased moduli and tensile strength, but not nearly to the level of that of Reference 1. Thus, these results show that the use of SBO as a processing oil substantially reduces key mechanical properties, such as moduli and tensile strength, compared to the use of the conventional petroleum-based processing oil.

TABLE 34
Composition and properties of the reference rubbers produced using
50.0 phr of processing oil. All values are in units of parts per
100 parts of elastomer (i.e. KER-1502).

| | Reference 1 | Reference 2 | Reference 3 |
|---|---|---|---|
| Starting Material | | | |
| KER-1502 | 100.00 | 100.00 | 100.00 |
| AR Oil | 50 | — | — |
| SBO | — | 50 | 50 |
| CB | 110 | 110 | 110 |
| ZnO | 3.00 | 3.00 | 4.5 |
| SA | 1.00 | 1.00 | 1.5 |
| TBBS | 1.5 | 1.5 | 1.5 |
| S8 | 1.75 | 1.75 | 2.625 |
| Properties | | | |
| Modulus at 300% elongation | 11.92 ± 0.16 | 6.45 ± 0.17 | 9.24 ± 0.15 |
| (MPa) | | | |
| Modulus at 100% elongation | 3.41 ± 0.07 | 2.18 ± 0.05 | 2.63 ± 0.05 |
| (MPa) | | | |
| Tensile Strength (MPa) | 16.8 ± 0.8 | 11.3 ± 0.3 | 14.4 ± 0.5 |
| Elongation (%) | 424 ± 26 | 513 ± 19 | 452 ± 16 |

Table 35 compares the properties of rubbers based on SBO-g15% PS (Sample 8) and SBO-g-25% PS (Sample 9) as processing oils to the reference based on SBO. As shown in Table 13, styrenation of the SBO substantially increased moduli and tensile strength.

TABLE 35
Composition and properties of rubbers based on SBO-g15% PS
(Example 13) (Example 13) and SBO-g-25% PS (Example 14) as
processing oils to the reference based on SBO (Reference 3). All
values are in units of parts per 100 parts of elastomer (i.e. KER-1502).

| | Reference 3 | Sample 56 | Sample 57 |
|---|---|---|---|
| Starting Material | | | |
| KER-1502 | 100.00 | 100.00 | 100.00 |
| SBO | 50 | — | — |
| SBO-g15% PS (Example 13) | — | 50 | — |
| SBO-g-25% PS (Example 14) | — | — | 50 |
| CB | 110 | 110 | 110 |
| ZnO | 4.5 | 4.5 | 4.5 |
| SA | 1.5 | 1.5 | 1.5 |
| TBBS | 1.5 | 1.5 | 1.5 |
| S8 | 2.625 | 2.625 | 2.625 |
| Properties | | | |
| Modulus at 300% elongation | 9.24 ± 0.15 | 15.49 ± 0.26 | 15.08 ± 0.29 |
| (MPa) | | | |
| Modulus at 100% elongation | 2.63 ± 0.05 | 3.92 ± 0.09 | 4.20 ± 0.07 |
| (MPa) | | | |
| Tensile Strength (MPa) | 14.4 ± 0.5 | 17.7 ± 0.5 | 16.5 ± 1.0 |
| Elongation (%) | 452 ± 16 | 340 ± 8 | 327 ± 22 |

### Example 32

The goal of this example is to show the usefulness of utilizing soybean oil (SBO) as a basis for the production of a bio-based and eco-friendly alternative to conventional petroleum-based processing oils (PBOs) for rubber compounds. Direct replacement of a conventional PBO with SBO in styrene-butadiene resin (SBR) rubber compounds may result in substantial reductions in key rubber properties including moduli and tensile strength. Grafting of polystyrene chains to SBO may overcome these deficiencies and the modified SBO provides properties comparable with the properties of PBO-based rubber compounds.

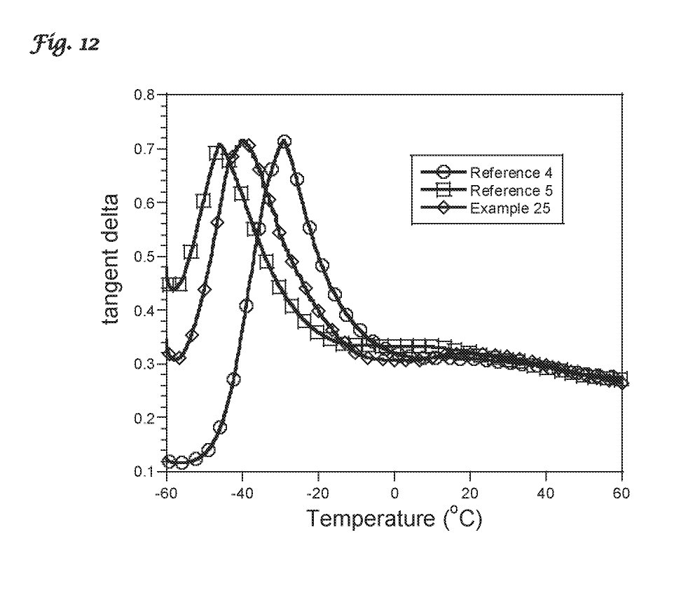

FIG. 1 offer a possible mechanistic explanation for the grafting of styrene to the SBO. FIGS. 13a and 13b provide Fourier Transform infrared (FTIR) and nuclear magnetic resonance (NMR) spectroscopy traces of SBO and styrenated SBO (e.g., SBO-PS in FIGS. 13A and 3B).

Table 36 below shows properties (molecular weight and viscosity) of styrenated soybean oil (SBO) having different levels (10 wt % added, 20 wt % added, and 30 wt % added) of styrene grafting. A petroleum based processing oil (AR Oil) is also offered for the sake of comparison.

TABLE 36
Properties of synthesized oils with different level of grafted polystyrene

| | Oil | | | | |
|---|---|---|---|---|---|
| | SBO-PS10 | SBO-PS20 | SBO-PS30 | AR Oil | SBO |
| Styrene added, | 10 | 20 | 30 | | |
| wt. % | | | | | |
| Grafted | 9.5 | 15.2 | 24.4 | | |
| polystyrene, wt. % | | | | | |
| Styrene | 95 | 76 | 83 | | |
| conversion, % | | | | | |
| Ungrafted | 0.1 | 0.1 | 0.6 | | |
| polystyrene, wt. % | | | | | |
| Molecular Weight | 7700/4800 | 13000/ | 14000/ | | |
| of the SBO-PS, | | 4200 | 5900 | | |
| Mw/Mn | | | | | |
| Oil Viscosity, Pa s | 0.27 | 1.62 | 6.77 | 2.12 | 0.05 |

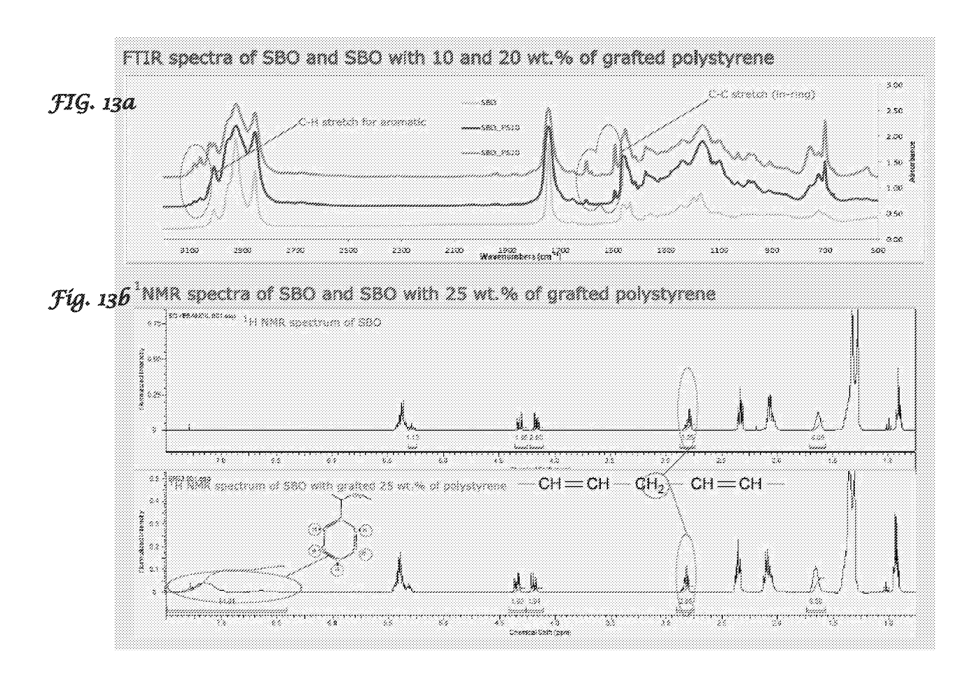

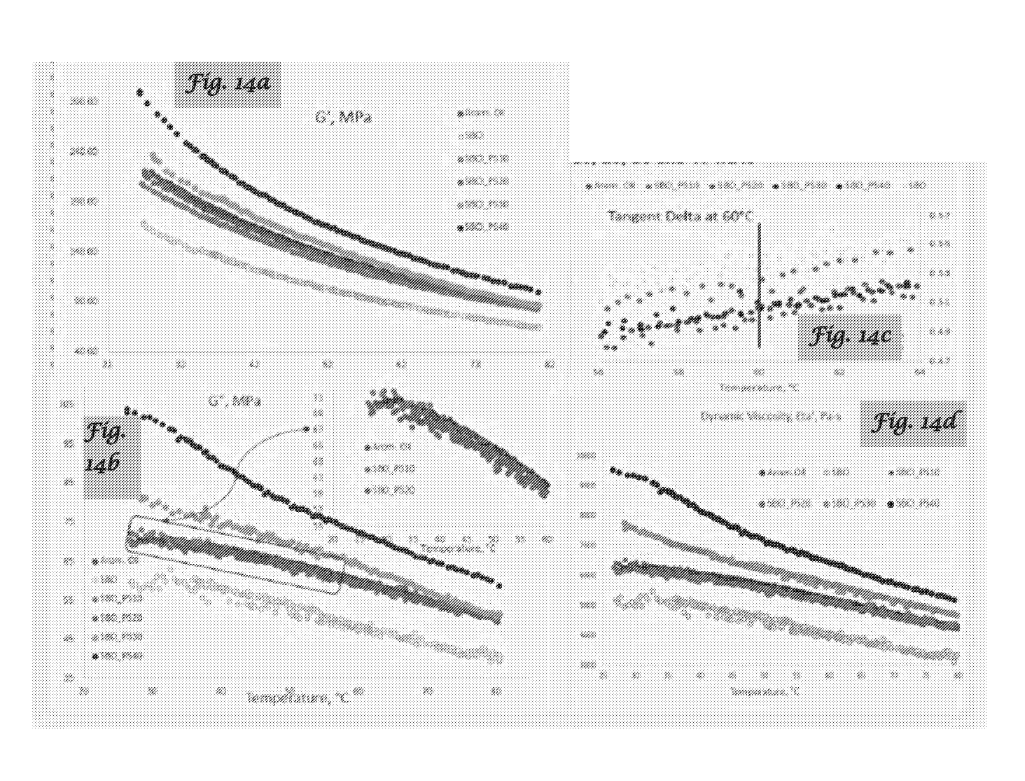

The styrenated soybean oils were utilized, at 25 wt % levels, in rubber compositions and they were subjected to dynamic mechanical analysis (DMA). Specifically, viscoelastic properties of a styrene butadiene rubber (SBR) blended with 25 wt % of the oils (e.g., styrenated SBO at various levels, SBO and a PPO) were tested in shear mode DMA, with a heating rate of 2° C./minute and a frequency of 2 Hz. The storage moduli G′ (FIG. 14a), the loss moduli G″ (FIG. 14b), the tangent δ (FIG. 14c) and eh dynamic viscosity (FIG. 14d) were determined for SBR blends with 25 wt % PBO (aromatic oil), SBO and SBO-PS with grafted polystyrene levels of 10, 20, 30 and 40 wt %. The results of the testing can be seen in FIGS. 14a, 14b, 14c and 14d.

Mooney viscosity of uncured rubber samples produced using SBR KER®-1502 with 37.5 parts per hundred (phr) of various processing oils and 40 wt. % carbon black were measured. In Table 17 below, MI is the initial maximum (i.e., Mooney peak), ML is Mooney viscosity ML (1+4) 100° C. and Relax (Tx80), is the time required to achieve an 80% drop from the peak torque.

TABLE 37
Mooney viscosity test data for uncured rubber samples produced using
SBR KER ®-1502 with 37.5 phr of various processing oils

| | Mooney Viscosity | | |
|---|---|---|---|
| Oil | MI | ML | Relax (Tx80) |
| PBO | 127.9 | 64.4 | 5.52 |
| SBO-PS10 | 114.1 | 56 | 5.2 |
| SBO-PS20 | 116.7 | 56.4 | 4.42 |
| SBO-PS30 | 121.4 | 58.2 | 4.16 |

TABLE 38
Mooney viscosity test data for uncured rubber samples produced using
SBR COPO-1500 with 37.5 phr of various processing oils

| | Mooney Viscosity | | |
|---|---|---|---|
| Oil | MI | ML | Relax (Tx80) |
| AR Oil | 125.1 | 69.6 | 5.58 |
| SBO | 102.3 | 56.6 | 4.54 |
| SBO-PS10 | 116.9 | 60.9 | 6.04 |
| SBO-PS20 | 133.0 | 65.1 | 6.36 |
| SBO-PS30 | 129.3 | 66.1 | 6.08 |
| SS | 113.0 | 58.7 | 5.06 |
| Poly(2-VOES) | 115.9 | 58.9 | 5.84 |

Tensile properties of rubber samples produced using SBR KER-1502 (Synthos) with 25 phr of processing oils and 40 wt. % of carbon black were also measured and the results are shown in Table 39 below.

TABLE 39

| | | Elongation | 100% | 300% |
|---|---|---|---|---|
| | Tensile Strength, | at | Modulus | Modulus, |
| | MPA | Break, % | Mpa | Mpa |
| Arom.Oil | 19.7 ± 0.7 | 345 ± 6 | 4.80 ± 0.14 | 17.12 ± 0.48 |
| SBO | 19.1 ± 0.6 | 328 ± 17 | 3.70 ± 0.06 | 13.26 ± 0.15 |
| SBO-g-PS20 | 20.3 ± 0.5 | 340 ± 9 | 4.79 ± 0.03 | 17.88 ± 0.12 |
| SBO-g-PS30 | 19.5 ± 1.3 | 339 ± 21 | 4.78 ± 0.11 | 17.20 ± 0.44 |

Tensile properties of rubber samples produced using SBR KER-1502 (Synthos) with 50 phr of processing oils and 40 wt. % of carbon black were also measured and the results are shown in Table 40 below.

TABLE 40

| | | Elongation | 100% | 300% |
|---|---|---|---|---|
| | Tensile Strength, | at | Modulus | Modulus, |
| | MPA | Break, % | Mpa | Mpa |
| Arom.Oil | 17.6 ± 1.3 | 312 ± 22 | 4.81 ± 0.11 | 17.06 ± 0.37 |
| SBO | 14.4 ± 0.5 | 452 ± 16 | 2.63 ± 0.05 | 9.24 ± 0.15 |
| SBO-g-PS20 | 17.7 ± 0.5 | 340 ± 8 | 3.92 ± 0.09 | 15.49 ± 0.26 |
| SBO-g-PS30 | 16.5 ± 1.0 | 327 ± 22 | 4.2 ± 0.07 | 15.08 ± 0.29 |

Tensile properties of rubber samples produced using SBR KER-1502 (Synthos) with 37.5 phr of processing oils and 40 wt. % of carbon black were also measured and the results are shown in Table 41 below.

TABLE 41

| | | Elongation | 100% | 300% |
|---|---|---|---|---|
| | Tensile Strength, | at | Modulus | Modulus, |
| | MPA | break, % | Mpa | Mpa |
| Arom.Oil | 19.4 ± 0.9 | 322 ± 22 | 5.13 ± 0.25 | 18.02 ± 0.49 |
| SBO | 16.9 ± 1.1 | 430 ± 30 | 3.27 ± 0.06 | 11.68 ± 0.10 |
| SBO-g-PS10 | 18.7 ± 1.0 | 370 ± 18 | 4.09 ± 0.06 | 15.11 ± 0.31 |
| SBO-g-PS20 | 17.2 ± 0.2 | 367 ± 3 | 3.90 ± 0.08 | 13.95 ± 0.20 |
| SBO-g-PS30 | 20.0 ± 0.4 | 384 ± 7 | 4.18 ± 0.08 | 15.62 ± 0.26 |

Polystyrene grafting onto SBO enables direct replacement of modified SBO in an SBR-based rubber compound. Styrenated SBO can be utilized without sacrificing rheological and mechanical properties compared to conventional petroleum oil-based rubber compounds.

### Example 33

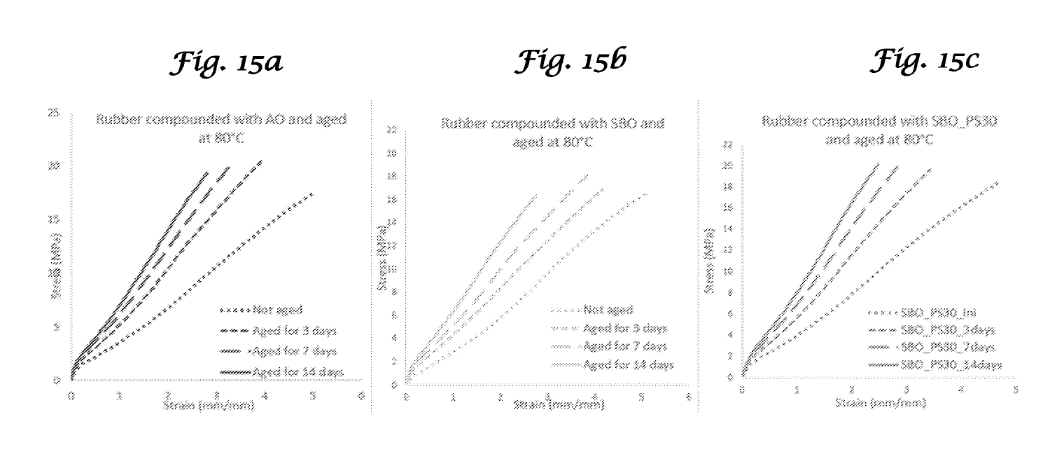

Soybean oil (SBO) with grafted polystyrene can be effectively used as a processing oil for styrene-butadiene (SBR) rubber compounds. Mechanical (tensile) properties of rubber compounded with polystyrene-modified SBO with 30 wt. % of grafted polystyrene are comparable to the properties of rubber compounded with commonly used petroleum based aromatic processing oil (AO). The thermal aging test of rubber samples compounded with AO, SBO and SBO with 30 wt. % of grafted polystyrene (SBO-PS30) are shown in FIGS. 15a (rubber compounded with AO), 15b (rubber compounded with SBO) and 15c (rubber compounded with SBO having 30 wt % of grafted polystyrene) and demonstrate the decrease in elongation at break but increase of moduli for all tested rubbers.

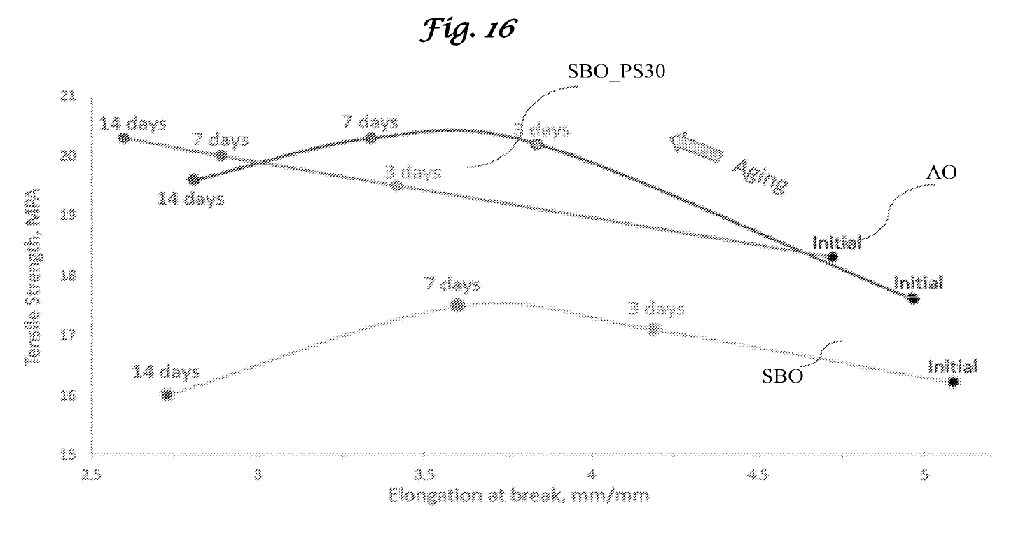

The increase in moduli and the decrease in elongation indicated continuing cross-linking when rubber samples are thermally aged. As shown in FIG. 16, rubbers compounded with SBO and AO, which were thermally aged for 14 days showed a drop in tensile strength. Rubbers compounded with SBO-PS30, did not show a tensile strength decrease, even after 14 days of aging. FIG. 16 also demonstrates mapping of tensile strength vs elongation at break data for the rubber samples compounded with AO, SBO and SBO-PS30 and aged for 3, 7 and 14 days. As seen there, the stress-strain data for the rubber compounded with SBO-PS30 show lineal increase in tensile strength when aged (FIG. 16) while rubbers compounded with SBO and AO show degradation in tensile properties after 7 days of aging.

### Example 34

In order to maximize the fraction of styrene that is chemically attached to the SBO, multiple synthesis experiments were conducted with variation in concentration of di-tert-butyl peroxide (tBP) and addition time for monomer/initiator solution. The viscosity of obtained oils and solubility in different solvents were tested after each synthesis. The ethanol-soluble fraction characterizes the amount of SBO that was not reacted with styrene. The hexane-insoluble fraction is the ungrafted polystyrene. Many factors may affect styrene conversion and content of the final product, such as concentration of tBP, temperature, time for addition of monomer and initiator. Table 42 shows how the concentration of initiator affects styrene conversion and grafting efficiency in synthesis of SBO-PS30, at the same feeding rate which corresponds to total monomer/initiator addition time of 3 hours. Each experiment was replicated 2-3 times to confirm reproducibility but the results in Table 42 are the results of the experiments with the highest conversion.

TABLE 42
Properties of SBO-PS30 oils synthesized at 150° C., monomer/initiator
addition time 3 h and different concentration of di-ter-butyl-peroxide.

| Concen- | Max. styrene | Ungrafted | Ungrafted | | |
|---|---|---|---|---|---|
| tration of | conversion, | SBO, | polystyrene, | Viscosity, | Mw, |
| tBP, wt. % | wt. % | wt. % | wt. % | Pa · s | g/mol |
| 4 | 79 | 11 | 0.1 | 1.84 | 2200 |
| 5 | 84 | 7 | 0.1 | 1.92 | 2400 |
| 6 | 94 | 6 | 0.1 | 2.04 | 6000 |

The lower concentration of tBP caused the lower conversion of styrene but amount of ungrafted polystyrene was the same at each concentration. The concentration of initiator of 6 wt. % provides the highest conversion.

### Example 35

Another important parameter is the addition rate for monomer/initiator solution. Table 43 shows experimental results of synthesis SBO-PS30 oils at 150° C., with 6 wt. % of initiator and different addition rates. The total addition time was varied from 0.5 to 3.5 hours. As can be seen from the table 43, the styrene conversion was higher at higher addition rate (shorter time) and decreased when monomer/initiator solution was added slower. At the same time, the content of ethanol-soluble oil, which is ungrafted SBO, decreased when the monomer/initiator solution was added slower. The highest grafting efficiency and almost 100% conversion was achieved when 10% of monomer/initiator solution were added at the beginning of synthesis and the remaining solution was added during 3 hours (last experiment in the Table 42).

TABLE 43
Properties of SBO-PS30 oils synthesized at 150° C.,
concentration of di-ter-butyl-peroxide 6 wt. % and
different addition time for monomer/initiator solution.

| | Styrene | | Ungrafted | |
|---|---|---|---|---|
| | conversion, | Ungrafted | polystyrene, | Viscosity, |
| Addition time, h. | wt. % | SBO, wt. % | wt. % | Pa · s |
| 0.5 | 98 | 28 | 0.8 | 12.37 |
| 1.5 | 96 | 24 | 0 | 5.72 |
| 2 | 92 | 22 | 0.4 | 2.60 |
| 2.5 | 87 | 16 | 0.2 | 2.78 |
| 3 | 85 | 12 | 0.6 | 2.04 |
| 3.5 | 83 | 11 | 0.6 | 2.52 |
| 3 h after 10% | 99.7 | 0 | 0 | 6.12 |

### Example 36

Multiple synthesis experiments were run and the polystyrene-grafted SBO (SBO-PS) samples were analyzed gravimetrically for monomer conversion, ungrafted oil content, ungrafted polystyrene content and viscosity. The properties of synthesized SBO-PS oils are listed in Table 44. All synthesis experiments were targeted to achieve 30 wt. % of grafted polystyrene and 100% conversion.

TABLE 44
Styrene-Soybean Oil Grafting Experiments

| | Initial amount of | Time of | | | | | |
|---|---|---|---|---|---|---|---|
| | monomer-initiator | remaining | Grafted | Ungrafted | Ungrafted | Conversion | Viscosity |
| Sample | solution added | addition | PS (%) | SBO (%) | PS (%) | (%) | (Pa s) |
| 58 | 20% of monomer- | 2 hours | 12.7 | 16.4 | 13.4 | 87.0 | 0.53 |
| | initiator | | | | | | |
| 59 | 20% of monomer- | 3 hours | 16.9 | 1.1 | 9.6 | 88.3 | 0.92 |
| | initiator | | | | | | |
| 60 | 10% of monomer- | 3 hours | 18.8 | 2.8 | 9.2 | 92.9 | 1.98 |
| | initiator | | | | | | |
| 61 | 0% initial addition | 4 hours | 29.6 | 0 | 0.5 | 98.7 | 5.80 |
| 62 | 15% initiator and | 3 hours | 30 | 0 | 0 | 99.9 | 6.12 |
| | 5% monomer | | | | | | |
| 63 | 15% initiator and | 3 hours | 25.6 | 2 | 3 | 95.3 | 4.18 |
| | 5% monomer | | | | | | |
| 64 | 15% initiator and | 3 hours | 18.9 | 22.1 | 9.8 | 95.7 | 1.92 |
| | 10% monomer | | | | | | |

As can be seen from Table 44, the most successful synthesis was Sample 62, where 15% of the initiator and 5% of the monomer were pre-loaded and the remaining monomer-initiator solution was added in 3 hours. However, the duplicate synthesis, Sample 63, showed that the properties of the product were slightly different, namely, a lower conversion and the presence of 3% of ungrafted polystyrene. Furthermore, Sample 63 had a lower viscosity than the first run, likely because it contains 2% of ungrafted SBO.

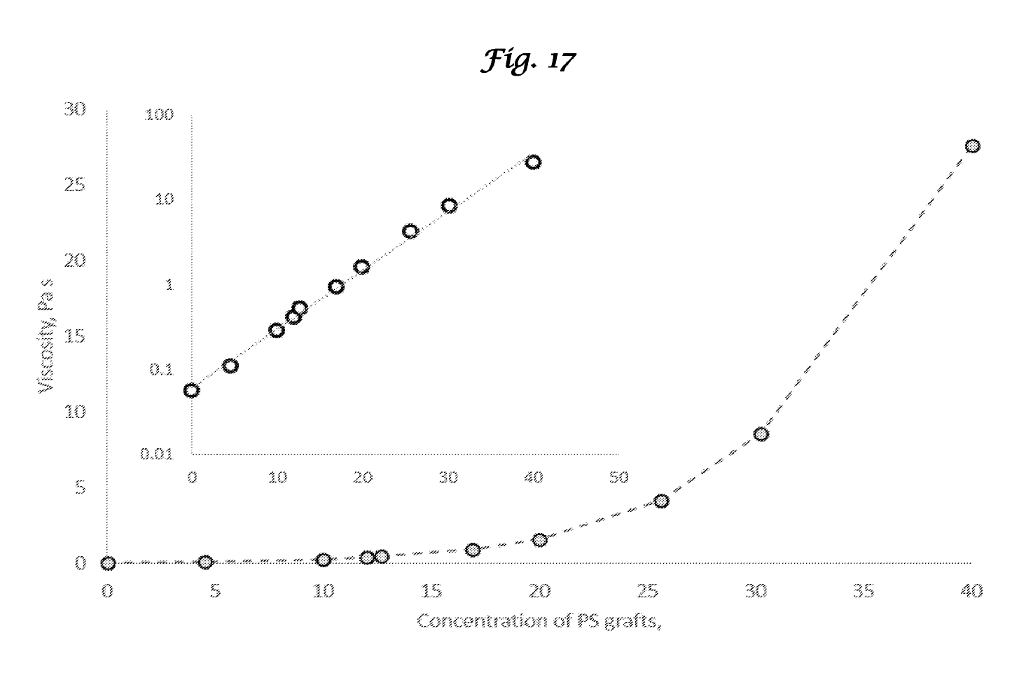

Viscosity of different processing oils vs. concentration of grafted PS at the 23° C. is shown in FIG. 17. As seen in the insert, the viscosity of SBO-PS oils depend on the concentration of grafted polystyrene in logarithmic scale.

The large graph in FIG. 17 shows how the viscosity increases with the concentration of grafted polystyrene. Viscosity vs graft PS concentration dependency can be described by the exponential equation: η=0.06 exp (0.16·C_{PS}). This equation allows for the concentration of grafted polystyrene to obtain a processing oil with a desired viscosity. If commonly used aromatic processing oil (AO) has a viscosity of 2.12 Pa s, according to the equation, the viscosity of SBO-PS with 22% of grafted polystyrene will by close to that of AO.

### Example 37

Some of the synthesized SBO-PS oils were used for SBR rubber compounding in order to compare the mechanical properties of rubbers compounded with SBO-PS oils with different viscosities and grafted polystyrene concentration. All rubbers were compounded with 37.5 phr of processing oil and 101 phr of carbon black. The rubber samples were then vulcanized at 145° C. for 35 min.

TABLE 45
Tensile data for vulcanized SBR rubbers compounded
with 37.5 phr of oil and 101 phr of carbon black

| | | | | | Modulus | Modulus |
|---|---|---|---|---|---|---|
| | | | Tensile | Elongation | at 100% | at 300% |
| | % of | Viscosity, | Strength, | at Break, | elongation, | elongation, |
| Oil | PS | Pa s | MPA | % | MPa | MPa |
| AO | 0 | 2.21 | 17.2 ± 0.5 | 431 ± 17 | 3.74 ± 0.05 | 12.25 ± 0.12 |
| SBO | 0 | 0.055 | 16.2 ± 0.2 | 509 ± 17 | 2.94 ± 0.07 | 9.42 ± 0.58 |
| Example 20, stored | 26 | 2.04 | 18.3 ± 0.2 | 447 ± 20 | 4.30 ± 0.11 | 13.18 ± 0.29 |
| for 6 month | | | | | | |
| Sample 63 | 30 | 6.12 | 19.4 ± 0.3 | 462 ± 8 | 4.10 ± 0.03 | 12.54 ± 0.07 |
| Sample 64 | 28.6 | 4.18 | 17.5 ± 0.3 | 429 ± 10 | 4.12 ± 0.08 | 12.40 ± 0.36 |
| Sample 59 | 16.9 | 0.92 | 17.6 ± 0.6 | 469 ± 23 | 3.86 ± 0.08 | 11.39 ± 0.29 |
| (oil phase only) | | | | | | |

Table 44 shows the tensile test data for vulcanized rubbers compounded with different oils. Two reference oils were also used for rubber compounding—aromatic oil (AO) and soybean oil (SBO). Example 20 in Table 44 was synthesized as before and was stored for 6 months before used for rubber compounding. Samples 63 and 34 were vacuum evaporated to remove unreacted styrene and Sample 59 was separated from unreacted styrene and ungrafted polystyrene before use for rubber compounding. From the tensile test data, it can be seen that tensile strength for rubber compounded with Sample 64 which contains 3% of ungrafted polystyrene, is similar as for rubber compounded with Sample 59, containing only 16.9% of grafted PS but the moduli are a little higher than for rubber compounded with Sample 59. All rubbers compounded with SBO-PS oils demonstrate sufficiently higher tensile strength and moduli than rubber compounded with pure SBO and little higher than rubber compounded with AO.

The complete disclosures of all patents, patent applications including provisional patent applications, and publications, and electronically available material cited herein are incorporated by reference. The foregoing detailed description and examples have been provided for clarity of understanding only. No unnecessary limitations are to be understood therefrom. The invention is not limited to the exact details shown and described; many variations will be apparent to one skilled in the art and are intended to be included within the invention defined by the claims.

1. A rubber composition comprising:
a rubber component; and
at least one plant oil-based component selected from the group consisting of sucrose fatty acid ester, poly(vinyl ether) fatty acid ester, styrenated sucrose fatty acid ester, styrenated poly(vinyl ether) fatty acid ester, or any combination thereof.

2. The rubber composition of claim 1, wherein a petroleum processing oil has been substituted, in whole or in part, with the plant oil-based component.

3. The rubber composition of claim 1, wherein the plant oil is selected from the group consisting of soybean oil, canola oil, corn oil, linseed oil, rapeseed oil, safflower oil, sunflower oil, tall oil and tung oil.

4. The rubber composition of claim 1, wherein the sucrose fatty acid ester comprises a sucrose soyate.

5. The rubber composition claim 4, wherein the sucrose soyate comprises a sucrose octasoyate.

6. The rubber composition of claim 1, wherein the poly(vinyl ether) fatty acid ester comprises a low molecular weight a poly(vinyl ether) fatty acid ester.

7. The rubber composition of claim 1, wherein the poly(vinyl ether) fatty acid ester comprises at least one of a poly[(2-vinyloxy)ethyl soyate], a poly[(4-vinyloxy)butyl soyate] and a poly(2-(1-propenyl)oxyethyl soyate).

8. The rubber composition of claim 1, further comprises a plant oil.

9. The rubber composition of claim 1, wherein the rubber component comprises a natural rubber (NR), a styrene butadiene rubber (SBR), an isoprene rubber (IR), a butadiene rubber (BR), an ethylene-propylene rubber (EDM/EPDM), a butyl rubber (IIR), a bromobutyl rubber (BIIR), a chloroprene rubber (CR), nitrile rubber (NBR), or any combination thereof.

10. The rubber composition of claim 1, further comprising a reinforcing filler.

11. The rubber composition of claim 10, wherein the reinforcing filler comprises carbon black, silica particles, mineral fillers, or a combination thereof.

12. The rubber composition of claim 1, further comprising at least one additive selected from the group consisting of a stabilizer, an antioxidant, a lubricant, a vulcanization agent, a plasticizer, an additional processing aid, and an accelerator, or any combination thereof.

13. The rubber composition of claim 1, further comprising a processing aid comprising a petroleum-based processing oil.

14. The rubber composition of claim 1, which is a vulcanized rubber compound.

15. The rubber composition of claim 1, prior to vulcanization.

16. The rubber composition of claim 1, wherein the poly(vinyl ether) fatty acid ester comprises a copolymer of a plant oil-based vinyl ether fatty acid ester and at least one vinyl ether comonomer.

17. The rubber composition of claim 1, wherein the poly(vinyl ether) fatty acid ester comprises a copolymer of a plant oil-based vinyl ether fatty acid ester and at least one comonomer selected from the group consisting of maleic anhydride, acrylonitrile, methacrylonitrile, fumaric acid, dimethyl fumarate and dimethyl maleate.

18. The rubber composition of claim 17, wherein the copolymer comprises polyMA-2VOES or polyMA-4-VOBS or both.

19. The rubber composition of claim 1, wherein the amount of plant oil-based component is at least 5% by weight, at least 15% by weight, at least 25% by weight, at least 40% by weight, or at least 50% by weight.

20. The rubber composition of claim 1, which is an unfilled rubber compound.

21.-57. (canceled)
